(19) United States
(12) Patent Application Publication
(10) Pub. No.: US 2005/0114548 A1
(43) Pub. Date: May 26, 2005

(54) Electronic messaging system and method thereof

(76) Inventors: Joel D. Tucciarone, Brooklyn, NY (US); Chester Y. M. Chee, Flushing, NY (US); Jeffrey Y. Huang, Flushing, NY (US); Kevin Milani, Brooklyn, NY (US); Patrick Tighe, New York, NY (US); Marlin Pohlman, Tulsa, OK (US)

Correspondence Address: LAU & ASSOCIATES, 7701 ROCKLEDGE COURT, SPRINGFIELD, VA, 22152, US

(21) Appl. No.: 11/016,885

(22) Filed: Dec. 21, 2004

Related U.S. Application Data
(62) Division of application No. 09/750,923, filed on Jan. 2, 2001.

(51) Int. Cl. G06F 15/16

(52) U.S. Cl. 709/245

(57) ABSTRACT

The present invention is an on-request service precluding unwanted solicitation of electronic messages. More specifically, an environment is created whereby a user may request information in desired categories, customize each request with respect to the amount of information wanted, the active duration of such request, the device or IP address(es) to which to deliver such information and other user-specified preferences. Further, an advertiser may respond to the request by providing the sought after information by way of the service, and may, in turn, define requirements and specifications related to budget, time period, response goals, etc. The system operates on the basis of subscriber and supplier having active requests and historical record of requests and fulfillment managed as Information Accounts.

### FIELD OF THE INVENTION

The present invention is in the field of electronic messaging system operatively integrated in the network arena encompassing the wired and wireless space.

### BACKGROUND OF THE INVENTION

The commercial electronic messaging market has experienced significant growth in the past few years. Jupiter Communications projects another 40-fold of increase in growth in this area; particularly, in commercial e-mail volumes, primarily because e-mail is a cost-efficient, highly effective response-rate system and method by which to make contact with, acquire, cultivate and retain customers, for promoting and selling products/services, building loyalty and reinforcing brand identity.

The current and projected growth in commercial emessaging volume increasingly strains user patience and impacts marketing effectiveness of this medium of communication. For example, the average number of commercial e-mail messages that consumers receive was 40 over the course of 12 months during 1999, excluding unsolicited e-mail or “spam” in the form of chain letters, duplicate postings, etc. By 2005, the average number of commercial e-messages alone is projected to grow to more than 1,600 annually. This translates to 4.4 commercial e-messages per day per average user. Overall, non-marketing e-mail and other e-mail correspondence of a personal nature will also grow significantly by more than doubling from 1,750 in 1999 to 4,000 per year in 2005.

The consequence of this rapid growth is that users face a virtual avalanche of e-messages, much of it irrelevant to their needs, as for the most part they did not request the received information, i.e., it is “spam,” the electronic form of “junk mail.” For legitimate businesses, the key challenge will intensify, of achieving efficient response rates and maintaining effective, high quality, two-way interaction with customers and prospects.

“Permission-based” or “opt-in” e-marketing entails users granting permission for companies to send advertisements and other commercial messages via e-mail or other forms of eMessaging. Opt-in e-mail is largely used to generate leads, increase sales, retain, up-sell and cross-sell customers as well as building traffic to company web-sites. Some corporations seek to build their own in-house permission-based e-mail lists by inviting website visitors to register and subscribe to an e-mail update or newsletter as well as by renting third-party permission-based opt-in lists.

So-called permission-based or “opt-in” e-mail has provided only a partial answer to the problem of excessive commercial e-mail. This is so, first of all because the action of indicating interest in a category or product area is temporarily displaced—that is, removed in terms of time of such action from the actual purchase decision point. Secondly, the information seeking is spatially removed from the primary interface that typical onliners use the most frequently-namely, their e-mail interface itself. Further, the conventional systems and methods of opt-in do not enable users to control/manage the flow of such e-mail to be sent to their inbox-for example, in terms of duration, frequency, geography, date, day part or time frame—for any given information desired. Further, the quantity of such delivered information is not controllable by the user, as so called opt-in e-mail is currently practiced in the marketplace. In effect, “conventional opt-in” is more like “opening” a faucet with limited or no ability to control its flow (amount), continuance (time period), or periodicity (frequency).

With the current conventional opt-in method, as provided by third party aggregators, users make their interests known to such an intermediary company, typically at that intermediary's website (or at an affiliate's web site) and, thereby, register to have promotional/informational messages in categories of interest sent to their e-mailbox on a continuing basis. These mailings continue until the recipient informs the information senders to cancel the mailing when the user no longer desires to receive such information. According to the common experience among users, this cancellation procedure often does not effectively cancel the influx of information. Many third party aggregators often do not send the requested promotional messages unless consumers also agree to receive additional messages. Hence, consumers are coerced to “opt-in.”

Other e-mail marketing intermediaries seek to persuade online users to provide e-mail addresses for promotional mailings, sometimes in return for some incentive, bonus point program or refund. Often, these companies will employ the opposite of “opt-in”, namely an “opt-out” method of e-mail marketing, whereby consumers are first sent an e-mail message and then are given the option of not receiving any more promotional messages of the type—that is after they have already received at least one such message. That is, in this method, a stream of messages is typically sent until a user takes the action to inform the sender that he no longer wants to be sent such messages (hence, “opt out”). While e-mail users, in research, by far, prefer “opt-in” over and above the “opt-out” method, as of mid-2000, actual e-marketers' practice is still much more skewed to “opt-out.”

A key challenge for effective e-mail marketing is distinguishing the fine line between permission-based e-mail and unsolicited e-mail, common known as “spam.” According to analysts' studies (Jupiter, IMT Strategies, et al), between 33% and 59% of consumers ignore e-mail from unfamiliar sources. This phenomenon is the “soft underbelly” of conventional permission-based or opt-in e-mail marketing in that, quite literally, the user forgets that he requested information or, simply does not recognize the “unknown” sending source.

Thus, with conventionally implemented “opt-out” and, even with “opt-in” e-mail, if the user receives more e-messages than expected, or if the content is irrelevant or if it is not timely (e.g., receiving the travel information package after one already took the trip), such eMessage is likely to be perceived as “spam” and, hence, ignored. If e-marketers send to a user's e-mail address in order to promote unrelated products/services—or if the user's addresses are sold/rented/exchanged with other marketers—such e-mail can appear to come from an unfamiliar sender and, de facto, result in the perception of “spam” on the part of the user—even if the customer originally gave permission to the sender directly or to some, legitimate third party intermediary.

In summary, the conventional “opt-in” e-mail system is not dynamic in the sense that users cannot control an “on/off switch,” i.e., turn on/turn off a category of interest easily and quickly; nor can they control the amount of information to be received nor its active “life.” Such systems are also, by their being “outside” of the user's e-mail system's operational infrastructure, not intimately knowledgeable of the individual user's e-mail behaviors re: the full range of other opt-in relationships for other categories of information, nor the person's e-mail preferences in terms of delivery, terminus device, type of e-mail format, auto-forwarding to share with a friend, etc. and/or the user's specific behaviors (open/save/delete/forward/et al.) in response to a given e-mail received, i.e., beyond simply tracking the click-through to the e-marketer's website.

### SUMMARY OF THE INVENTION

In light of the drawbacks of the known methods for enabling users to grant their permission for commercial messages to be sent to their e-mail address or other e-messaging terminus in the categories of their interest, an objective of the present invention is to provide a system and method for facilitating information requests by combining functionality such as quantity/duration, device terminus and other preferences with the most frequently engaged online activity; namely, with the e-mail or emessaging system, putting users in control of their own information request parameters. Thus, the subject invention makes it possible to have immediate interaction with the on-request utility at the very point of the e-mail interface (or, according to another embodiment, a single click away instantly from the e-mail interface to the on-request functionality or according to another embodiment as a pull-down or pop-up panel on a browser, or according to another embodiment as a desktop application or agent, or according to another embodiment at a separate website).

The subject invention embodies, as well, a “just-in-time” responsivity feature that enables the user to self-customize the quantity, frequency, delivery terminus (1 or more), auto-forwarding and other criteria specific to the individual user and the specific requested information event and to have such request and specific criteria active for a desired duration or time frame which coincides with the user's period of interest.

Further, the subject invention includes the corollary mechanism for aggregating legitimate advertiser e-mail/e-messages in a Central Posting Facility (and, according to another embodiment, a cluster or networking of such databases) and, by extension, the application of such Facility to become a Commercial On Demand e-Mail Clearinghouse for multiple uses by web-sites, portals, corporations and other service providers with end-user relationships. A method for integrating the “just-in-time” functionality described above with other systems such as SAIC's MISTI for indexing and searching of web-accessible content or legacy databases is also provided for by the invention.

The present invention provides an improved method and system that enhances any e-mail system, whether POP, IMAP or other protocol (or more broadly, any e-messaging system), by combination with a dynamic, on-screen, on-request information control and exchange functionality which enables users to make self-tailored or personally customized requests for categories of information to be delivered to them via their e-mail/eMessaging address, (according to other embodiments, such functionality may be provided as an embedded browser plug-in, pop-up, desktop application or agent, or at a separate website itself, and delivery may be by other than e-mail forms of e-messaging including instant messaging, short text wireless, addressable television communication, as well as by conventional delivery, over the Internet, of addressable data packets to an IP address.)

The method and system, according to the present invention, provides the user with a range of pre-established categories and sub-categories of information which the user may activate by simply highlighting, or otherwise checking off, or clicking on.

Further, the method and system enables users to make specific requests beyond the existing, pre-established categories, by inputting their information request following a simple format for such request and the system seeks to identify and provide such information by e-mail or alternate e-messaging protocol, e.g., instant messaging, wireless short message or other digital communications to an IP address, by its use of such searching mechanisms as SAIC's MISTI system.

The invention also provides for the requests, so indicated, to be self-tailored or customized by the user according to the user's preferences, for example, quantity of information desired, active duration for each request, geographic specificity, date, daypart, time period, cost/value, delivery terminus device(s), automatic forwarding to one or more other e-mail/eMessaging addresses, and other parameters that the user dynamically is able to control.

The method and system according to the present invention further provides for the coding of such requests and the retrieval of relevant information/advertisement/offers from a range of databases, a) controlled by the service as a Central Posting Facility of one or more databases to which legitimate advertisers, under certain agreed-on procedures, may post their most current eMessaging-delivered offerings; b) via inter-linkage with one or more outside databases or web-sites controlled by advertisers directly or by intermediary aggregators of such commercial communications, offers or information and accessible over a wired or wireless network.

The method and system according to the present invention enables the user, therefore, simply and easily, at the e-mail (or emessaging) interface (or according to other embodiments at the desktop, at the browser or at a separate web site) to request on a self-customized basis, the information and commercial offer(s) he wants to receive in his e-mail in-box, or other e-messaging terminus (or according to other embodiments receiving same at a private lockbox located elsewhere, e.g., on a separate website). Such requests may occur without the user being required to leave in any way or exit the primary e-mail interface (or according to other embodiments, via browser pull-down, pop-up desktop application, or at a separate website).

Further, the method and system of the present invention incorporates a billing transaction mechanism whereby the information supplier/advertiser can be charged for delivery of his information/advertisements to qualified requesters. Additionally, the users of such system on the “demand” side are enabled to purchase relevant information (e.g., full reports, etc.) by way of a micro-payments credit card or other billing transaction system.

The present invention acts as an information exchange system, which seeks to optimize the matching up of the requests from multiple users for information with their associated multiple criteria/preferences and personal profiles on the one hand, with, on the other hand, the information inventory of multiple suppliers' with their associated multiple specifications, objectives and mandatories. In this embodiment, the user or subscriber has an Information Account and the Supplier or Information Provider has an Information Account each of which maintains active and historical records of requests made, criteria for such requests and a record of delivered results and associated email behaviors and financial transactions as appropriate.

Such on request utility may be embodied as an information exchange or, according to other embodiments, as an enhanced Selection Engine, which delivers a similar end user experience that operates by combining a Search Engine functionality (such as aspects of MISTI) with an Account Management system that records, manages and directs the search function, its delivered results, the historical tracking of same as well as any financial accounting of such “information transactions.”

A further object of the present invention is to construct Web-based services wherein users at a variety of separate web-sites or portals are able to input into an information request panel and, thereby, declare their interest in receiving, offers and information, typically of a commercial type, for desired categories of commerce or social activity and qualify such requests as to duration, quantity, frequency, et al. to be delivered largely by e-mail to their e-mail address or to some other eMessaging terminus or IP address.

This method and system takes conventional opt-in or permission-based e-mail to a new dimension in dynamic user control and specificity and may be rightly termed a new form of “on request,” user-controlled information access utility. With the ability, in particular, to control duration of active requests (in hours, days, weeks, months, or no time limit), frequency, and quantity of desired information, specific time period and other factors, the system provides a more effective method of “just-in-time e-marketing communication” for users who are closer to the “purchase decision window” able, willing and ready to transact.

### BRIEF DESCRIPTION OF THE DRAWINGS

FIG. 1 illustrates an information exchange system of the present invention.

FIG. 2 illustrates a first system embodiment of the present invention, based on an exchange model.

FIG. 3 illustrates a flow chart diagram of the System Architecture for the present invention.

FIG. 4 illustrates another preference information screen for subscriber account holders of the present invention.

FIGS. 5a and 5b illustrate preference information screens for subscriber account holders of the present invention.

FIG. 6 illustrates a geographically-based preference information screen for subscriber account holders of the present invention.

FIG. 7 illustrates a customization module of the present invention.

FIGS. 8a and 8b illustrate a third system embodiment for supplier information control aspects of the present invention.

FIGS. 9a, 9b, 9c and 9d illustrate the information management and preference specification input screens for use by Suppliers/Information Providers of the present invention.

FIG. 10 illustrates a summary screen of the activity history of subscriber account holders of the present invention.

FIG. 11 illustrates an alternative system embodiment of the present invention, which is structured as a subscriber account-driven, search engine-based request and fulfillment system.

FIG. 12 illustrates a flow chart diagram for subscriber account holders of the present invention.

FIG. 13 illustrates a flow chart diagram for supplier account holders of the present invention.

FIG. 14 illustrates a flow chart diagram for the processing of requests by the present invention.

FIG. 15 illustrates Table G that contains various feature of the present invention.

FIG. 16 illustrates Table H that contains various features of the present invention.

### DETAILED DESCRIPTION OF THE PRESENT INVENTION

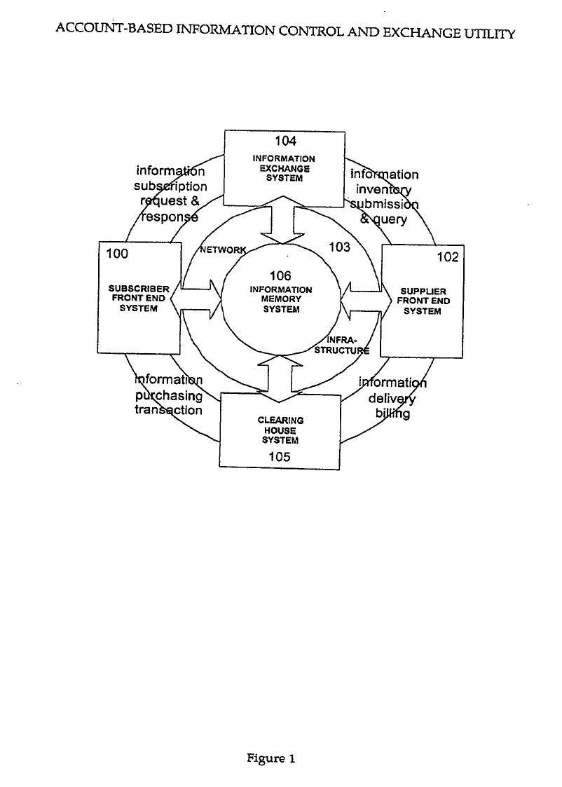

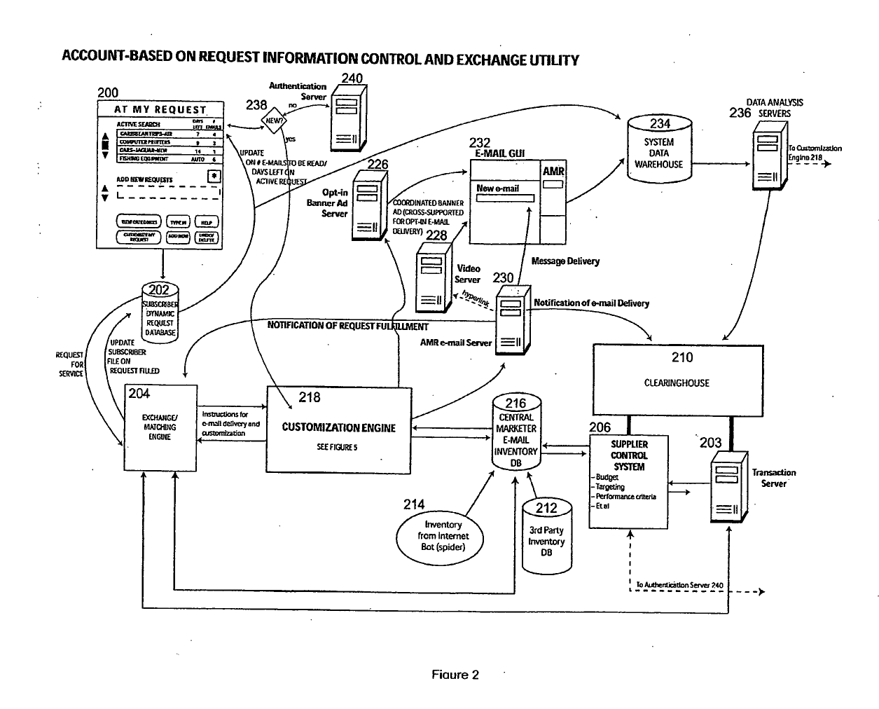

FIG. 1 illustrates a broad systematic view of the present invention. As shown, a Subscriber Front End System 100, a Supplier Front End System 102, an Information Exchange System 104, a Clearing House System 105 and an Information Memory System 106 are all interconnected by a network 103. The Supplier Front End System 102 is used to collect information from advertisers or information providers. The Subscriber Front End System 100 is used to collect information requests from Subscribers. The Information Exchange System 104 is used to facilitate either exact matches or a varying degrees of matches between information requests made by subscribers and information provided by advertisers/suppliers. The Clearinghouse System 105 is used to handle all aftermath functions of either the exact matches or the varying degrees of matches, such as aspects of business transaction, including refined or modified requests, tracking, accounting-related functions, etc. The Network 103 is used to be a facilitator of communication among the various systems. Network 103 can be, but is not limited to, being an Internet, an email network, a wireless or cellular network, a Wide Area Network, a Local Area Network, or a combination thereof. A system use statement is given immediately hereinbelow.

Start of Day (SOD)

Information Exchange System 104 and clearinghouse System 105 load up all the corresponding business rules stored in Information Memory System 106 via Network 103. Then Information Exchange System 104 also load up all the information inventories and requests for “today” from Information Memory System 106 via Network 103. When the loading process is completed, Information Exchange System 104 performs the matching process to generate executions by matching information inventory with relevant requests. Thereafter, the system follows the process defined in Execution.

Execution

Executions are then sent to Information Memory System 106 for archiving and clearinghouse System 105 for further processing, via Network 103. Clearing House System 105 ensures that no execution violates any boundary specification of subscriber and supplier defined via Subscriber Front End System 100 and Supplier Front End System 102 respectively. If the boundary specification has been violated, the system will invalidate the inventory or request of the corresponding supplier or subscriber respectively. This ensures his/her inventory/request will not be processed in the future until the violation has been neutralized.

Intra-Day

Subscriber submits an information request via Subscriber Front End System 100. This request is sent to Information Exchange System 104 via Network 103. When Information Exchange System 104 received the request, it looks up matching inventory from Information Memory System 106 via Network 103. Then the system follows the process defined in Execution.

Supplier submits an information inventory via Supplier Front End System 102. This submission is sent to Information Exchange System 104 via Network 103. When Information Exchange System 104 received the inventory, it looks up matching request from Information Memory System 106 via Network 103. Then the system follows the process defined in Execution.

End of Day (EOD)

Clearing House System 105 scans all recurring information inventories and requests stored in Information Memory System 106, then marks these information inventories and requests as “today”.

Period Summary

Start of Day tasks MUST be performed prior to Intra-day tasks. Intra-day tasks MUST be performed prior to End of Day tasks. The time span that defines each period (i.e. SOD, Intra-Day, EOD) is customizable.

Subscriber

Subscriber uses Subscriber Front End System 100 to submit a new information request or to query existing information request status. When subscriber logged into the system via Subscriber Front End System 100, Subscriber Front End System 100 query the information requests and executions that are associated to the logged in subscriber. Subscriber can also modify any existing information request via Subscriber Front End System 100; the updated request is then sent to Information Exchange System 104 for further processing as described in Intra-Day. Subscriber also uses Subscriber Front End System 100 to perform micro-payment for their specialize subscription.

Supplier

Supplier uses Supplier Front End System 102 to submit a new information inventory or to query existing information inventory status. When supplier logged into the system via Supplier Front End System 102, Supplier Front End System 102 query the information inventories and executions that are associated to the logged in supplier. Supplier can also modify any existing information inventory via Supplier Front End System 102; the updated inventory is then sent to Information Exchange System 104 for further processing as described in Intra-Day. Supplier also uses Supplier Front End System 102 to perform payment for their services.

The Subscriber Front End System 100 provides information subscriber (IS) a friendly user interface to interact with the other system components such as Information Exchange System, clearinghouse System and Information Memory System. When the IS requests for specific information, IS submits the request to Information Exchange System 100, which system 100 responses to IS with the matching result (via either searching or matching information inventory resides in Information Memory System). Network Infrastructure provides a platform for communication between Subscriber front-end system and other system components as described above.

Subscriber front-end system can be an application, an applet, a web application, and/or an embedded device with applet running on it. Components belonging to the Subscriber Front End System 100 in the various figures of the present invention are listed by way of an example in Table A.

TABLE A

| Figure | Item # | Comments |
|---|---|---|
| 2 | 200, 232 | |
| 3 | 1102, 1104, | |
| | 1136 | |
| 4 | 900-999 | Information response (e-message) |
| | | front end |
| 6 | 802, 871, 1300-1399 | Information request specification |
| | | front end |
| 5a, 5b | 800-899 | Information request specification |
| | | front end |
| 7 | 500, 502, 504 | |
| 11 | 300, 310 | |
| 12 | 600-699 | Front-end work flow |

The Supplier Front End System 102 provides information provider (IP) a friendly user interface to interact with the other system components such as Information Exchange System, Clearing House System and Information Memory System. When the IP submits an information inventory, IP submits the information inventory to Information Exchange System which responses to IP with the matching result (via either searching or matching information request resides in Information Memory System). Network Infrastructure provides a platform for communication between Supplier front-end system and other system components as described above.

Supplier front-end system can be an application, an applet, a web application, and/or an embedded device with applet running on it. Components belonging to the Supplier Front End System 102 in the various figures of the present invention are listed by way of an example in Table B.

TABLE B

| Figure | Item # | Comments |
|---|---|---|
| 2 | 206, 232 | |
| 3 | 1100, 1102, 1104, | |
| | 1136 | |
| 13 | 700-799 | Front end work flow |
| 8a, 8b | 402, 404, 406, 408, | |
| | 410 | |
| 10 | 1000-1099 | Report format |
| 11 | 308, 310 | |

The Network Infrastructure 103 provides all system components a platform for communication. Network infrastructure can be any form of wired networks, wireless networks, and/or satellite networks with any form of networking protocol build on it. Components belonging to the Network 103 in the various figures of the present invention are listed by way of an example in Table C.

TABLE C

| Figure | Comments |
|---|---|
| 2 | Arrows between block diagrams |
| 3 | indicate communication via Network |
| 7 | Infrastructure. |
| 8 | |
| 11 | |

The Information Exchange System 104 facilitates the searching or matching of information request and information inventory resides in Information Memory System according to both static and dynamic business rules. The process of facilitation can be real-time or periodic. When there is a match between one or more information requests to one or more information inventories, there are one or more executions. Information Exchange system forwards these executions to Information Memory System and clearinghouse System for archiving and further processing respectively via Network infrastructure. Components belonging to the Information Exchange System 104 in the various figures of the present invention are listed by way of an example in Table D.

TABLE D

| Figure | Item # |
|---|---|
| 2 | 204, 210, 218, |
| | 226, 230, 236 |
| 3 | 1106, 1122, 1130 |
| 7 | 510, 512, 514 |
| 14 | 1200-1224, 1234-1299 |

The clearinghouse System 105 facilitates the process of validating the execution correctness and transaction accounting information generated by these executions according to both static and dynamic business rules. The process of facilitation can be real-time or periodic. Clearing House System forwards any updates to Information Memory System for archiving via Network infrastructure. Components belonging to the Clearinghouse system 105 in the various figures of the present invention are listed by way of an example in Table E.

TABLE E

| Figure | Item # |
|---|---|
| 2 | 203, 210 |
| 3 | 1114, 1118, |
| | 1134 |
| 14 | 1228, 1230, |
| | 1232 |

The Information Memory System 106 provides all system components information storage. Information Memory System can be distributed among the Network Infrastructure or centralized within the Network Infrastructure. Components belonging to the Information Memory System 106 in the various figures of the present invention are listed by way of an example in Table F.

TABLE F

| Figure | Item # |
|---|---|
| 2 | 202, 212, 214, 216, 226, |
| | 228, 234, 240 |
| 3 | 1108, 1112, 1120, 1124 |
| 7 | 506, 508 |
| 8a, 8b | 412, 414, 416, 422, 424 |
| 11 | 302, 306, 308 |

FIG. 2 illustrates a first systematic view of the present invention. As representatively shown, this is an At My Request User Request Utility 200 running on a system that can be as simple as a personal computer or personal digital assistant connected to network 103 via either wired or wireless transmission. 200 is the subscriber's interface to the At My Request Utility. From this interface, a subscriber can specify requests and establish parameters/criteria associated with specific requests.

Connected to utility 200 is a Subscriber Dynamic Request Database 202. The active subscriber request information from all subscribers are stored in this database. The database 202 exchanges information with an Exchange/Matching Engine 204. Engine 204 matches supplier information with subscriber requests. The matching engine defines positive matches by means of an exchange or system of matching logic controlled by business rules, wherein:
1. Consumer is a Client (Subscriber).
2. BusinessUser is a Client (Supplier).
3. Client has a Portfolio.
4. Portfolio is a PortfolioItem.
5. Order is a PortfolioItem.
6. Info Match Up Report is a PortfolioItem.
7. Portfolio keeps track of PortfolioItem.
8. Consumer's Portfolio provides MatchingEngine with Consumer's demographics and behavioral information for more accurate matching.
9. BusinessUser's Portfolio provides information to ClearingEngine to match up the credit limit of the BusinessUserAccount.
10. Order generates Info Match Up Reports.
11. Consumer Order is an Order that contains specification of a commercial advertisement request.
12. BusinessUser Order is an Order that contains the specification of a commercial advertisement.
13. An execution of two orders (Consumer Order and BusinessUser Order) occurs when their specifications are “likely” to match. Both Consumer and BusinessUser receive an Info Match Up Report for an execution.
14. OrderBook maintains open Orders. Open order is an order that has not been satisfied.
15. MatchingEngine matches up open Consumer Order and open BusinessUser Order.
16. MatchingEngine defines how the orders (both Consumer or BusinessUser) are being matched.

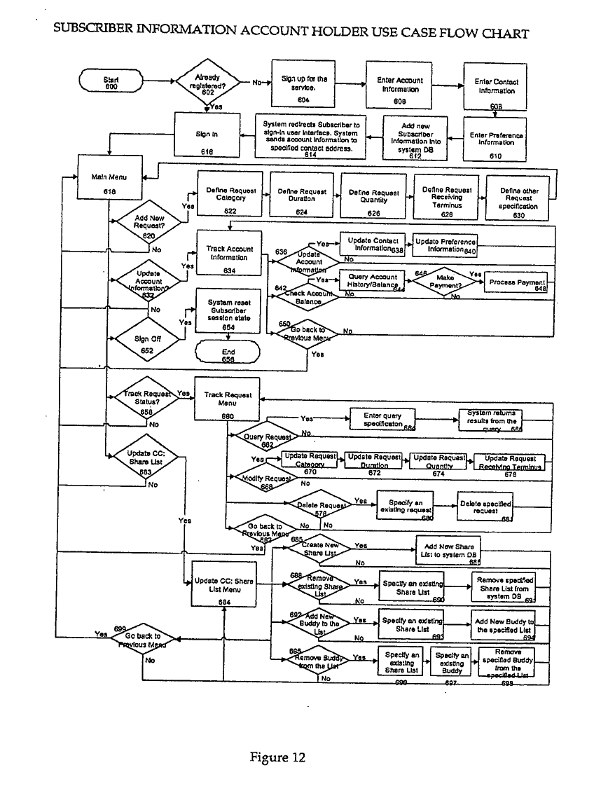

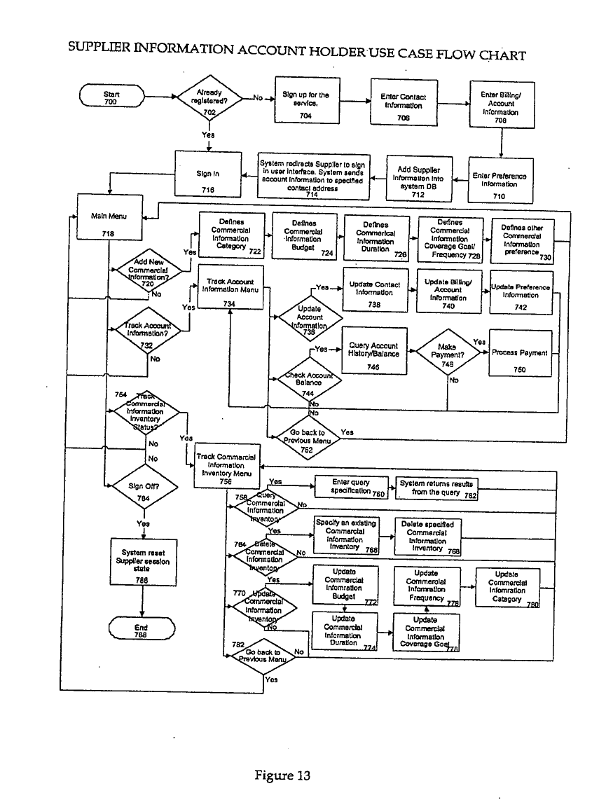

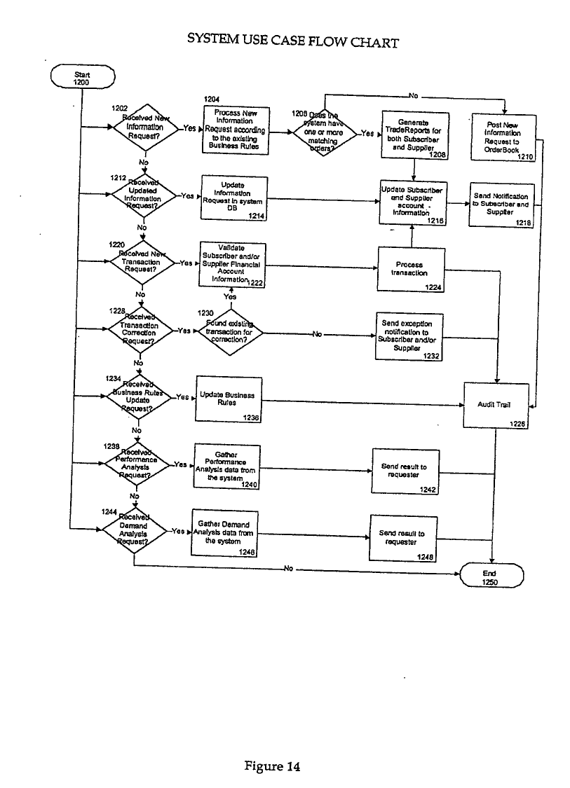

Complying with these rules, a Use Case Model including a Subscriber Use Case Statement (FIG. 12), a System Use Case Statement (FIG. 14) and a Supplier Use Case Statement (FIG. 13) are made possible.

When the Subscriber logs into the At My Request User Request Utility 200 the system authenticates the Subscriber at the Authentication Server 240. If the Subscriber is a new user of the system 238 he will be sent to the Customization Engine 218 and will be asked to fill out a Subscriber Profile and then will be given a name and password by the system for future authentication.

Interactively communicating with the Exchange/Matching Engine 204 is a Customization Engine 218 that manages customizable content, maintains rules that are specified by the Subscribers and/or the system and/or the Suppliers, maintains profile information about Subscribers (based on user-supplied data at sign-up or subsequently and relevant behavioral tracking data about the users' activity on the system) which is used to customize the system's response to their queries, and is used to make adjustments to both an Subscriber's Profile Database as well as Business Rules specific to individual Subscribers.

The Customization Engine 218 also communicates with the Central Marketer E-mail Inventory Database 216 and receives instructions and messages from the Supplier Control System 206 about what to do with the inventory it has access to in the database. The Supplier Control System 206 is the control utility or dashboard for marketers and advertisers. From this dashboard they are able to set parameters such as budget, targeting, performance criteria, etc. Before the Supplier can use the dashboard, the Supplier must first be authenticated by the Authentication Server 240.

A Central Marketer eMail Inventory Database 216 is interactively communicable with the Customization Engine as well. The Central Marketer eMail Inventory Database 216 holds both internal and external advertising inventory and information. Database 216 also collects information for inventory from Internet Bot 214—an application that follows hyperlinks and catalogs the content of the pages that meet specified criteria—and 3 rd Party Information Inventory Databases 212.

A Transaction Server 203 bridges between the Supplier Control System 206, the Exchange/Matching Engine 204 and a Clearinghouse 210. The Transaction Server 203 processes all forms of transactions, including micro-payments, billing, credit card payments for the users including both “Subscribers” and “Suppliers”, whereas the Clearinghouse 210 makes certain of execution of matches within limits of user and advertiser/information provider accounts, such as credit, request criteria, etc. and makes adjustments as may be required to “true up” accounts.

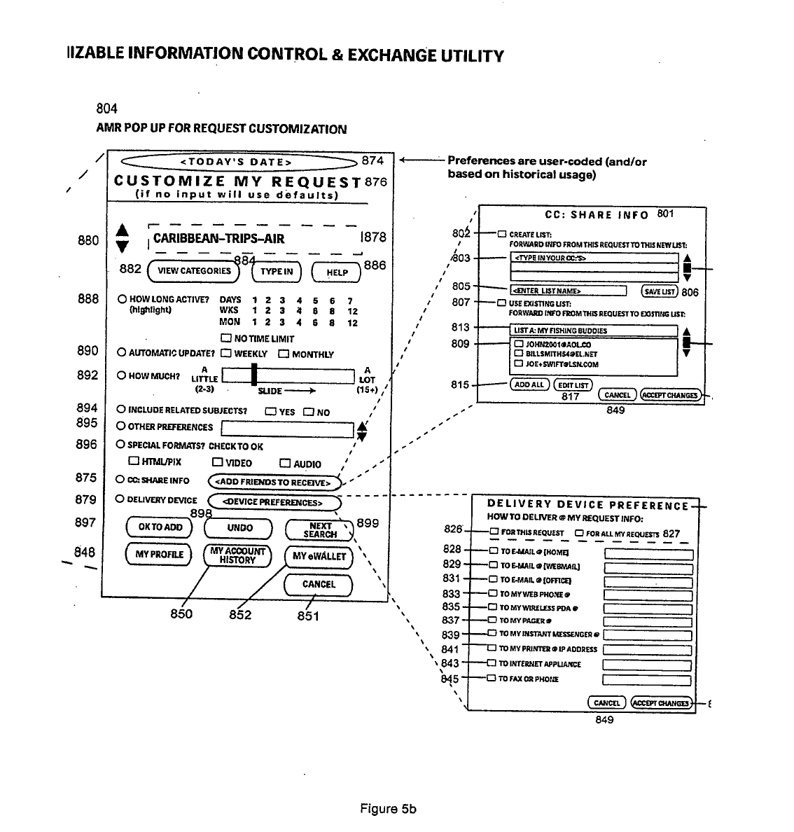

An “At My Request” email/eMessaging server 230 interconnects between an e-mail Graphical User Interface (GUI) 232, a Video Server 228, and the Exchange/Matching Engine 204 and the Clearinghouse 210. The Video Server 228 provides hyperlinks to the AMR e-Mail Server 230 which are then embedded into e-mails sent to the e-Mail GUI 232 wherein the link when clicked, causes a video to download from the Video Server 228 and run. The Video Server can also be used to attach compressed videos as attachments to emails/emessages sent by the AMR e-Mail Server. The email GUI provides access to the delivered information as well as the At My Request user interface (see FIG. 5). The GUI also hosts banner advertising. By way of functions, the AMR e-Mail Server 230 provides notification or request fulfillment to the Exchange/Matching Engine 204, provides notification of email delivery to the Clearinghouse 210, and delivers messages directly to the email GUI and through the Video Server 228.

An Opt-in Banner Ad Server 226 bridges between the Customization Engine 218 and the e-Mail GUI 232. The Opt-in Banner Ad Server provides banner ads which are either related to the user's current “on-demand” requests for information or the user's stated preferences for banner ads which are solicited by the system at sign-up and periodically thereafter.

The System Data Warehouse 234 is connected to the At My Request User Interface 200, the Subscriber Dynamic Request Database 202, the e-Mail GUI 232 and Data Analysis Servers 236. The System Data Warehouse provides storage of all historical user data. The historical user data are then analyzed by the Data Analysis Servers 236 according to Business Rules and provide the Clearinghouse 210 with the results. The Data Analysis Servers can also provide results to the Customization Engine 218 for uses established by business rules and for customization of advertising campaigns.

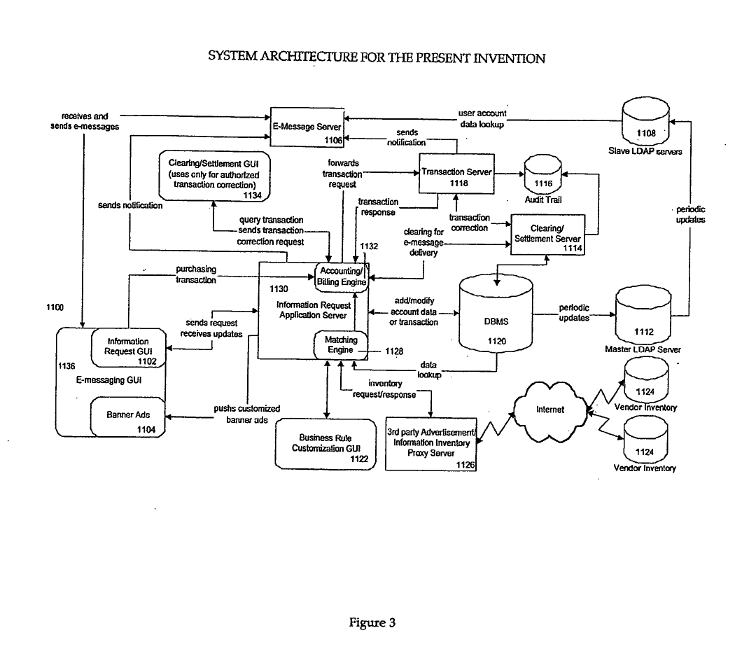

FIG. 3 illustrates a flow chart diagram of the system architecture for the present invention. The Information Request Application Server (IRA) 1130 has two components, the Matching Engine 1128 and the Accounting/Billing Engine 1132. The IRA handles requests from commercial information subscribers and suppliers via Information Request GUI 1104, which is located within the overall eMessaging GUI 1100. When a request is received, the Matching Engine 1128 looks into the DBMS 1120 for advertising/information inventory. Based on the Business Rules that are stored in the DBMS, the Matching Engine matches up commercial information inventory with commercial information request. Subscribers and suppliers are notified when the request has been fulfilled via electronic messaging sent from the eMessage Server 1106. The eMessage Server provides subscribers/suppliers, IRA Server and Transaction Server a communication platform (i.e., email, wireless, instant messaging). When the request has been fulfilled, the Accounting/Billing Engine 1132 deducts the supplier account credit with one or more financial transactions based upon the number of inventory items delivered to subscriber(s). The IRA is also responsible for pushing personalized banner advertisement to the eMessaging GUI 1102 based upon subscriber/supplier personal profile and/or requested information request categories.

The Transaction Server 1118 handles financial transactions following the fulfillment of requests by the IRA. Financial requests are passed from the user, through the IRA and on to the Transaction Server. The responsibilities of the Transaction Server are: to ensure the transaction is atomic, i.e., either the transaction is completed or nothing is done at all; to ensure the transaction is auditable via audit trail information 1116; to ensure the transaction correction, if needed, is auditable via audit trail information.

The Clearing/Settlement Server 1114 handles the accounting/billing settlement on the supplier's account; it also provides authorized personnel to facilitate transaction correction on subscriber's/supplier's behalf. All actions taken on CS Server are monitored.

The Database Management Server (DBMS) 1120 is the sole data repository for the entire system. DBMS provides the rest of the system a way to add or modify data in its storage. Contained within the DBMS is: subscriber/supplier personal preference/behavioral profile; subscriber/supplier personal information (such as contact address); subscriber/supplier information request account information; subscriber/supplier eMessaging account information; financial transaction information (such as billing account, micro payment, credit card information); subscriber's information request and its status; supplier's information request and its status; information request/inventory execution reports; business rules for Matching Engine component of IRA Server.

Periodically, the DBMS synchronizes its data to master LDAP Server 1112 and master LDAP server synchronizes its data to multiple slave LDAP servers 1110 and 1108. Both eMessage and IRA servers use slave LDAP servers to look up non-volatile account information for subscriber/supplier authentication during sign-in process.

The third party Advertisement Information Inventory Proxy Server (AIP) 1126 allows third party vendors to submit their inventory into the system without using the Information Request GUI 1104. The information submitted via AIP server MUST be compliant to XML-based IRML (Information Request Markup Language) format.

The Business Rule Customization GUI 1122 provides authorized personnel with a user-friendly way to submit transaction corrections on subscriber's/supplier's behalf.

The eMessaging GUI 1100 consists of three components: Banner Advertisement 1102; eMessage Center 1136; and Information Request Utility 1104. The Banner Advertisement 1102 is placed by the IRA 1130 and is personalized based on the subscriber/supplier preference/behavioral information. The eMessage Center 1136 provides subscriber/supplier with a user-friendly graphical interface to read (or send) electronic messages from the system. The Information Request Utility 1104 provides subscriber (supplier) with a user-friendly graphical user interface to parameterize and to submit commercial information requests (or inventory) to the system.

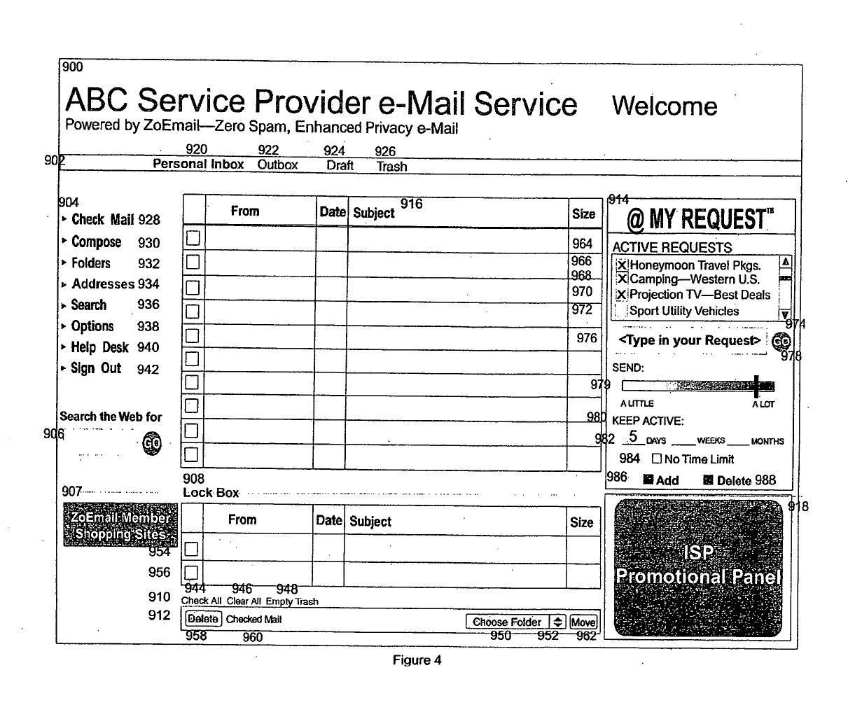

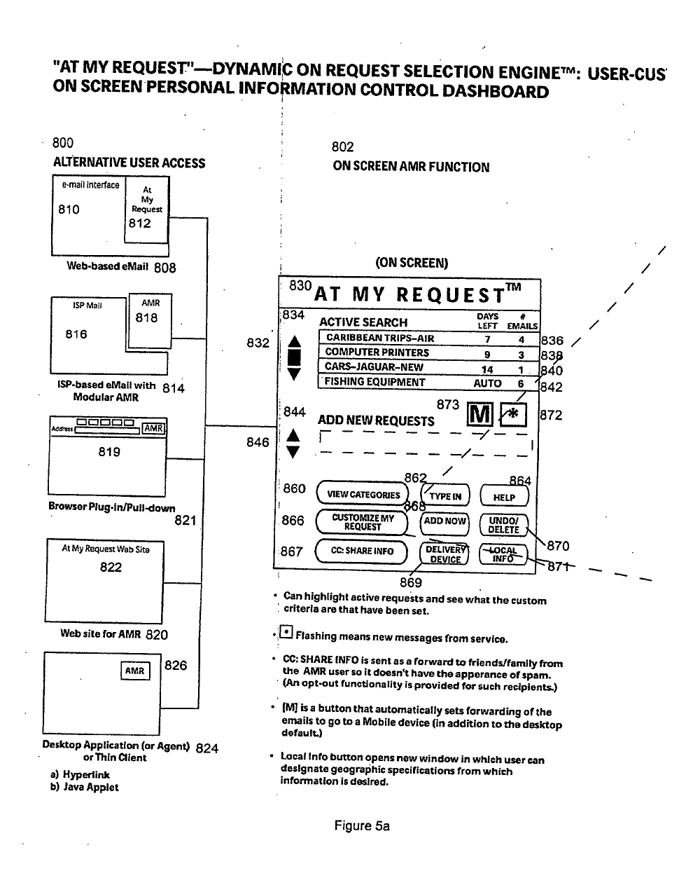

FIG. 4 illustrates another preference information screen for user account holders of the present invention. As shown this is a main menu screen of an e-mail account with an exemplary ABC Service Provider e-Mail Service logo 900. This screen contains numerous segments, including an actionable row segment 902, an actionable column segment 904, a search segment 906, a ZoEmail Member Shopping Sites 907, a first treatment segment 910, a second treatment segment 912, an at my request segment 914, a tabulated record segment 916 and an Internet Service Provider segment 918.

At the actionable row segment 902, one can check whether there is any awaiting email message by clicking the personal inbox area 922. Alternatively, email message can be sent out by clicking the outbox area 922. One can also draft email messages by clicking the draft area 924 or treat certain information as garbage by clicking the trash area 926.

At the actionable column segment 904, there are numerous icons linking to specific utilizable features, including check mail 928, compose email message 930, various folders 932, address list 934, search feature 936, options feature 938, help desk 940 and sign out feature 942.

At the search segment 906, there is a search the Web feature. From this site, one can find information on products, deals, advertisers and other related content on the Web.

With the ZoEmail Member Shopping Sites 907 button the user can go to web storefronts where purchases of information, products and services can be made. The shopping sites may be a page of hyperlinks to advertiser/information provider sites, may be a virtual mall hosted by ZoeMail where all transactions take place on ZoEmail servers, or some combination of both.

The lock box folder 908 stores all e-mails from senders who don't have an authenticated key and are thus from unknown senders. By sending unauthenticated messages to the lockbox, the main inbox stays free of irrelevant mail. At the lock box 908, there are a plurality of actionable features 910 for selecting check all 944, clear all 946 and empty trash 948. Items in the lock box 908 can either be individually check at the check boxes 954 and 956 or all items can be checked by the check all key 944. If all items are checked and deleting of all items are desired, then the clear all key 946 can be clicked to accomplish this result. However, if only a selected few of the items is desired to be deleted, then the delete key 958 can be clicked to accomplish this result. It should be noted that the deleted items are not immediately removed from one's record, they are rather being placed in a folder waiting to be permanently removed by the clicking of the empty trash key 948. Once the empty trash key is pressed, then the items will be permanently removed and unrecoverable. Other folders like the lock box folder 908 can be selected from the choose folder feature 950 through the scroll bar 952.

The checked mail key 960 is used in conjunction with the checking of items in the lock box 908. Should a person wish to read the content of any message item, all that person need to do is to check the relevant check box 954 or 956 then press the checked mail key 960. Content of the relevant message item will appear in the screen. Alternatively, the user may also click on the subject line of a mail message to open that mail message.

The move key 962 is also used in conjunction with the lock box 908 as well as the choose folder key 950. Assuming there are a general mail box folder and a stock portfolio folder. Should a person receive an email stock report in the general mail box folder and wish to move the report to be stored in the stock portfolio folder, then the person needs to go to the general mail box folder through the choose folder key 950, identify the email stock report through the relevant check item box 954 and 956, click the move key 962 to indicate the email stock report is to be moved, identify the stock portfolio folder through the choose folder key 950. Through this process, the email stock report is moved from the general mail box folder to the stock portfolio folder.

At the At My Request segment 914, various features of the At My Request service are shown. There is an active request window 964, within which window contains numerous request items representatively showing honeymoon travel packages 966, camping in the western United States 968, best deals on projection television 970 and sport utility vehicles 972. Other request items can be shown by using the scroll bar 974. Adjacent to each request item is a check box. An x in the check box indicates the adjacent request is active. A blank in the check box indicates the adjacent request is in the process of being selected and user-defined request criteria are being established for the request.

A person may add requests through the type in your request area 976. At the end of typing in the request, the GO icon 978 can be clicked to initiate the search. Below the type in your request area 976 is a scroll bar area 979. This scroll bar is for indicating the volume of information being requested. For a few on target results, a person may choose the end of the scroll bar indicating a little. Conversely, for a large volume of on target results, the person may choose the end of the scroll bar indicating a lot. The person may also indicate a volume anywhere in-between the two ends.

Below the volume bar 979 is a keep active indication segment 980. A person may indicate the search should be kept active for a number of days, weeks or months at the keep active designation area 982. Should the person choose so, a no time limit 984 can also be designated.

Regarding the add key 986 and delete key 988, the user may add a new request to his list of active requests or delete a request from his list of requests. At the far right corner of the screen is a reserved Internet Service Provider Promotional Panel 918. This promotional panel is used as an area to run advertising, promotions and to be host to dynamic information from third parties.

FIG. 5 illustrates an “At My Request” Subscriber Control Panel. There are three major representative segments. The first segment is labeled as the Alternative User Access 800. The second segment is labeled as the On Screen At My Request Function 802. The third segment is labeled as the At My Request Pop Up for Request Customization 804.

Illustratively shown in the first segment are five ways of accessing the At My Request service. The first way of access is through a web-based e-mail system 808 (Web mail). Within this web-based email system 808 is an e-mail interface 810 and an At My Request Control Panel Utility 812.

A second way of access is provided by an Internet Service Provider mail 816 with a modular At My Request 818 which is provided as an optional service to the ISP's user base and is integrated with the ISP's mail system and/or mail Interface.

A third way of access is provided by a browser plug-in or pull-down menu 821. With the At My Request functionality installed as a plug-in to a browser 819, the user can readily use the At My Request service, with communication from the On Request central service and the end user occurring via Jabber (Instant Messenger) or other Internet eMessaging protocol.

A fourth way of access is directly from a web-site for At My Request 820. Once access to the web-site has been obtained, the At My Request service 822 can be readily used.

A fifth way of access is through an Application or a Thin Client 824. An Application, once installed, may provide the user with a Desktop Shortcut 826 or make itself available in various user and application menus. The Thin Client may be downloaded by the user over the Internet. Once installed, both the Application and Thin Client provide the user with the full functionality of the At My Request service.

Linked to the alternative user access 800 is the On screen At My Request Function 802. The screen 802 has an At My Request logo 830. Below the logo is a window 832 with a number of entries of actively searched items. As shown, item 836 is a Caribbean air trip that has received 4 e-mails with seven more days left on the search. Similarly, item 838 is a search of computer printers has received 3 e-mails with 9 more days left on the search. Item 840 is a search of new Jaguar cars having received 1 e-mail with 14 more days left on the search. Item 842 is a search of fishing equipment having received 6 e-mails with an auto number of days left on the search. Even though the window can only display a limited number of items per screen, additional number of items can be viewed through the scroll bar 832.

Screen 830 also contained a view categories key 860, a “type in” key 862, a “help” key 864, a “customize my request” key 866, an “add now” key 868, “an undo/delete” key 870, a “cc: share info” key 867, a “delivery device” key 869 and a “local info” key 871. Depending upon needs and functionality, other keys may be added.

Search items can be easily added in the add new requests designated area 844. For multiple additions, scroll bar 846 can be used. An asterisk inside a box icon 872 is shown on screen 830. Flashing of this icon means that new messages have been received.

By clicking the “Customize My Request” button, the At My Request pop up for request customization screen 804 appears. The header of the screen shows today's date 874 and a customize my request logo 876. The middle of the screen shows a number of customizable features. Should no customization be needed, then either automatic personal preference preceding or over time self-coding will be used as default features. Self-coding is determined by the system using historical usage patterns, feedback and Subscriber behavior history as the basis for creating a personalized default customization for the Subscriber. Since the customization features are search item specific, the item to be searched is shown in window 878, which currently shows a Caribbean air trip. For other search items, scroll bar 880 can be used for making desired selections. Associated with window 878 are a view categories key 882, a type in key 884 and a help key 886. For each search item, there is a prompt 888 of how long should this search be active. In response to the prompt one can designate either in terms of days, weeks or months or specify no time limit. For each search item, one can also specify at a prompt 890 of whether to have an automatic update of the search, which can be provided on either a weekly, monthly basis or, as may be required, other time frame. One can also specify at a prompt 892 how much information is requested in a range between a little and a lot (illustrated here with a slide bar, but which can be embodied by way of check off boxes, fill in, or other control device). Should it be desirable, one can also specify at a prompt 894 whether to include related subjects. As to formats, one can specify at a prompt 896 one of HTML/PIX format, video format or audio format. Associated with this customization screen are an ok to add key 897, an undo key 898, a next search key 899, a my profile key 848, a my account history key 850, a my eWallet key 852 and a cancel key 851. Should the subscriber want to accept the current preferences as a new active request he would use the ok to add key 897. Should the subscriber desire to cancel the current preferences and return the customize request panel to some default setting he would hit the undo key 898. Should the subscriber want to add a preferences for a new request he would invoke the next search key 899. Should the subscriber wish to modify his profile he would invoke the my profile key 848. Should the subscriber wish to view the details of his account he would invoke the my account history key 850. Should the subscriber wish to either see the details of his online cash status or else make a purchase he would invoke the my eWallet key 852. Should the subscriber decide to not customize his current request he can use the cancel key 851 to return to the previous screen 802.

Should the subscriber want to share results from his information requests with his friends he can use the cc: share info feature 895. This opens a new window with a title of cc: share info 801 and two main sections: the first section is used to create a new list of friends or groups 802 and the second section provides the subscriber with the ability to choose from an existing list of friends or groups 807. In the first section the subscriber can enter name(s) into the text entry area 803 while using the scroll controls 804 to the right of the text entry area for seeing the parts of the list which aren't currently visible within the text entry area. The subscriber can also name the current list in text entry area 805 and when the subscriber has completed building his list he can save the list to his account profile by using the save list key 806. Should the subscriber wish to use an existing list he can click on pull down menu 813 and select a list from his pull-down menu of lists. After the subscriber has selected a list the name of the list appears in the text box at 813 and a listing of the contents of the list appear in text box 809. The subscriber may scroll the information in 809 to see areas of the list that are not currently visible in the box. The subscriber can use the check off boxes in the text box 809 to select people from the list to send to, or the subscriber can send to the whole list easily by invoking the add all key 815. Should the subscriber want to modify an existing list he can use the edit list key 817. When the subscriber has selected the people he would like to share his at my request results he would then use the accept changes key 823 to activate his share info preferences. Should the subscriber change his mind and decide not to share his request information he can use the cancel key 849 to close the cc: share info window and return to the previous screen (802 or 804).

Should the subscriber desire to receive at my request information on more than one terminus device he can use the delivery device key 879 to select any number of terminus device(s) as the recipients of his request information. When the delivery device key is used a new window pops up with the title of delivery device preference 825 and is broken into two sections. The top section allows the user to specify whether the delivery device preferences will be for only the currently active request 826 or whether the delivery device preferences will be for all the subscriber's requests 827. In the bottom section the subscriber can make selections by checking off delivery devices on the left side and then filling in the appropriate device information in the text entry area to the right of each selection. The subscriber can select to send request information to home e-mail 828, web-based e-mail 829, office e-mail 831, web phone 833, wireless PDA 835, pager 837, instant messenger 839, network printer 841, Internet appliance 843 and fax or phone 845. Once the subscriber has made his selections he can activate the device delivery preferences by using the accept changes key 867. Should the subscriber decide to not specify an alternative delivery device, he can use the cancel key 847 to go back to the previous menu (802 or 804).

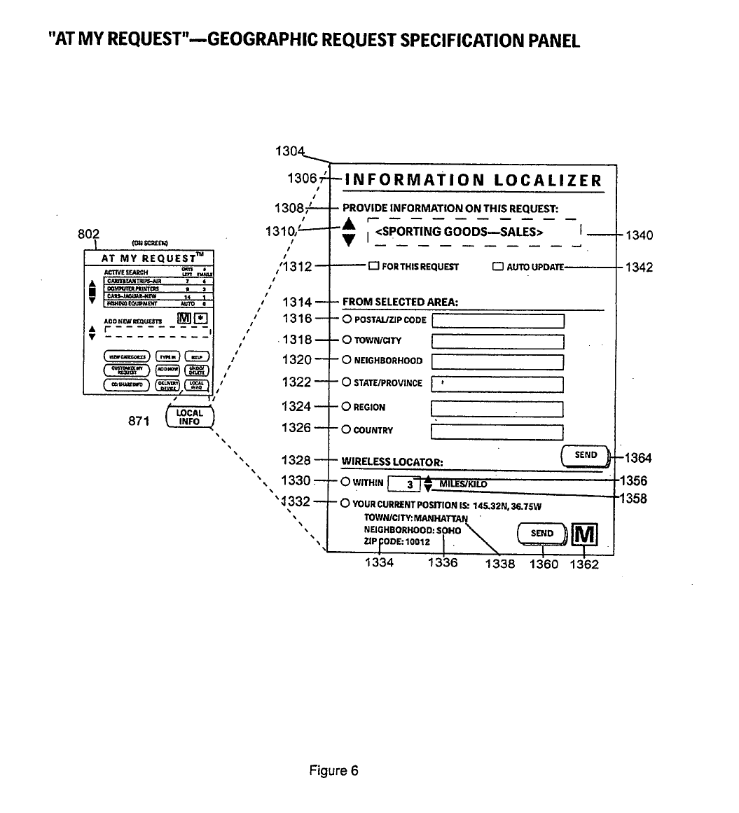

FIG. 6 illustrates an “At My Request” Subscriber Control Panel for designating geographic request specifications. This information control panel is launched from the main “At My Request” Subscriber Control Panel 802 by depressing the local info key 871. The Information Localizer panel 1304 has a title of Information Localizer 1306 and is divided into three sections titled “provide information on this request” 1308, “from selected area” 1314, and “wireless locator” 1328. In the top section 1308, the subscriber can select his list of active requests in the window at 1340 by using the scroll bars at 1310. The subscriber can also specify that the geographic parameters be used for on the currently selected request 1312 as well as for the request to be auto updated 1342.

In the middle section, “from selected area” 1314, the subscriber can designate the postal/zip code 1316, town/city 1318, neighborhood 1320, state/province 1322, region 1324, country 1326 by filling in the information in the entry area to the right of the aforementioned preferences. When the subscriber has completed his request, he can press the send key 1364 to activate the request.

In the bottom section, “wireless locator” 1328, the subscriber can input a radius in miles or kilometers from which he seeks information. The subscriber can use the up and down buttons 1358 to the right of the entry area to advance the number up or down 1 integer. The subscriber is given his current GPS coordinates in item 1332, his current town/city location in 1338, his current neighborhood in 1336 and his current zip code in 1334. When the user has entered the radius of the search in 1356, he may then press the send key 1360 to activate the search.

The subscriber may activate the Mobile key symbol—a capital M in a box—1362 to quickly tell the system to send a copy of the requested information to his default mobile device.

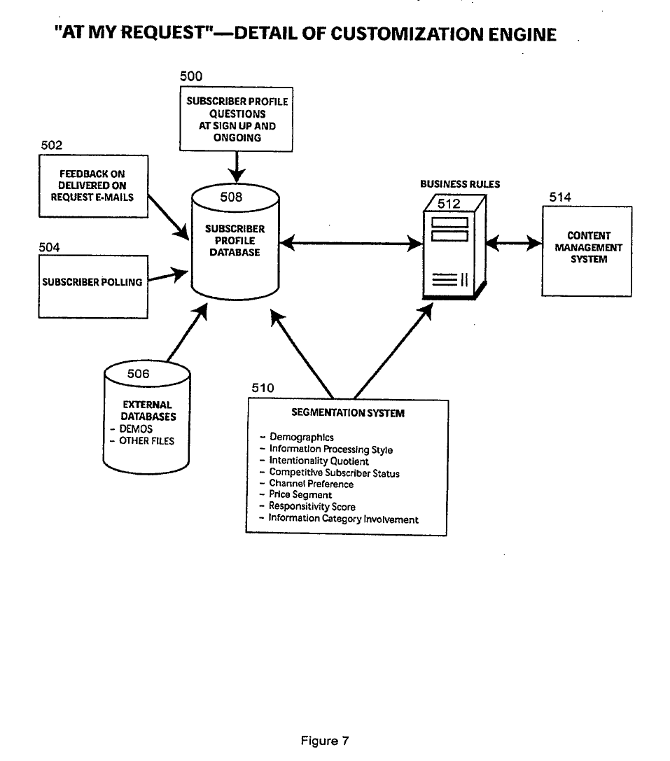

FIG. 7 illustrates an embodiment of the Information Customization Engine (see 218) of the present invention. All user profiles are stored in a Subscriber Profile Database 508. The Subscriber Profile Database receives Feedback On Delivered On Request e-Mails 502, receives answers to Subscriber Profile Questions At Sign Up and Ongoing 500, receives results of Subscriber Polling 504, receives information from External Databases 506, is acted upon by a Segmentation System 510 and intercommunicates with a Business Rules Server 512.

A new subscriber is given a prompt at step 500 which asks the Subscriber Profile Questions before the Subscriber finishes signing up for the At My Request service. Later the Subscriber's profile is maintained by additional Ongoing questions. A user can express like, dislike and other types of feedback with respect to the delivered opt-in e-mails 502.

External Databases 506 are coordinated with information in the Subscriber Profile Database 508 in order to increase the amount of information available about Subscribers. For instance, a Subscriber's zip code could be cross-referenced with a third parties database allowing the system to infer knowledge about the subscriber with respect to the information contained in the third party's database about the Zip Code in the subscriber's profile.

Working in tandem with the Business Rules 512 and the Subscriber Profile Database 508 the Segmentation System 510 creates narrowly targeted lists based on specified criteria and business rules. These targeted lists could be as small as a single person and as large as the number of entries in the Subscriber Profile Database. The targeted lists are then used by the Content Management System 514 to fulfill subscriber requests with targeted and/or personalized advertising/information.

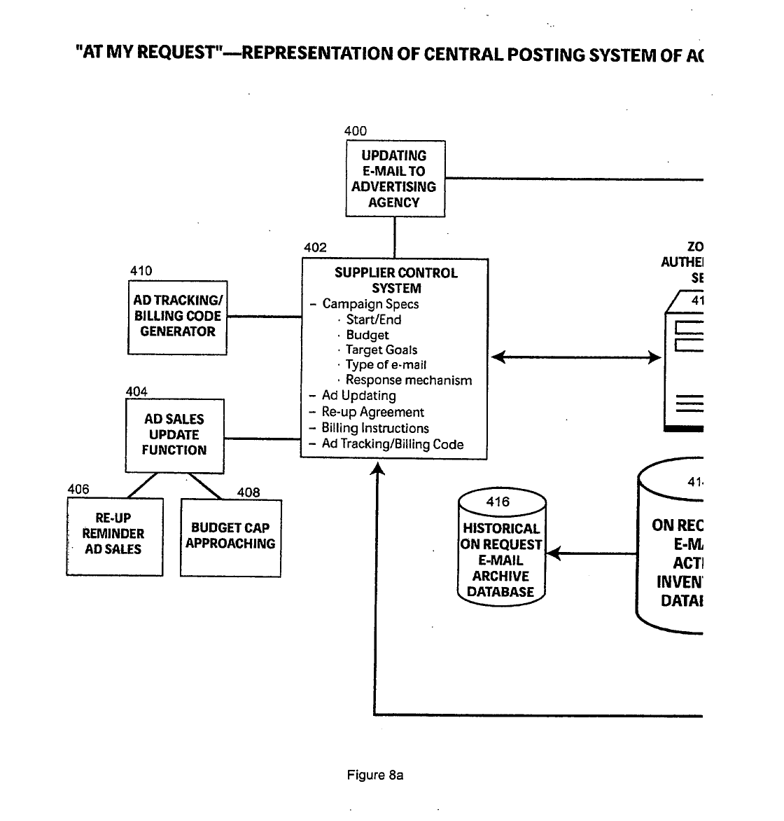

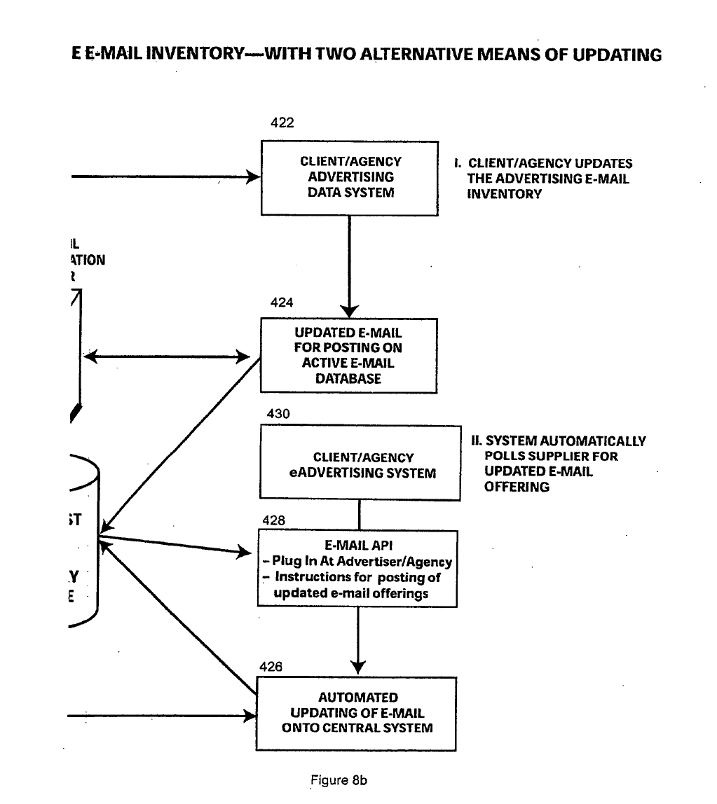

FIG. 8 illustrates a third embodiment of the present invention that representatively describes a system for central posting by Suppliers of active e-mail inventory with two alternative means of updating.

The Supplier is first authenticated to use the system by the ZoEmail Authentication Server 412. If the Supplier is authenticated then the Supplier has access to the features made available through the Supplier Control System 402. The Supplier Control System communicates with the Ad Sales Update Function 404, the Ad Tracking/Billing Code Generator 410, the ZoeMail Authentication Server 412 and sends an e-Mail Update to the Client/Agency Advertising Data System 422 through the Updating E-Mail To Advertising Agency 400.

The Supplier Control System 402 allows the supplier to set parameters such as start/end dates, budget, target goals, type of e-mail delivered, response mechanism as well as providing the Supplier with access to functionalities such as Ad Updating completed by the Ad Sales Update Function 404, Re-Up Agreement completed by Re-Up Reminder Ad Sales 406, Billing Instructions and Ad Tracking/Billing Code completed by Ad Tracking/Billing Code Generator 410.

The Ad Sales Update Function 404 provides the supplier with a means to insert new ad inventory or update existing ad inventory. The Re-Up Reminder Ad Sales 406 system prompts the supplier to renew, extend or start a new campaign when certain limits or quotas are about to be meet. The Budget Cap Approaching system 408 alerts the supplier when the specified Budget Cap is about to be met and gives the Supplier the opportunity to increase the Budget Cap or to enact rules specified by the Supplier in the Supplier Control System 402. The Ad Tracking/Billing Code Generator 410 applies a code schema to advertising so that it may be tracked for both effectiveness and the Supplier's campaign specifications.

The supplier may work with an agency and may allow the agency to run advertising campaigns on its behalf through the Client/Agency Advertising Data System 422 is connected to Updated E-Mail For Posting On Active e-Mail Database 424 and Updating e-Mail To Advertising Agency 400. The Client/Agency Advertising Data System is used by the client or agency who are first authenticated by the Authentication Server 412 and then are allowed to make changes to the Supplier's e-mail inventory. The Client or Agency can also specify which informational e-mails in the inventory should be posted on the On Request E-Mail Active Inventory Database 414 at step 424.

If the Supplier wishes to run its own campaigns it can update its e-mail inventory through the Automated Updating of e-Mail Onto Central System prompt at step 426 which then updates the Suppliers inventory in the On Request e-Mail Active Inventory Database 414. The Automated Updating of e-Mail onto Central System 426 is also controlled by the e-Mail API 428 which is embodied by a control panel in the form of a plug-in or other type of application and is maintained by either the Supplier or the Agency. The e-Mail API allows the Supplier/Agency to provide instructions for the posting of updated e-mail offerings to the Central System. The e-Mail API 428 is a sub-component of the Client/Agency eAdvertising System 430.

The Historical On Request e-Mail Archive Database 416 communicates with the On Request e-Mail Active Inventory Database 414 and stores a historical record of all inventory.

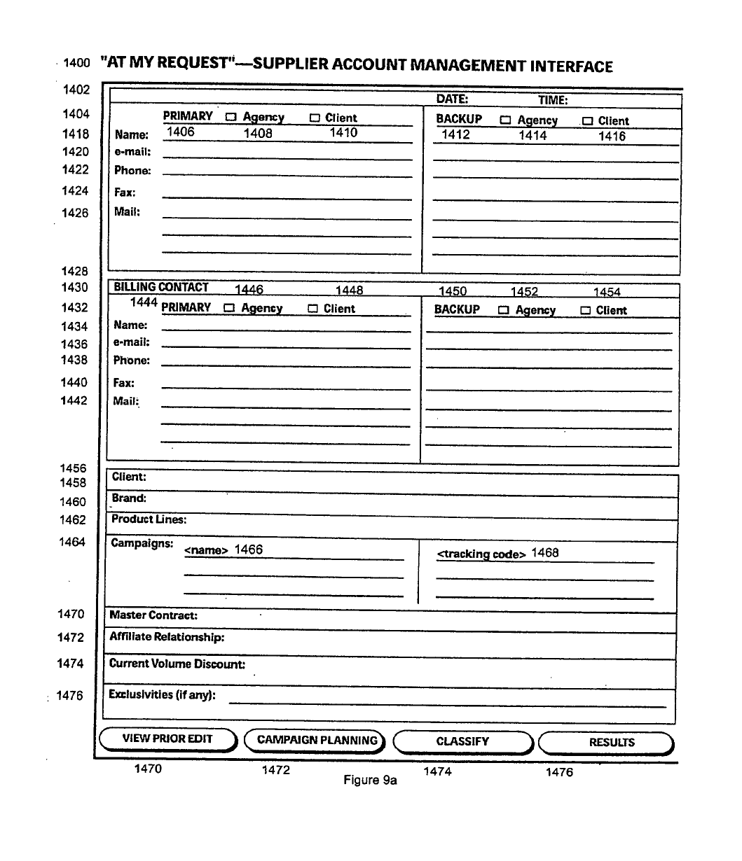

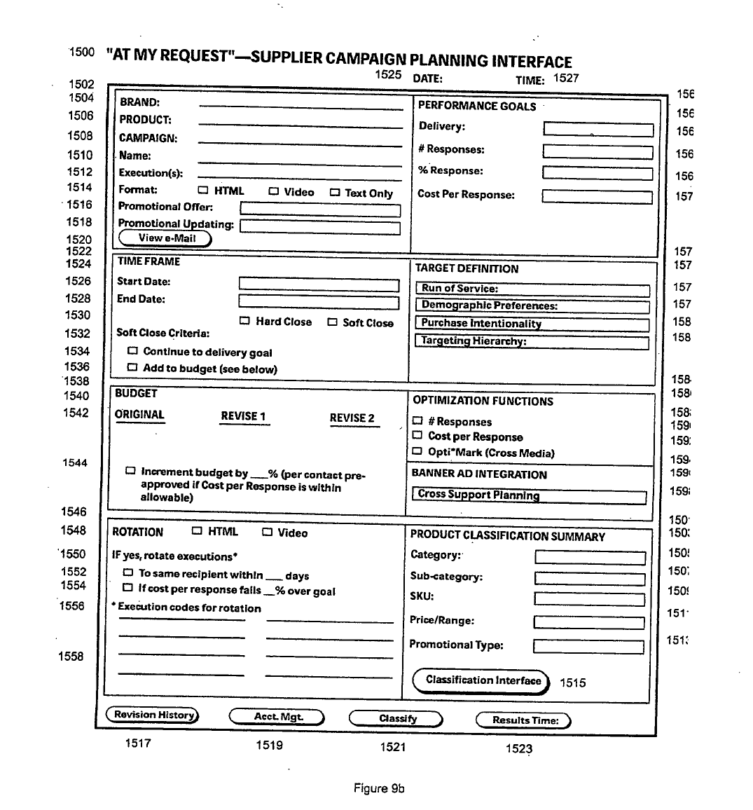

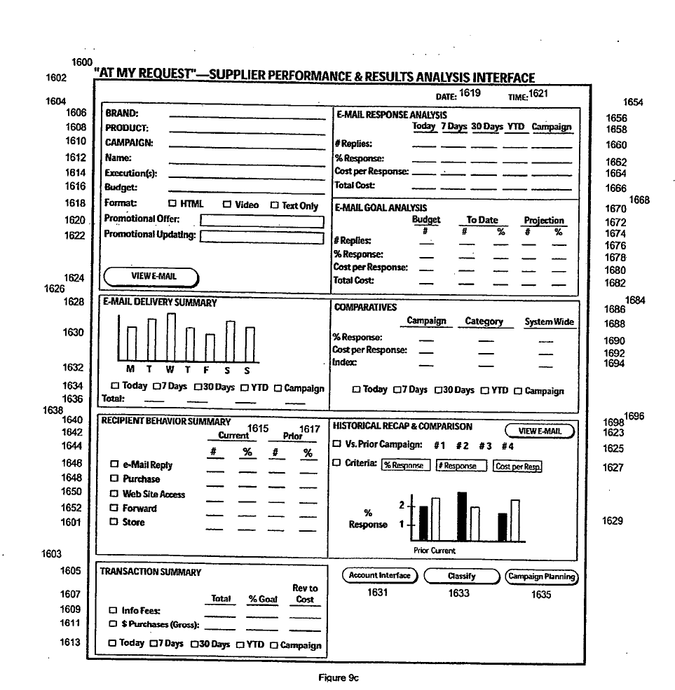

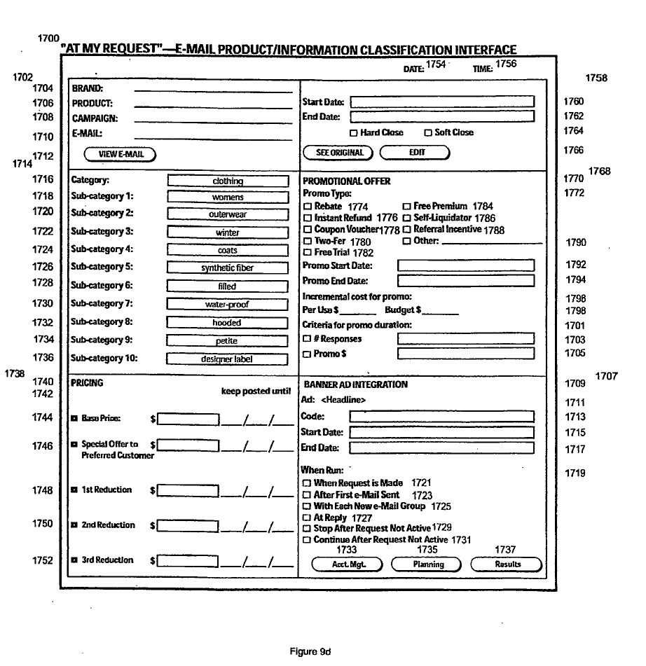

FIGS. 9a, 9b, 9c and 9d illustrate information management and preference screens for Supplier/Information Producers of the present invention.

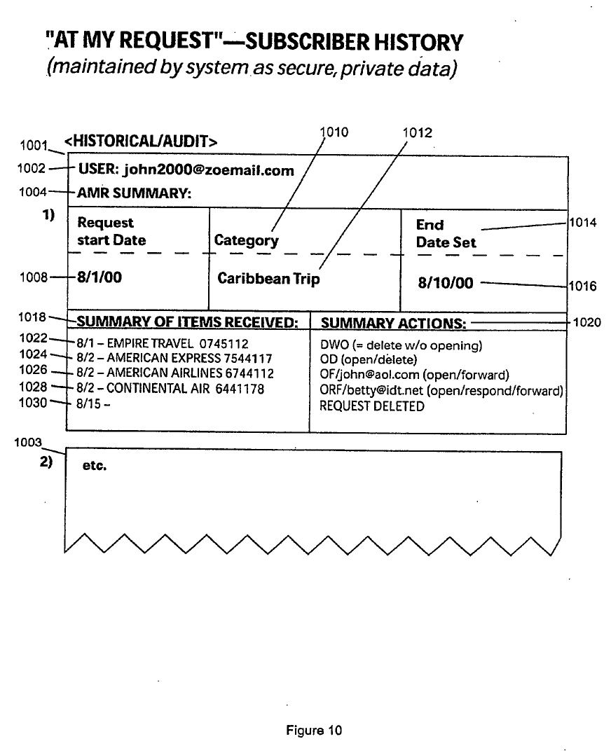

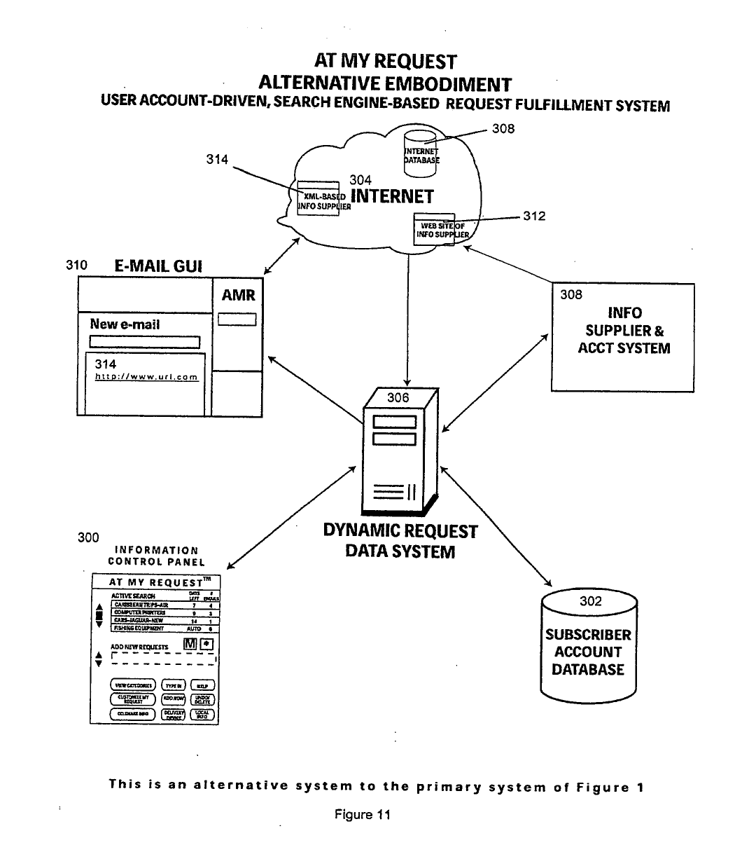

FIG. 10 illustrates a sample at your request user history record 1000. This record contains two windows 1001 and 1003. Window 1001 contains a user identifier area 1002 recording the email address of the user. Below the identifier area 1002 is a at my request summary statement 1004, which is temporarily left blank for this user.

Regarding search events, there is a search category 1010 indicating a search of a Caribbean Trip 1012. The request of the search has a starting date 1008 on August 1, 2000 and an ending date 1016 on August 10, 2000.

There is a summary of items sent 1018 recording all results that have been sent. Adjacent to this summary is a summary action 1020 recording how the search result is treated by the user. As illustrative examples, item 1022 indicates result of an Empire Travel 0745112 delivered on August 1 that was deleted without opening. Item 1024 indicates result of an American Express 7544117 delivered on August 2 that was opened and deleted. Item 1026 indicates result of an American Airline 6744112 delivered on August 2 that was opened and forwarded to john@aol.com. Item 1028 indicates a Continental Air 6441178 delivered on August 2 that was opened, responded and forwarded to betty@idt.net. Item 1030 indicates a request that was deleted before any result is delivered.

Window 1003 is the history record for a second user request.

FIG. 11 illustrates an alternative system embodiment of the present invention, which is structured as a subscriber account-driven, search engine-based request and fulfillment system.

The Information Control Panel 300 is connected to the Dynamic Request Data System 306 and provides the subscriber with an interface allowing the subscriber to specify requests and establish specific request parameters including all of the parameters identified in FIG. 5.

The Dynamic Request Data System 306 is at the hub of the system and is in direct contact with the Information Control Panel 300, The Subscriber Account Database 302, The Internet 304 and sources of Information on the Internet (312, 314 and 316), Supplier and Accounting System 308 and an e-Mail GUI 310. The Dynamic Request Data System includes a Search Engine, a Data Warehouse or Database, a Business Rules Database and eMessaging Servers. The Dynamic Request Data System searches over the Internet for information to fulfill a Subscriber's parameters as expressed in the Information Control Panel and then packages the information as an html or ASCII text e-mail with or without an attachment and sends the e-mail to the e-Mail GUI 310. The html e-mail may contain hyperlinks 314 to locations on the Internet 304.

The Dynamic Request Data System 306 is capable of using all available communication protocols such as HTML, XML, FTP, Archie, Gopher, Veronica, WAP, et al. as well as search all publicly available sources of information including Databases 316, XML-based Information Suppliers 314 and Web Sites 312.

The Dynamic Request Data System 306 can be configured by the Information Suppliers and Accounting Function 308 to search first in specific data sources and then to present the data in a customized form or rank order.

The Subscriber Account Database 302 intercommunicates with the Dynamic Request Data System 306. The Subscriber Account Database tracks subscriber requests and the fulfillment of subscriber requests with respect to the duration, the quantity of information and other specific preferences as defined by the Subscriber at the Information Control Panel 300.

FIG. 12 illustrates a flow chart diagram for a User Account Holder of the present invention. As to the Subscriber Use Case Statement (FIG. 6), Subscriber uses @MyRequest panel to enter the specification of his/her request for commercial advertisement. The system ensures that the Subscriber has already signed up for the service before processing the request. If Subscriber is not already signed up for the service, the system will prompt Subscriber for some basic information (such as e-mail/eMessaging address, demographic information) via the service sign-up panel, and process the request once sign up process is validated.

Should a new user attempt to open an account or an old user attempt to enter an existing account, both type of users gain access to the present invention system through the logic flow set forth herein beginning at step 600. At the very beginning of the process, a determination is made to distinguish a new user from a user with an existing account, as shown in step 602. While a user with an existing account signs in immediately at step 616, a new user must sign up for the service at step 604, enter all prompted information as account information at step 606, enter all prompted information as user contact information at step 608, and enter all desired options upon prompting as preference information at step 610. The information entered through steps 604 to 610 are added into a new customer information system database, as shown in step 612. Immediately after the sign up service is completed, relevant information of the customer is sent to an address obtained from step 608 to confirm that the sign up process has been successfully completed along with other relevant information such as customer number, account number, password, etc. The user is then redirected at step 614 to the sign in at step 616 to take advantage of the present invention system. Once successfully signed in, a main menu is displayed at step 618. From which menu, five options can be readily selected. The options include add new request at step 620, update account information at step 632, sign off at step 652, track request status at step 658 and update cc: share list at step 683. Even though the exemplary main menu shows only five options, more options can be easily made available, such as viewing account history, establishing user personal files, providing customer tools, etc.

Should the user choose the add new request option at step 620, a prompt asking the user to define request category is provided as shown in step 622, a prompt asking the user to define request duration is provided as shown in step 624, a prompt asking the user to define request quantity is provided as shown in step 626, a prompt asking the user to define request receiving terminus as shown in step 628, and followed by a prompt asking the user to define other request specifications as shown in step 630. Thereafter, the main menu 618 is shown allowing the user to choose further options.

Should the user choose the update account information option at step 632, the system begins tracking the account information as shown at step 634 and the user is given three options at step 634 of updating account information as shown in step 636, check account balance as shown in step 642 and go back to previous menu as shown in step 650. If the user chooses to update account information at step 636 a prompt asking the user to update contact information is provided at step 630, followed by a prompt asking the user to update contact information is provided at step 638, a prompt asking the user to update preference information is provided at step 640 and at the conclusion of step 640, the user is directed back to the menu at step 634.

Should the user choose to check account balance as shown in step 642 the system then queries the user account history/balance at step 644, displays a prompt asking whether the user wants to make a payment as shown in step 646 and if the user wants to make a payment the payment is processed as shown in step 648 and the user is taken back to the menu at step 634. If the user decides not to make a payment he is taken back to the menu at step 634. Should the user choose to go back to the previous menu at step 650 the user is then taken to the Main Menu at step 618.

Should the user choose to sign off at step 652, the system resets the subscriber session state at step 654 and ends the transaction at step 656.

Should the user chooses to track request status of outstanding requests at step 658, the user is presented with a track request menu at step 660 with options of either query request at step 662, modify request at step 668, delete request at step 678 or go back to the previous menu at step 682.

Should the user choose query request at step 662, the user is prompted to enter query specification at step 664 and then the system returns the results from the query to the user at step 666. Should the user choose modify request at step 668, the user is prompted to update request category as shown in step 670; user is prompted to update request duration as shown in step 672; user is prompted to update request quantity as shown in step 674; user is prompted to update request receiving terminus as shown in step 676; and the user is then taken back to the track request menu at step 660. Should the user choose delete request at step 678, the user is prompted to specify an existing request as shown in step 680, the user is prompted to delete specified request at step 681 and then the system returns the user back to the Track Request Menu at step 660. Should the user choose go back to the previous menu at step 682 the user is taken back to the Main Menu at step 618.

Should the user choose Update CC: Share List at step 683, the user is taken to the update cc: share list menu as shown in step 684. From this menu the user is provided with five options: create new share list as shown in step 685, remove existing share list as shown in step 688, add new buddy to the list as shown in step 692, remove buddy from the list as shown in step 695, and go back to previous menu as shown in step 699. Should the user choose create new share list at step 685, the user is prompted to add new share list to system DB and then the system returns the user back to the Update cc: share list menu at step 684. Should the user choose remove existing share list at step 688, the user is prompted to specify an existing share list as shown in step 690, the user is prompted to remove specified share list from system database as shown in step 691 and then the user is returned to update cc: share list menu as shown in step 684.

Should the user choose add new buddy to the list at step 692, the user is prompted to specify an existing share list as shown in step 693, the user is prompted to add new buddy to the specified list at step 694 and then the user is taken back to the update cc: share list menu as shown in step 684.

Should the user choose remove buddy from the list at step 695, the user is prompted to specify an existing share list at step 696, the user is prompted to specify an existing buddy at step 697, the user is prompted to remove specified buddy from the specified list at step 698, then the user is returned back to the Update CC: Share List Menu as shown in step 684.

Should the user choose go back to previous menu the user is taken back to the Main Menu as shown in step 618.

FIG. 13 illustrates a flow chart diagram for an Advertiser [or Information Supplier] Account Holder. Regarding the Supplier Use Case Statement (FIG. 13), Supplier uses @MyRequest panel to enter the specification of his/her commercial advertisement inventory. The system ensures that the Supplier has already signed up for the service before processing the request. If Supplier is not already signed up for the service, the system will prompt Supplier for some basic information (such as e-mail or other eMessaging address, accounting/financial information) via the service sign-up panel and process the request once sign up process is validated. Supplier can specify the category, start/end date for his/her commercial advertisement/information, the target budget, prospect preference hierarchy, frequency, reach (or percentage of the market), response, goals, etc. The Supplier has the option of making changes to request specification or account information later.

This flow chart diagram is the counterpart of the diagram in FIG. 12. This means while the user makes request in the flow chart shown in FIG. 6, advertisers fulfills the user's request as well as setting the parameters by which the advertisers are willing to provide the advertisements. At the very beginning stage of the logic flow, a determination is made regarding whether an advertiser has already registered, as shown in step 702. If yes, the advertiser signs in at step 716. If no, then the advertiser must sign up for the on request service at step 704, enter advertiser contact information at step 706, enter advertiser billing account information to the provider of the at my request service at step 708, enter advertiser preference information at step 710 and information collected from the foregoing steps are added to an advertiser information system database, as shown in step 712. The system of the present invention then sends relevant information to the advertiser contact address to confirm that an account has been successfully established and the advertiser can sign in the system of the present invention to use services associated therewith, as shown in step 714.

After signing in at step 716, a main menu is provided at step 718. The advertiser may select one of many service options including adding new commercial information at step 720, tracking account information at step 732, tracking commercial inventory status at step 754, and signing off at step 784. Once the advertiser selects the adding new commercial information option at step 720, the advertiser may define commercial information category at step 722, define commercial information budget at step 724, define commercial information duration at step 726, define commercial information coverage goal/frequency at step 728, define other commercial information preferences at step 730, and finally return to the main menu for other selections.

Should the advertiser choose to track account information as shown in step 732, the advertiser is taken to the track account information menu at step 734 and provided with three options: update account information at step 736, check account balance at step 744 and go back to previous menu at step 752. Should the advertiser choose to update account information as shown in step 736, the advertiser is prompted to update contact information at step 738, the advertiser is prompted to update billing/account information at step 740, the advertiser is prompted to update preference information at step 742, then the advertiser is returned back to the track account information menu at step 734. Should the advertiser choose check account balance as shown in step 744, the system queries the history/balance of the advertiser at step 746 and the advertiser is prompted to make a payment at step 748. If the advertiser makes a payment at step 748, the payment is processed at step 750. If the advertiser chooses to not make a payment, the advertiser is taken back to the track account information menu as shown in step 734. Should the advertiser choose go back to the main menu as shown in step 752, the advertiser is taken back to the Main Menu as shown in step 718.

Should the advertiser choose to track commercial information inventory status as shown in step 754, the advertiser is taken to the track commercial information inventory menu as shown in step 756. From this menu the advertiser has four options: query commercial information inventory at step 758: delete commercial information inventory at step 764; update commercial information inventory at step 770 and go back to previous menu at step 782.

Should the advertiser choose query commercial information inventory as shown in step 758, the advertiser is prompted to enter query specification at step 760, the system returns results from the query at step 762 and the advertiser is taken back to the track commercial information inventory menu at step 756.

Should the advertiser choose delete commercial information inventory as shown in step 764, the advertiser is prompted to specify an existing commercial information inventory at step 766, the advertiser is prompted to delete specified commercial information inventory at step 768 and then the advertiser is taken back to the track commercial information inventory menu as shown in step 756.

Should the advertiser choose update commercial information inventory as shown in step 770, the advertiser is prompted to update commercial information budget at step 772; the advertiser is prompted to update commercial information duration at step 774; the advertiser is prompted to update commercial information coverage goal at step 778; the advertiser is prompted to update commercial information frequency at step 776; the advertiser is prompted to update commercial information category at step 780 and then the advertiser is taken back to the track commercial information inventory menu as shown in step 756.

Should the advertiser choose go back to the main menu as shown in step 782, the advertiser is taken back to the Main Menu as shown in step 718.

Should the advertiser choose to sign off 784 from the main menu 718, the system resets the supplier session state as shown in step 786 and then terminates the session as shown in step 788.

Once the advertiser selects the tracking advertisement status option at step 740, a track advertisement menu is given at step 742 so that an advertiser may select a number of options including querying advertisement information at step 744, updating advertisement information at step 750 and removing advertisement information at step 762, among other possible options. If the querying advertisement information option is selected at step 744, the advertiser may enter query specification at step 746 and allow system to return results from the query at step 748 before returning to the track advertisement menu at step 742.

If the advertiser selects the update advertisement/information option at step 750, the advertiser may update advertisement budget at step 752; update advertisement frequency at step 754; update advertisement category at step 756; update advertisement reach at step 758 and update advertisement duration at 760 before returning to the track advertisement menu at step 744.

If the advertiser wishes to remove advertisement information thus chooses such an option at step 762, advertisement is then removed at step 768 before returning to the rack advertisement menu at step 742. Should the advertiser wishes to exit the track advertisement menu at step 742, the advertiser is returned to the main menu at step 718.

If the advertiser has completed setting all desired options, then the advertiser may sign off at step 764. The system resets advertiser session state at step 766 and all logic flow terminates at step 770.

FIG. 14 illustrates a flow chart diagram for the processing of requests by the present invention. Regarding the System Use Case Statement, after the system has received a request from Subscriber, it looks into its inventory (OrderBook component in Domain Modeling) to see if it can satisfy the Subscriber's request. If it finds the matching item in the inventory, it has an execution. The system then generates two Info Match Up Reports for both Subscriber and Supplier. When Subscriber's Portfolio receives the Info Match Up Reports, it sends an email to Subscriber using the predetermined keyed email address (generated during signup process) with the attached inventory information. When Supplier's Portfolio receives the Info Match Up Reports, it updates the account information to indicate that a complete or partial portion of his/her inventory has been satisfied. When items in Supplier inventory have been satisfied up to a pre-defined threshold, the system will send out email to Supplier using predetermined keyed email address (generated during signup process) to notify Supplier. If Supplier can choose to extend the period of a specific inventory item or to renew his/her credit limit he/she can do so via the Supplier @MyRequest panel. If Supplier chooses neither to extend the period of a specific inventory item nor renew his/her credit limit, the system will not further process Supplier inventory when either the pre-defined period is expired or the credit limit has been reached. Subscriber can also specify the category of information he/she is looking for. Subscriber can use the quantity slide bar (or other indicator device) to define the amount of advertisement/informational email to be received, and uses the “time to live” optional check/fill-in boxes to define the duration of advertisement email to be received. Subscriber can also specify other preferences including delivery device terminus, whether to auto-forward to a “buddy list” (cc's or existing list) or new cc's. Subscriber has the option of making changes to request specification later.

The system determines if it has received a new information request at step 1202 if it has the system processes the new information request according to the existing Business Rules at step 1204 and then the system determines if it has one or more matching orders at step 1206. If the system has one or more matching orders the system generates Trade Reports for both subscriber and supplier at step 1208 and then updates Subscriber and Supplier account information at step 1216. Once the account information is updated the system sends notification to subscriber and supplier at step 1218 and the results of the whole transaction are posted to the audit trail at step 1226. The system then ends the processing of the request at step 1250. If the system does not have one or more matching orders at step 1206 the system then posts new information request to the OrderBook at Step 1210, posts the transaction to the audit trail at step 1226 and ends transaction at step 1250.

If the system has not received a new information request at step 1202, then the system determines whether it has received an Updated Information Request at step 1212. If yes, then the system updates information request in system database at step 1214, updates subscriber and supplier account information at step 1216, sends notification to subscriber and supplier at step 1218, posts the transaction to the audit trail at step 1226 and ends the transaction at step 1250.

If the system has not received an updated information request at step 1212, it then the system determines whether it has received a new transaction request at step 1220. If so, the system validates subscriber and/or supplier financial account information at step 1222, processes the transaction at step 1224; and then updates subscriber and supplier account information at step 1216; sends notification to subscriber and supplier at step 1218; and sends information from step 1224 and step 1218 to the audit trail at step 1226. The system ends the transaction at step 1250.

If the system has not received a new transaction request at step 1220, then the system determines whether it has received a transaction correction request at step 1228. If so, the system finds existing transaction which the subscriber/supplier indicates as needing correction at step 1230, validates the subscriber and/or supplier financial account information at step 1222, processes the transaction at step 1224 and then updates subscriber and supplier account information at step 1216; sends notification to subscriber and supplier at step 1218; and sends information from step 1224; and step 1218 to the audit trail at step 1226. The system ends the processing of the request at step 1250. If the indicated transaction is not found at step 1230, the system then sends an exception notification to subscriber and/or supplier at step 1232 and the information from the transaction is posted to the audit trail at step 1226 and the system ends the transaction at step 1250.

If the system has not received a transaction correction request at step 1228, the system determines whether it has received a business rules update request at step 1234. If so, the system updates the business rules at step 1236 and then posts the transaction to the audit trail at step 1226. The system then ends the transaction at step 1250.

If the system has not received a business rules update request at step 1234, the system determines whether it has received a performance analysis request at step 1238. If so, the system gathers performance analysis data from the system at step 1240 and then sends the result to the requester at step 1242 before ending the transaction at step 1250.

If the system has not received a performance analysis request at step 1238, then the system determines whether it has received a demand analysis request at step 1244. If so, the system gathers demand analysis data from the system at step 1246 and then sends the result to requester at step 1248 before ending the transaction at step 1250. If the system has received an unknown request, it ends the transaction at step 1250.

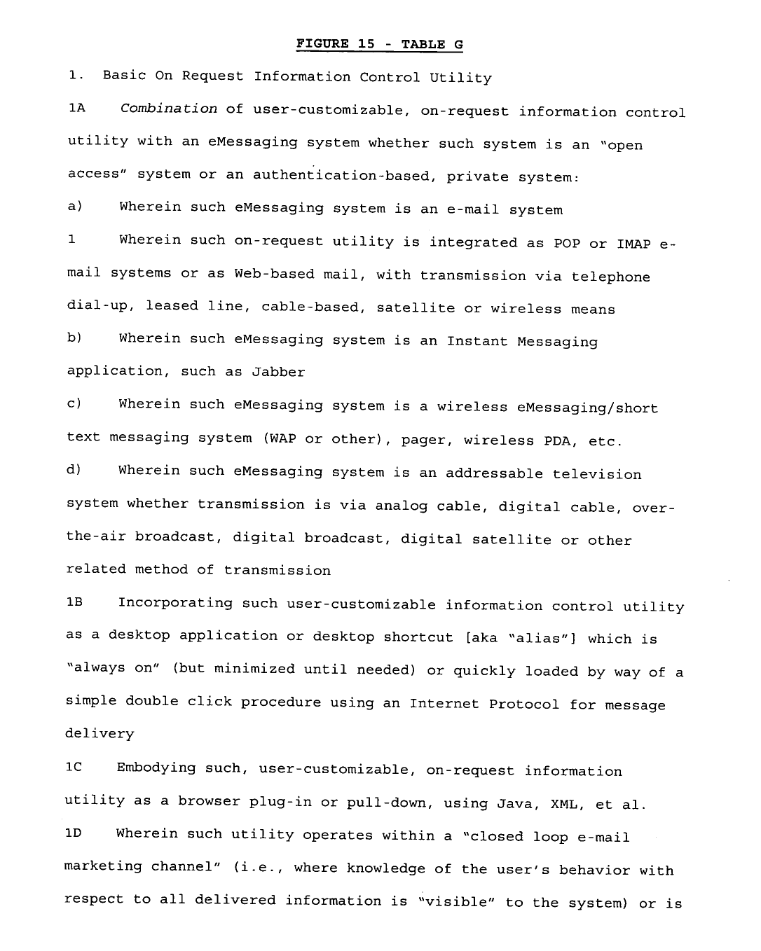

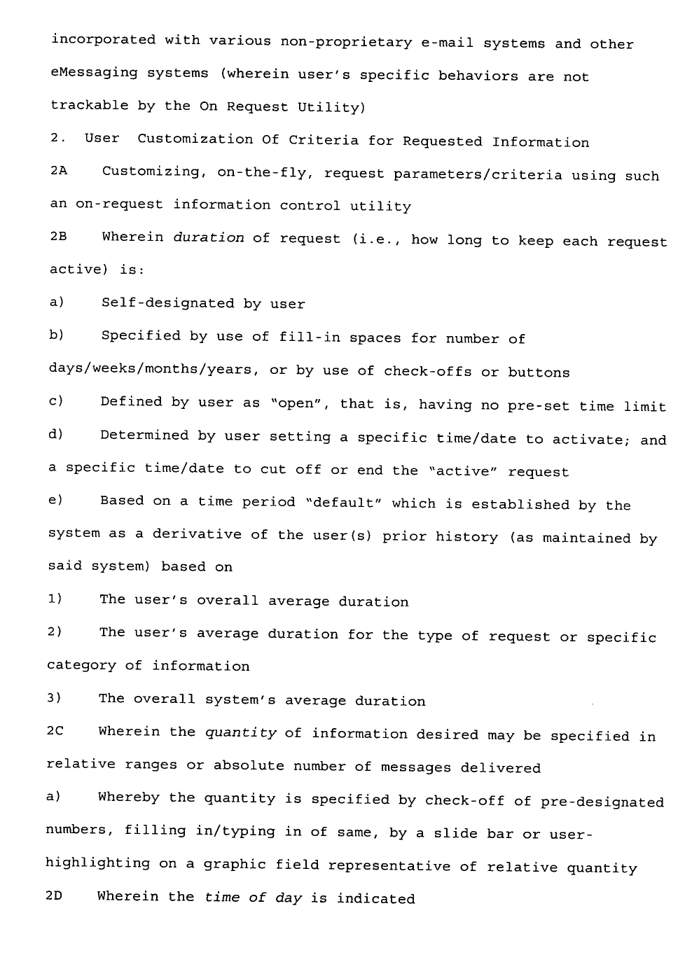

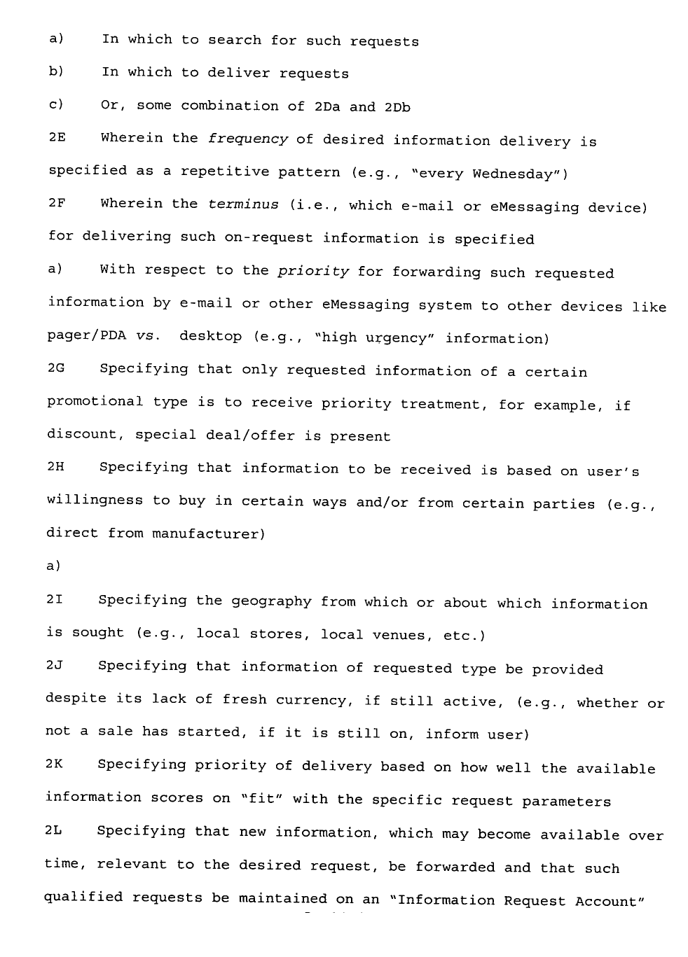

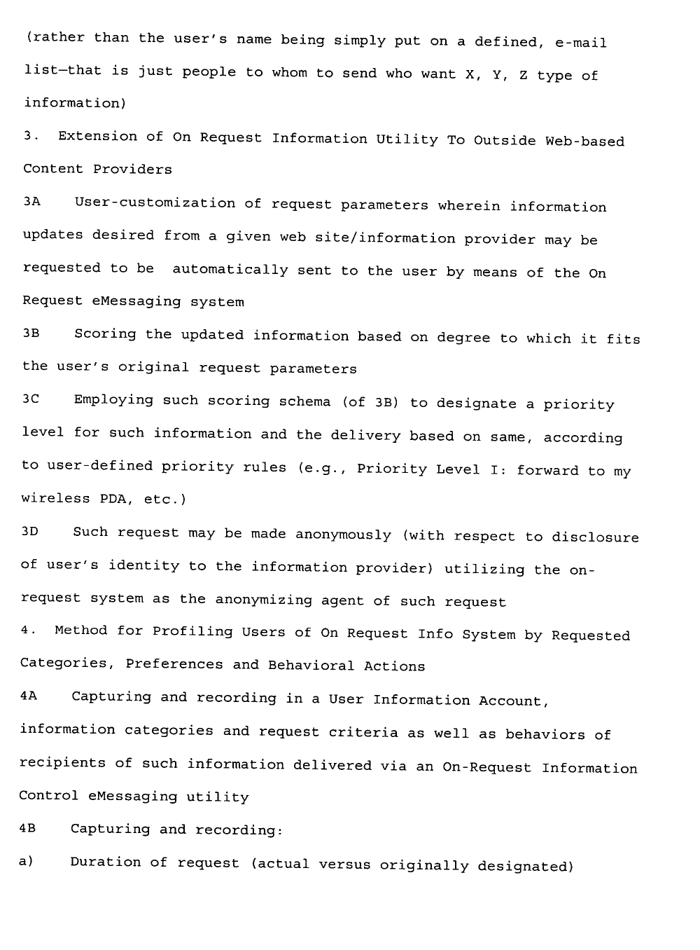

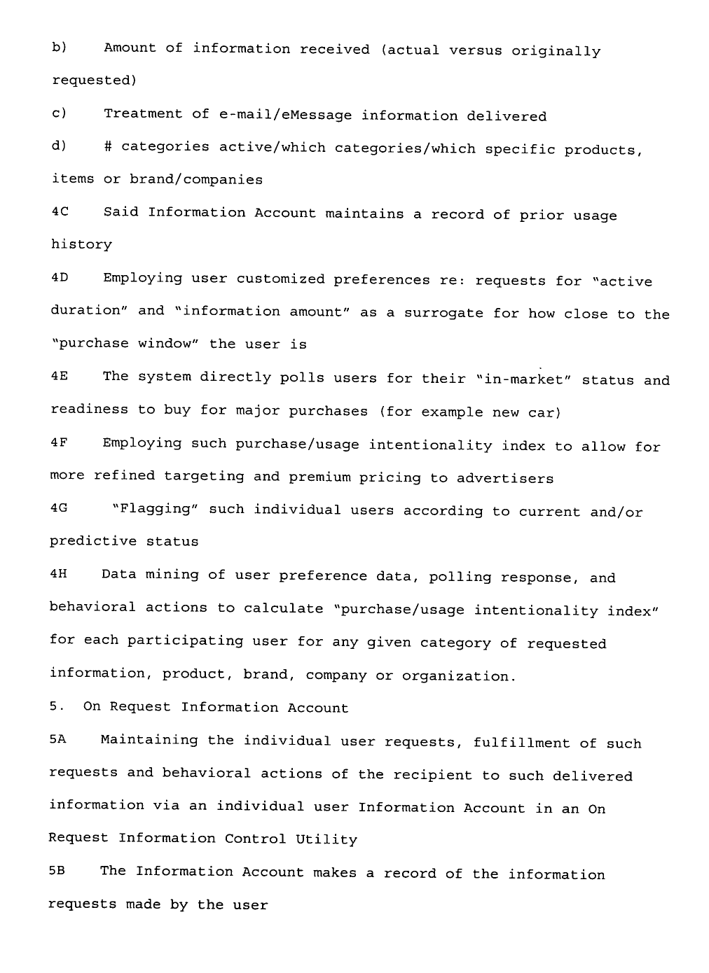

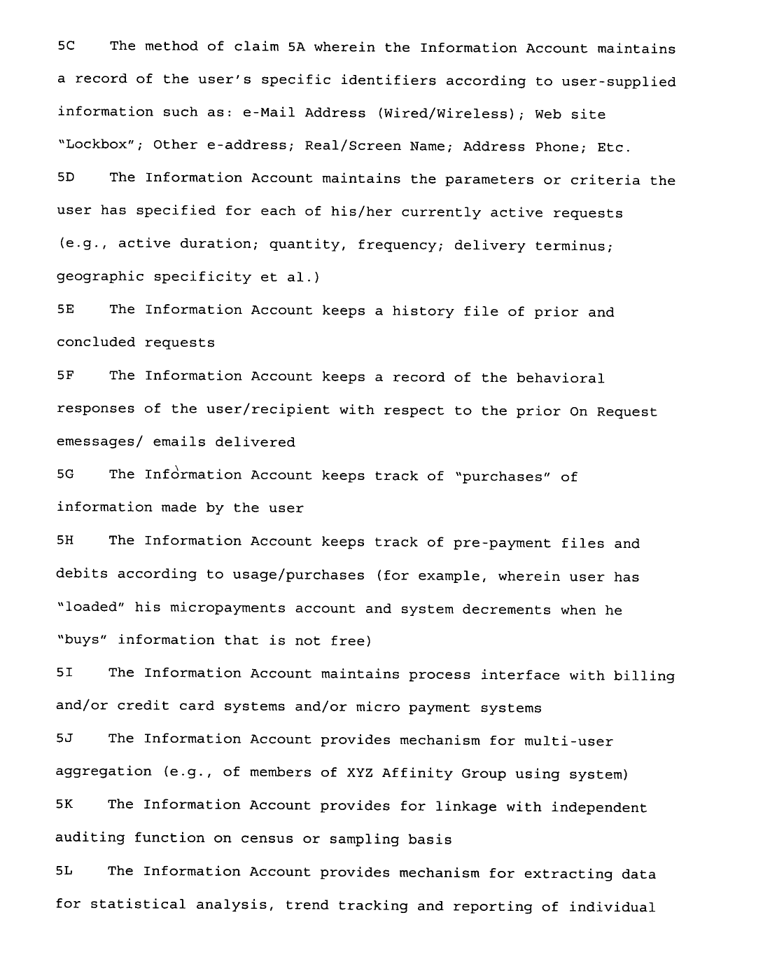

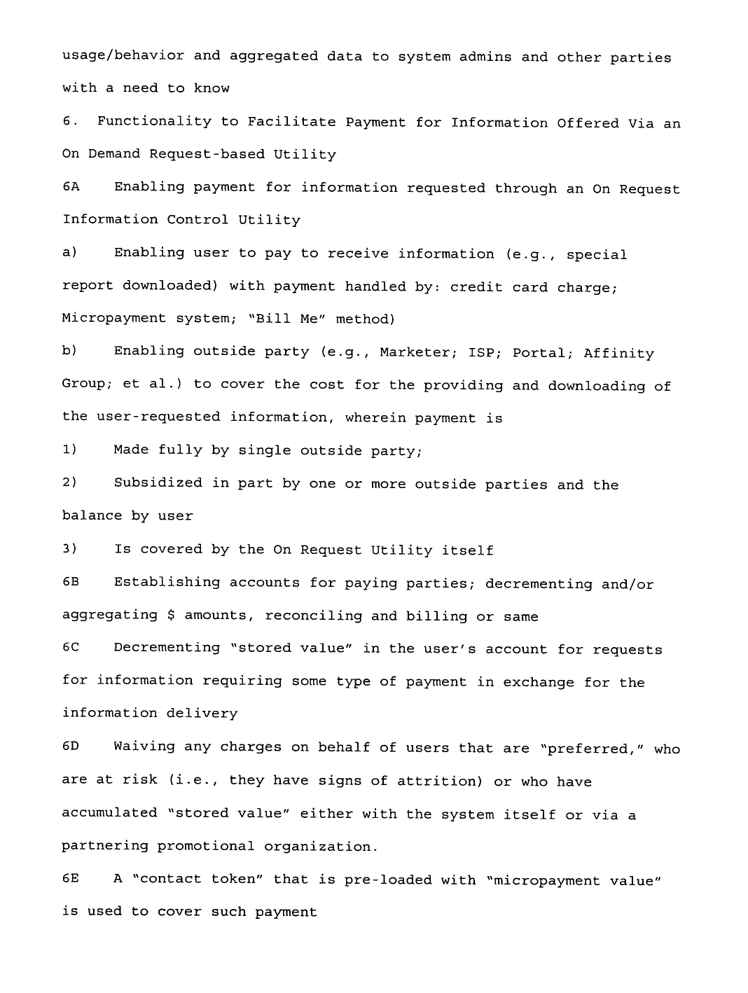

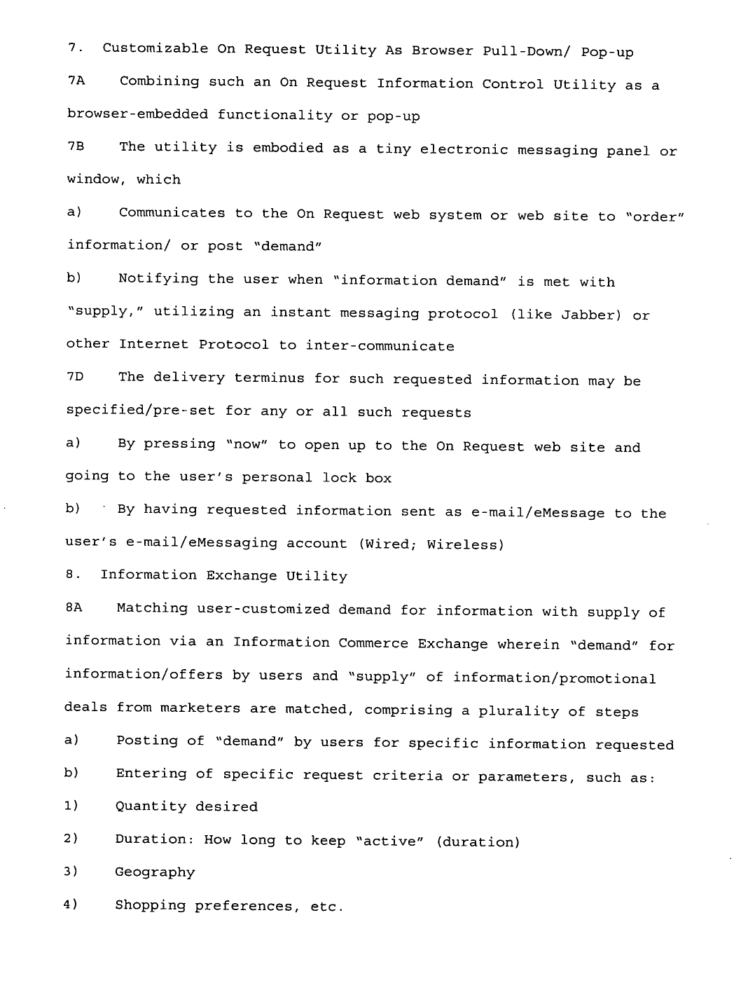

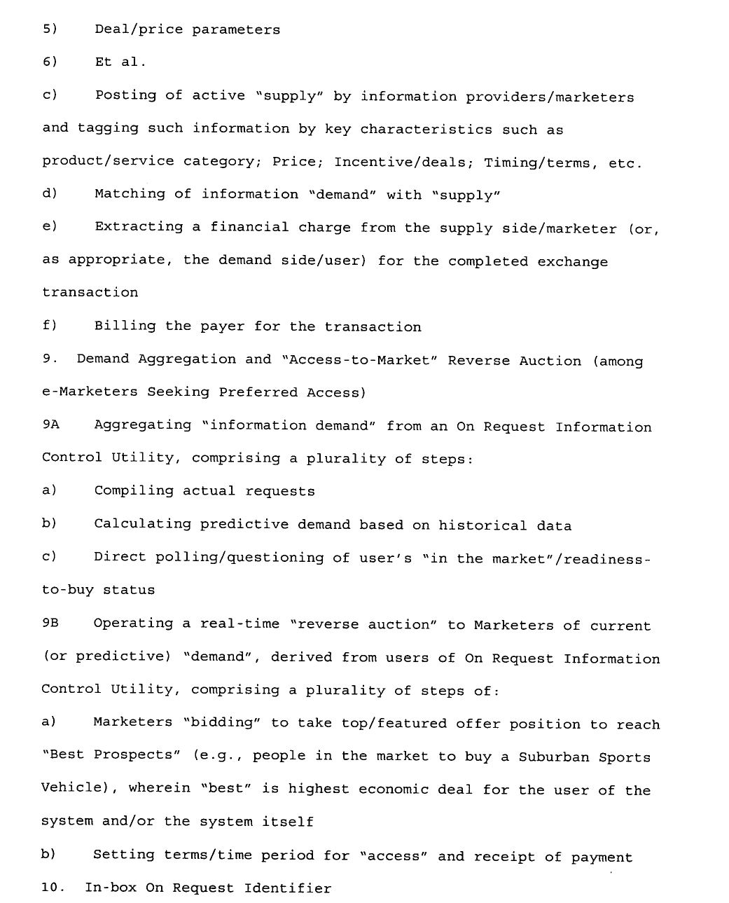

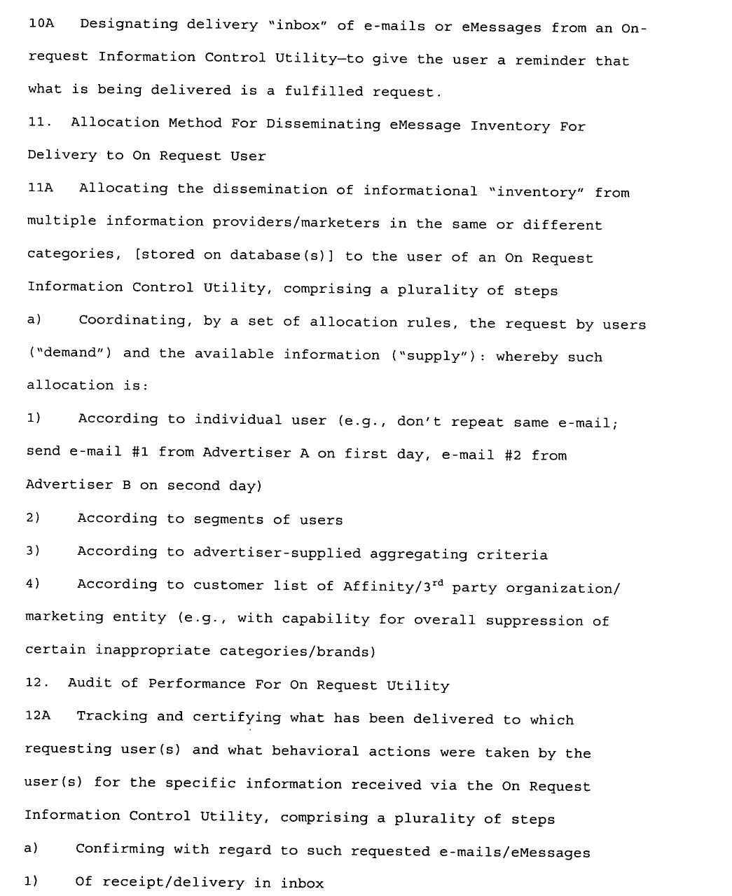

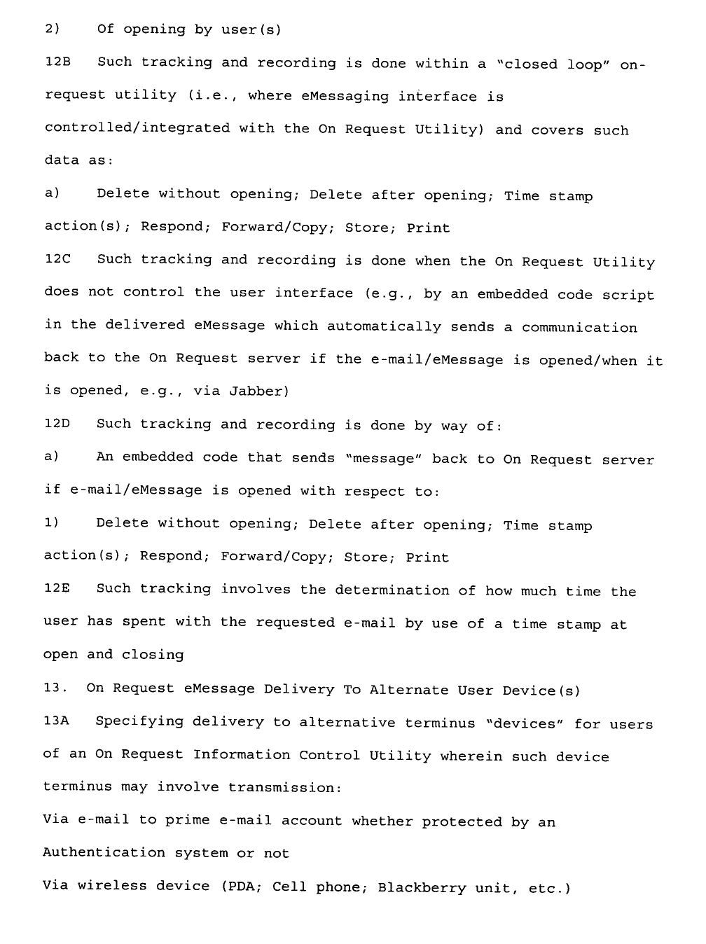

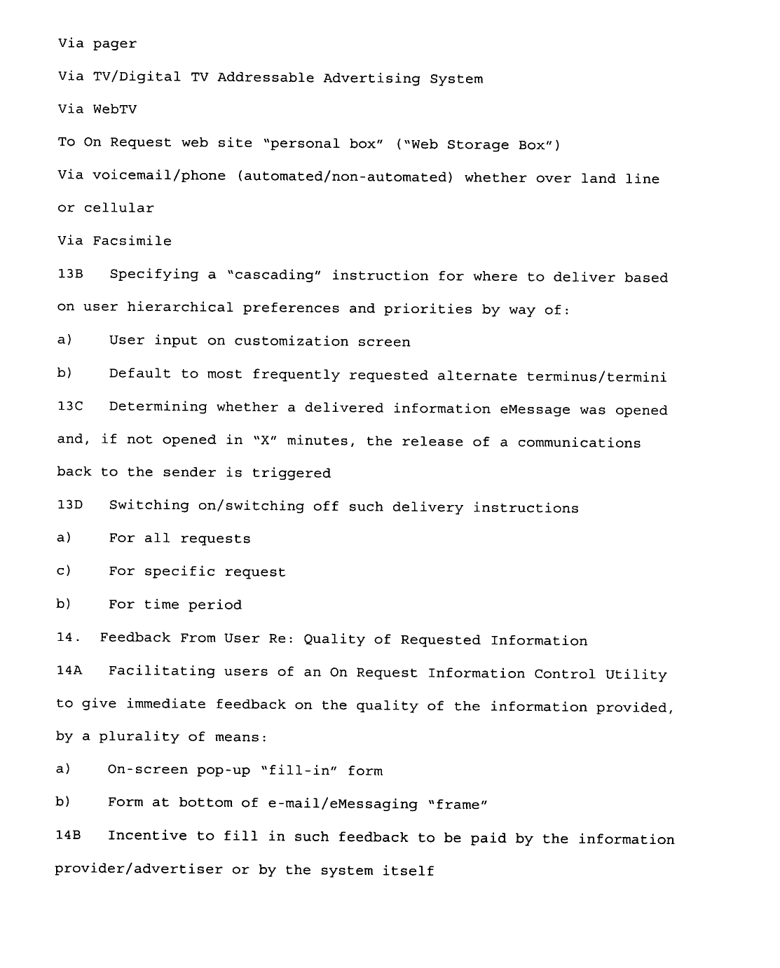

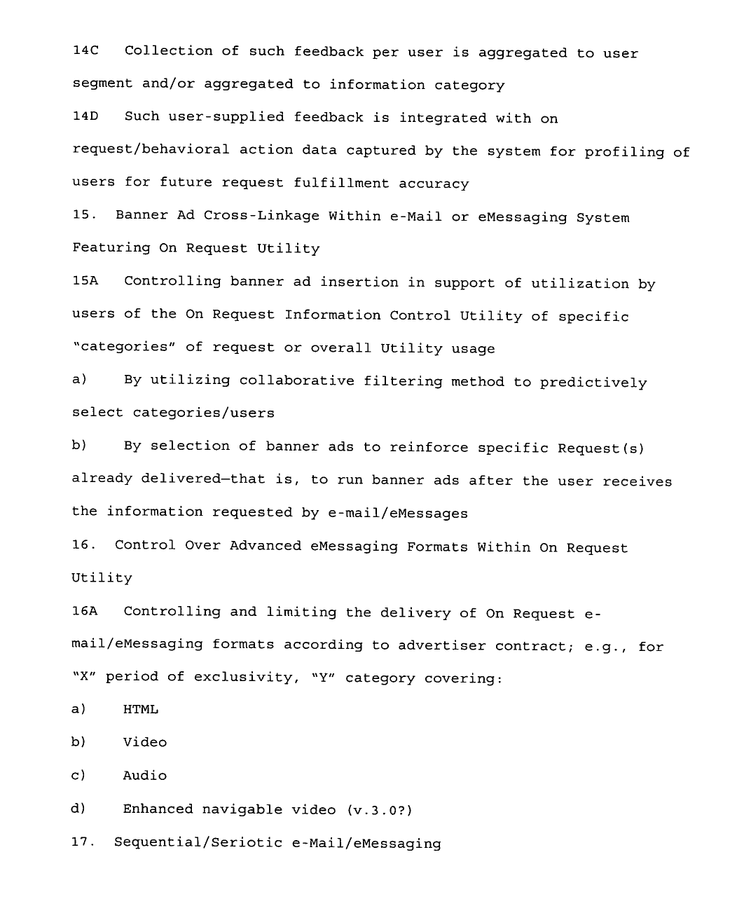

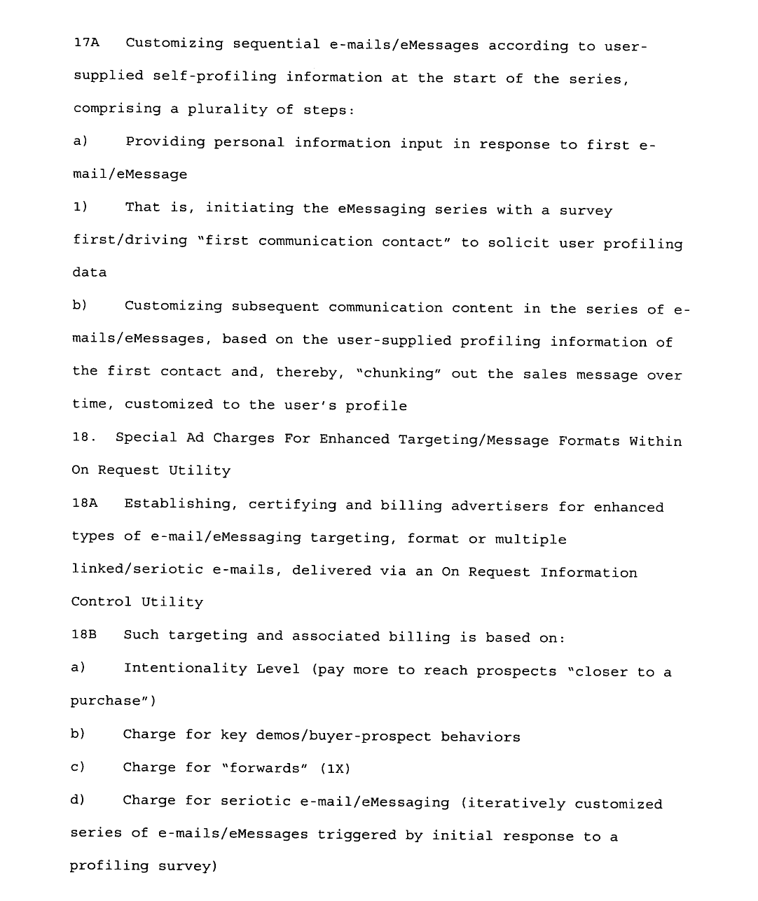

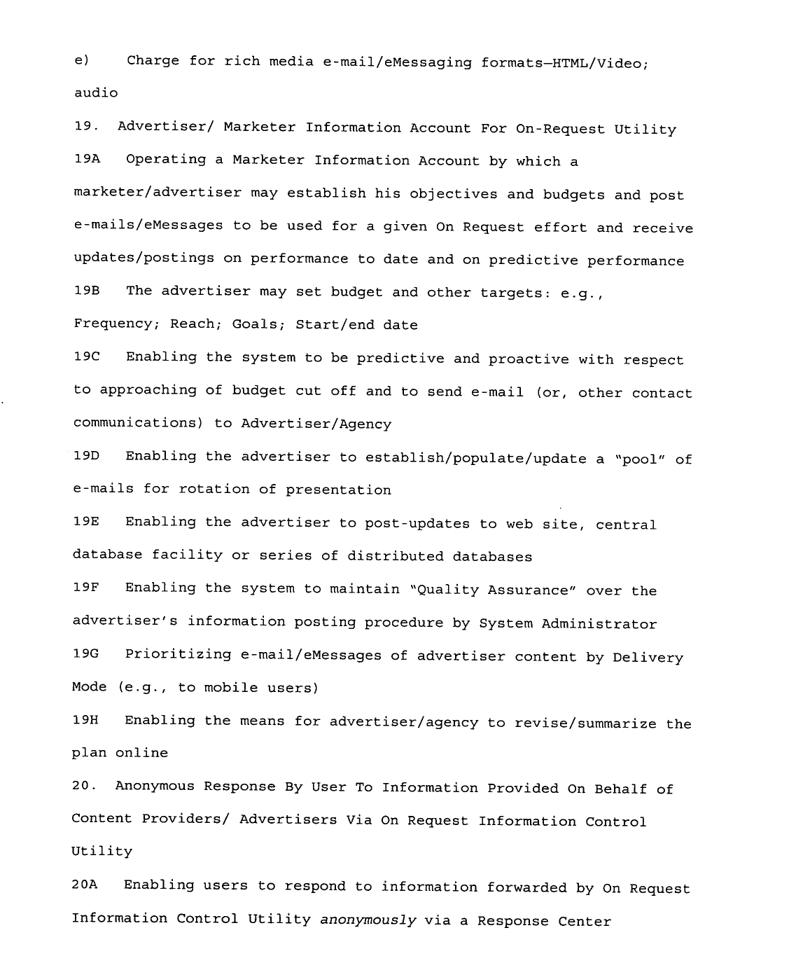

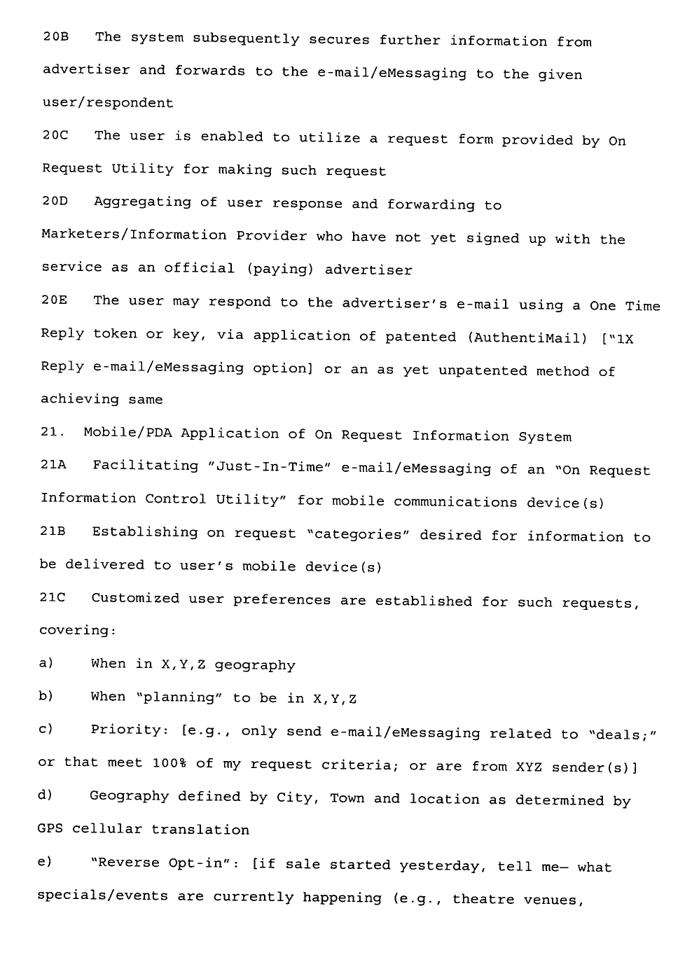

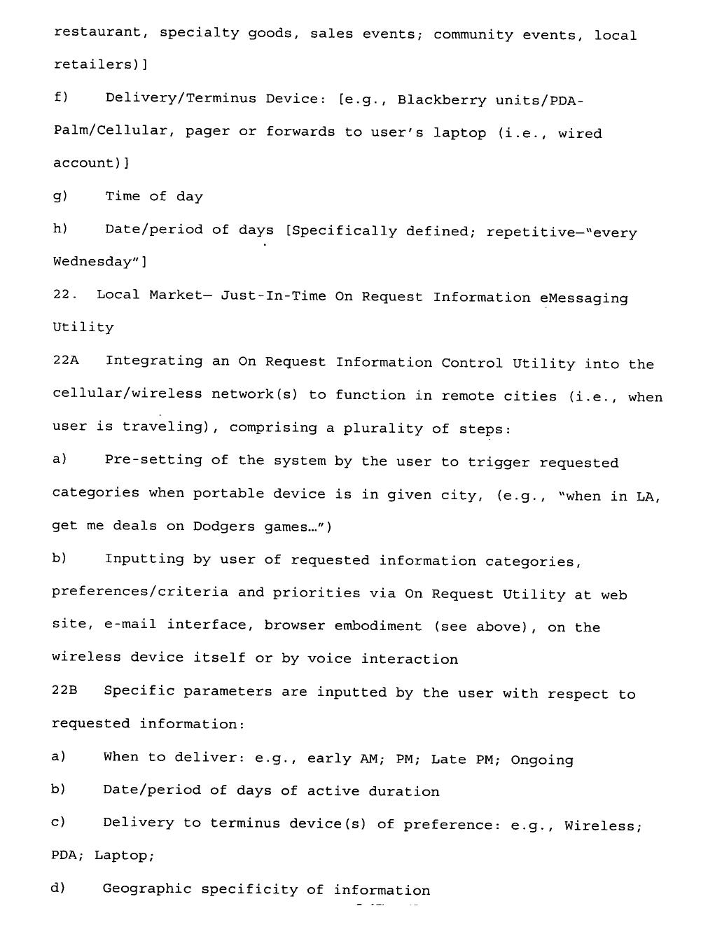

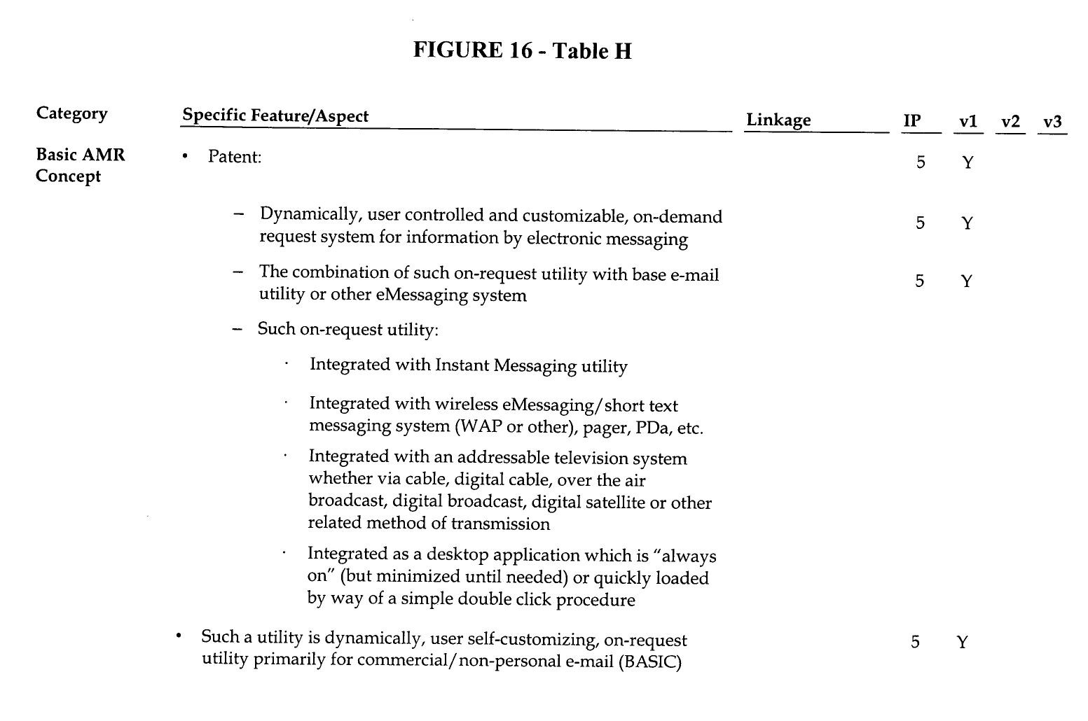

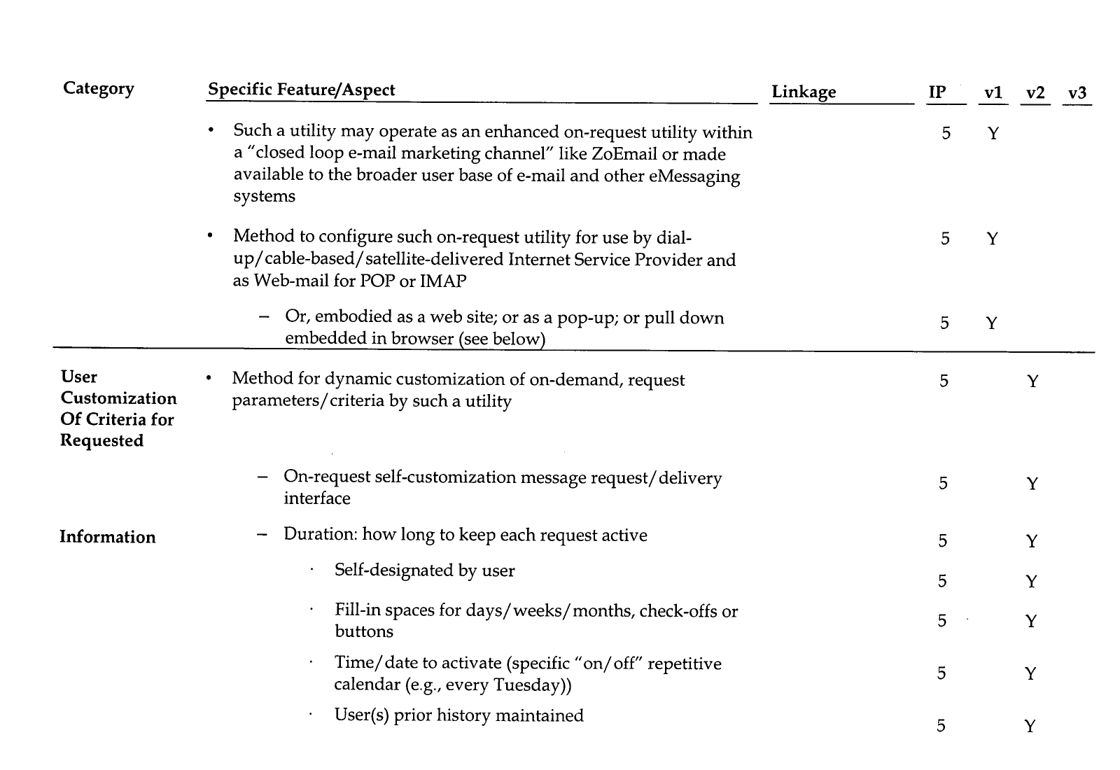

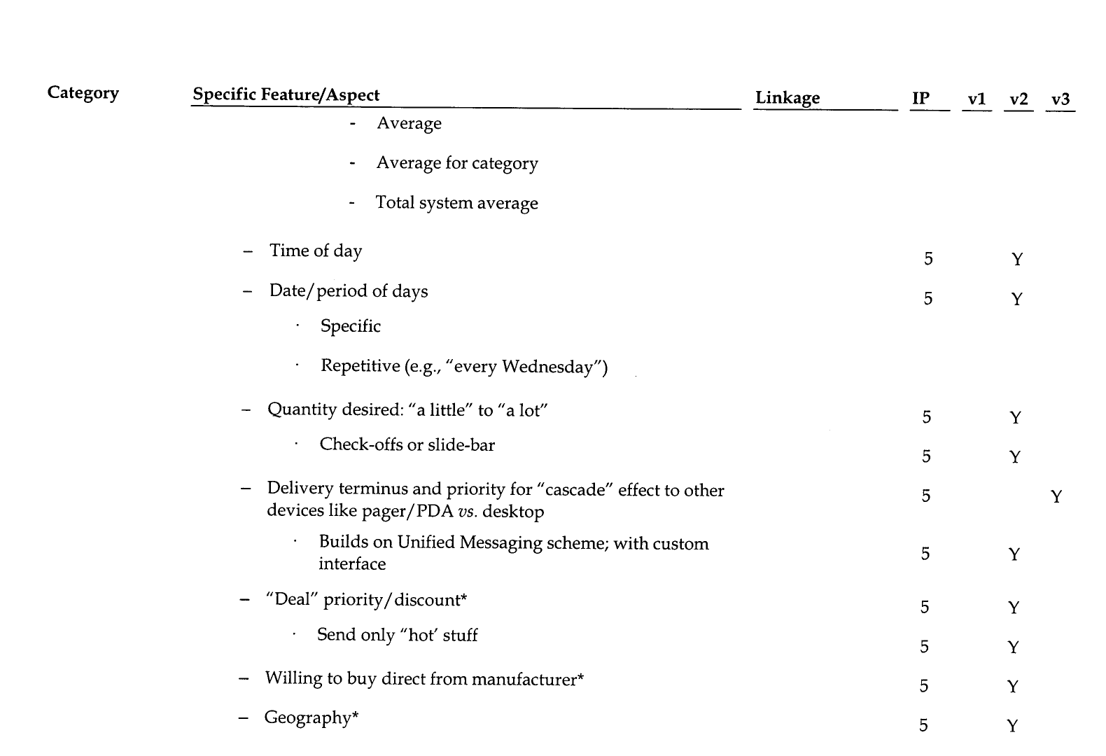

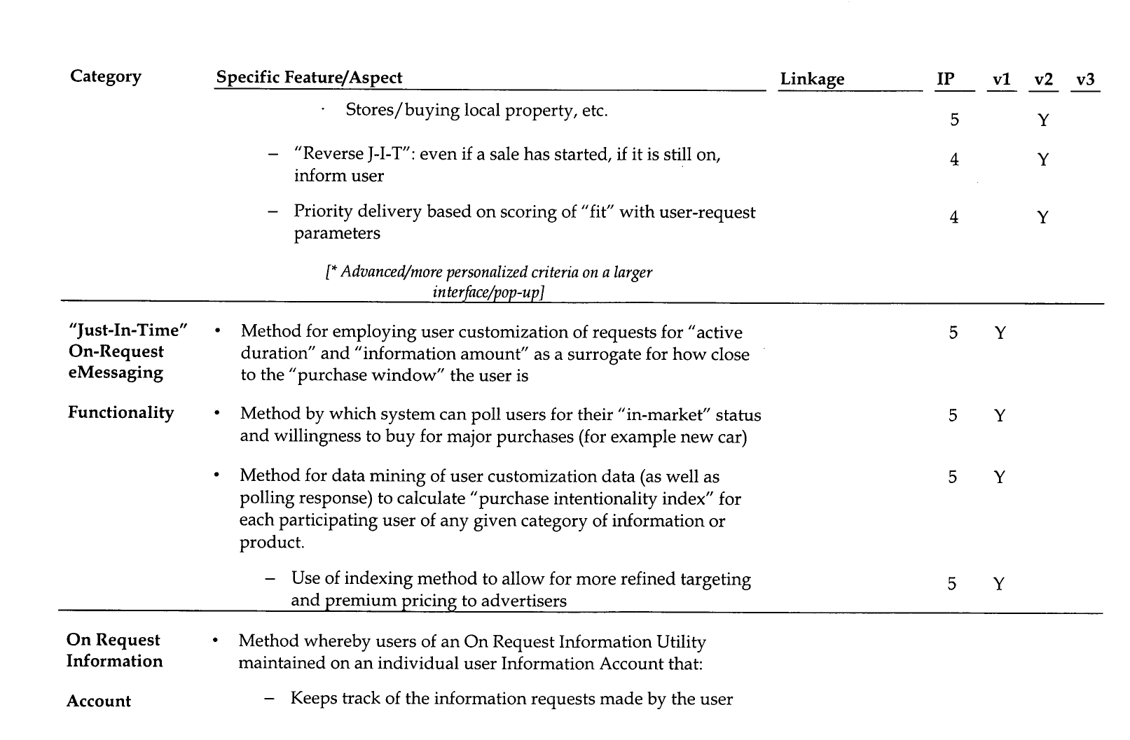

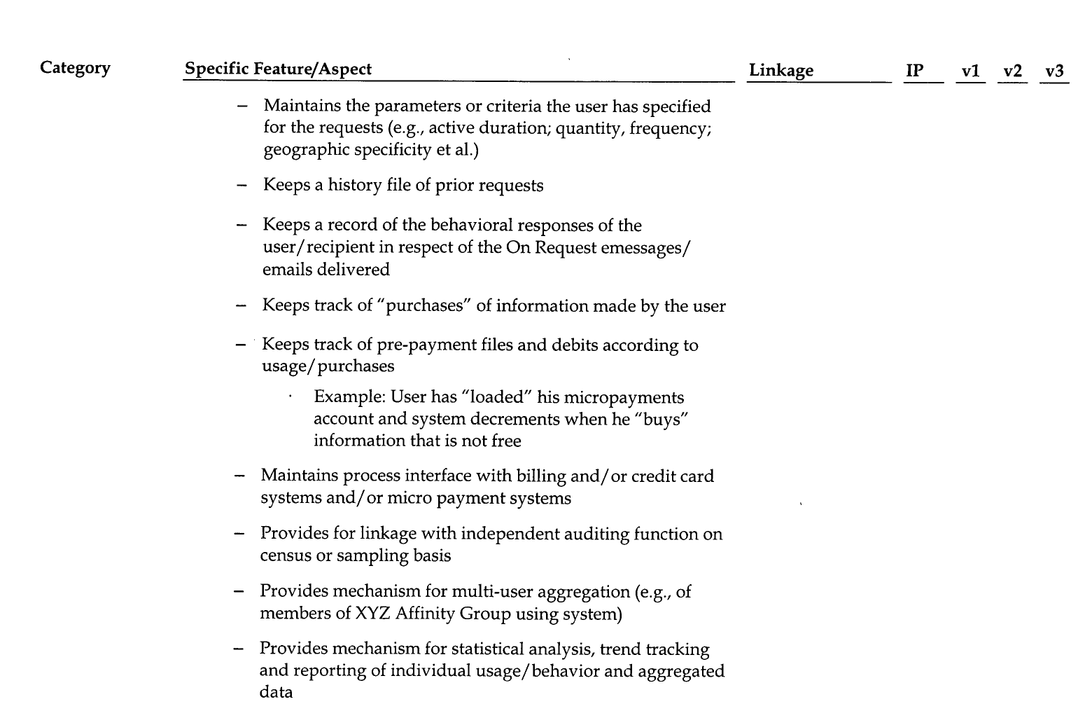

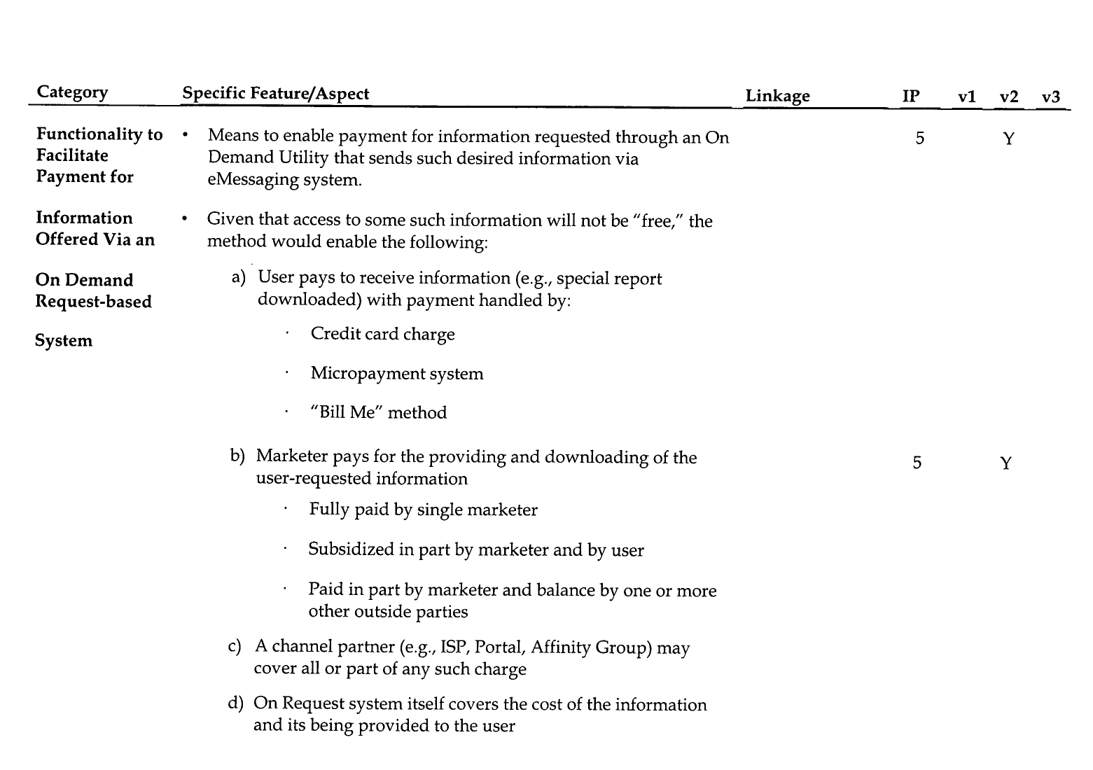

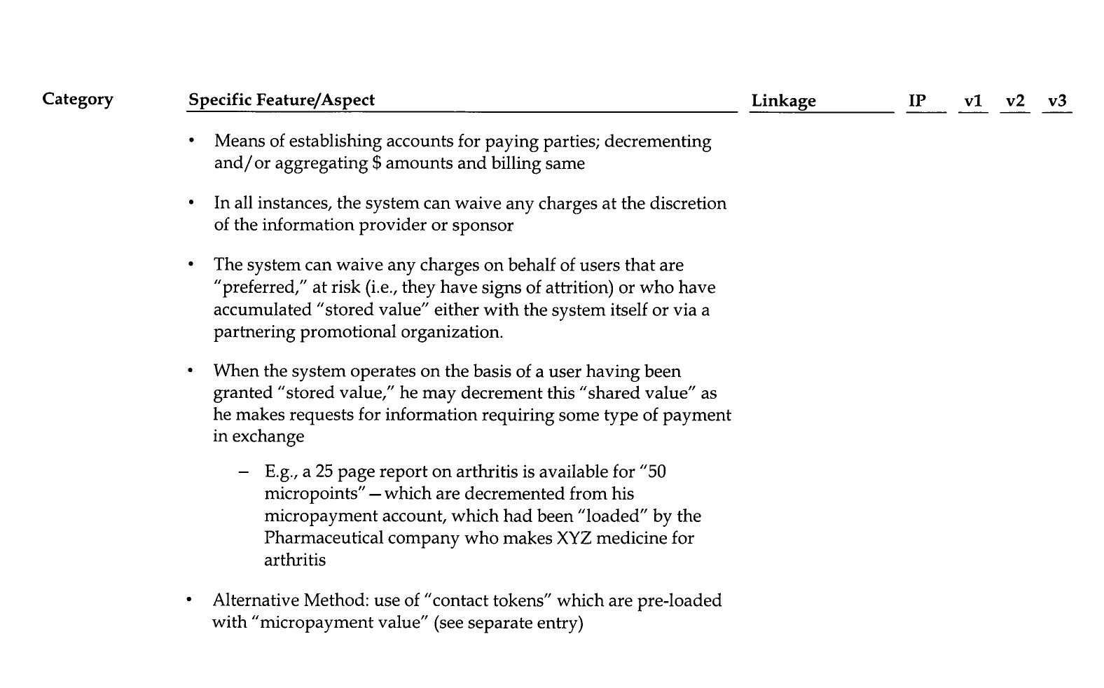

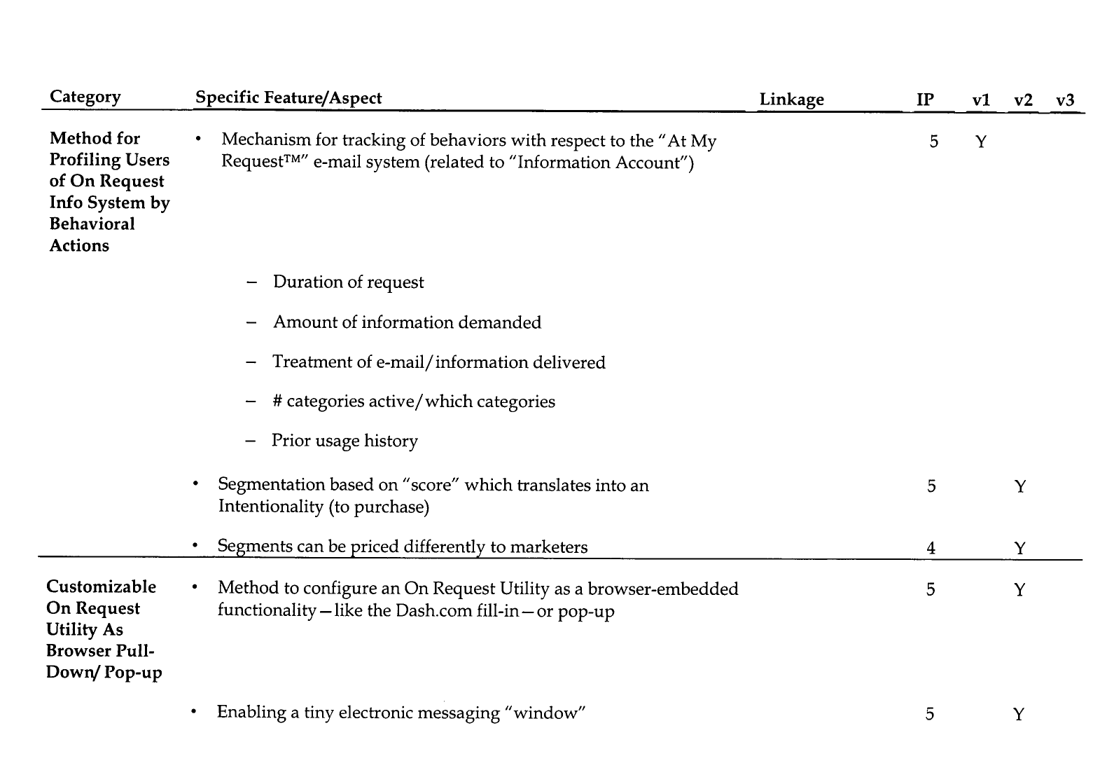

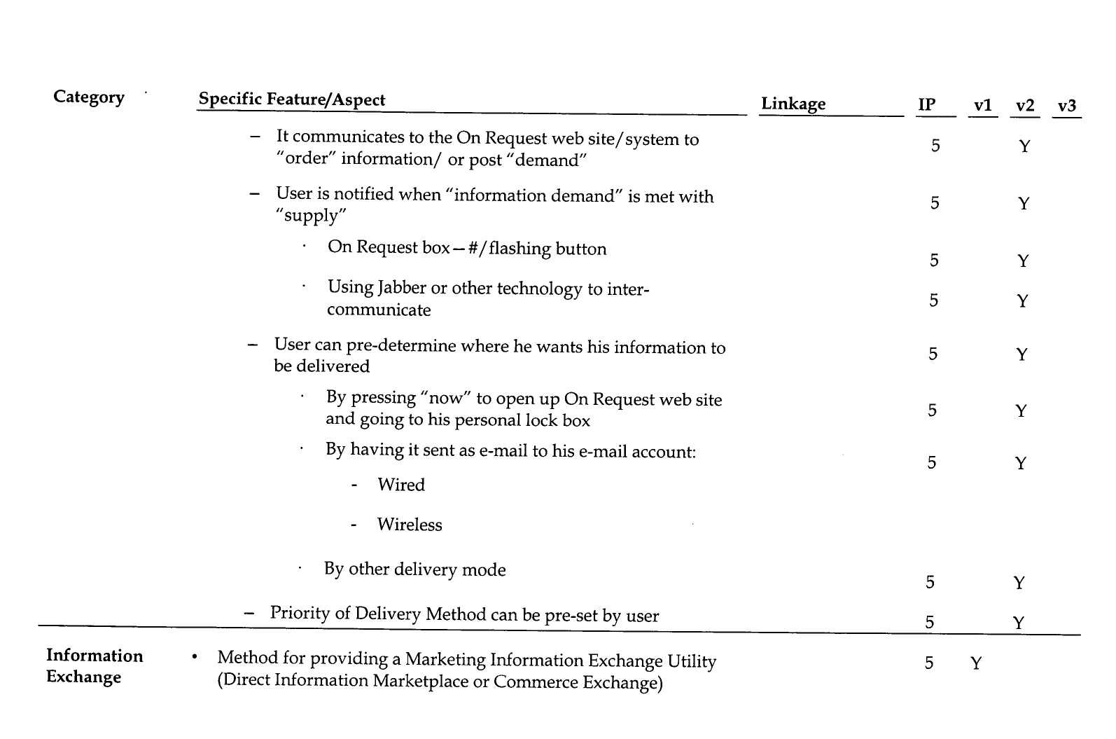

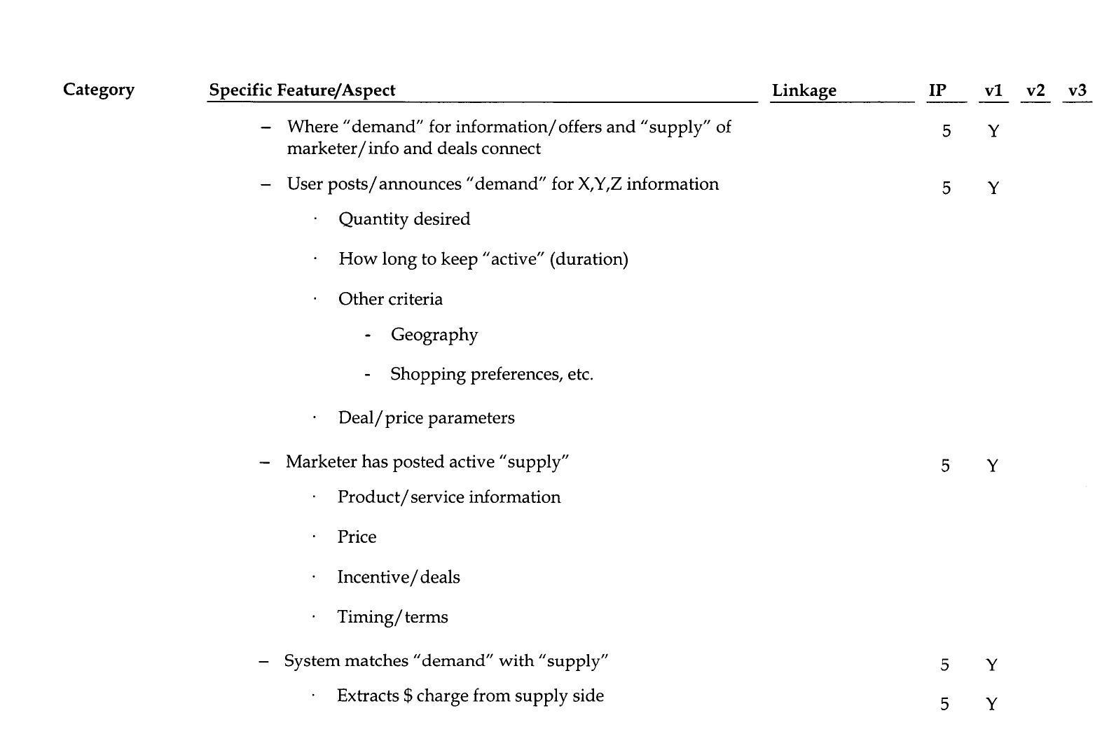

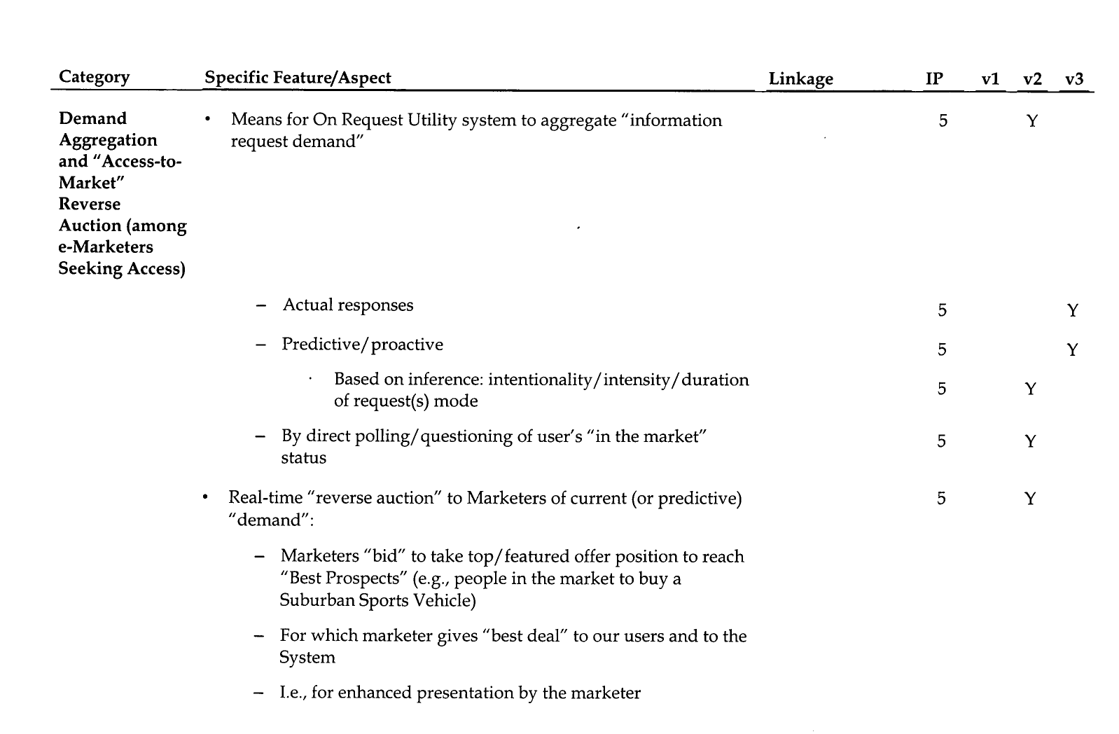

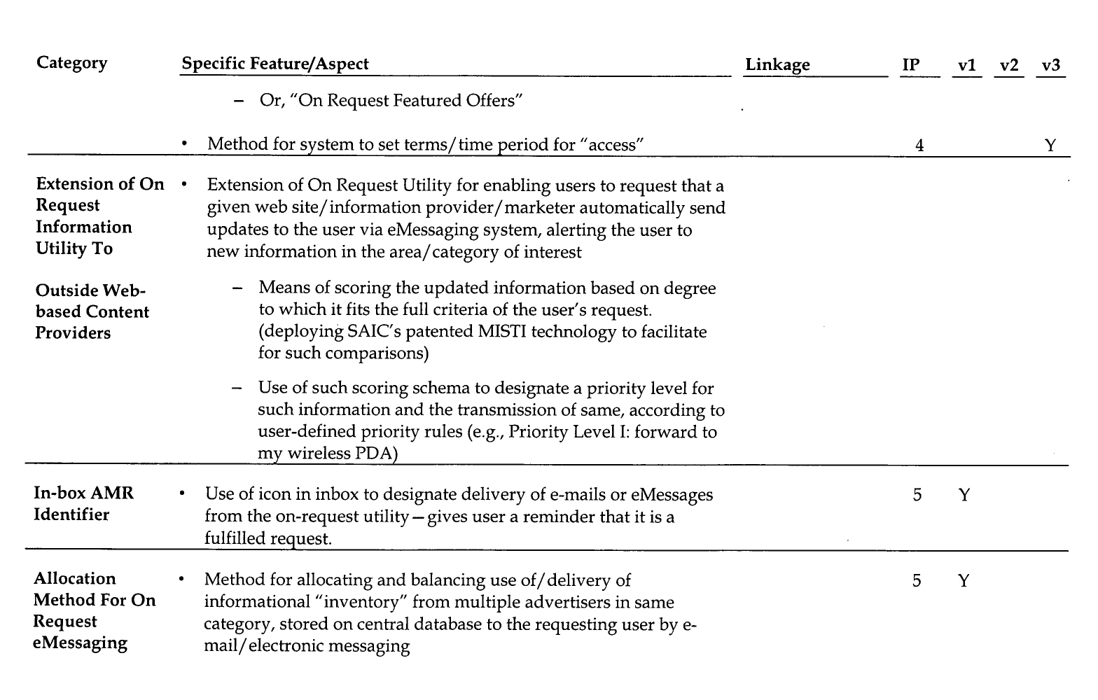

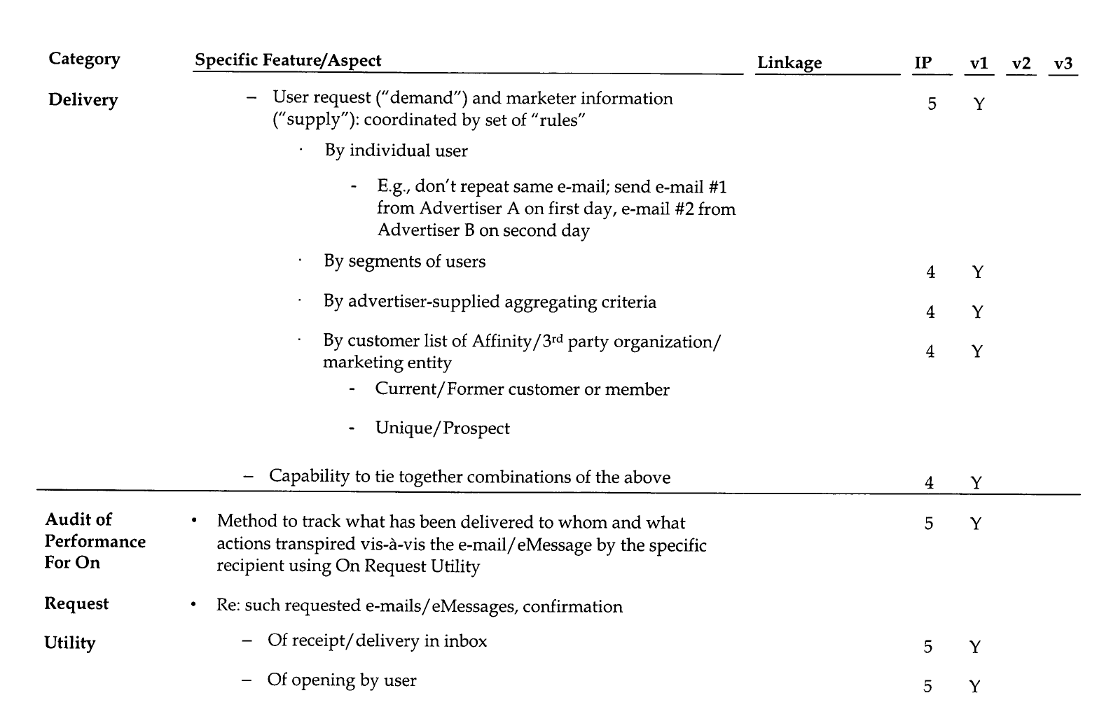

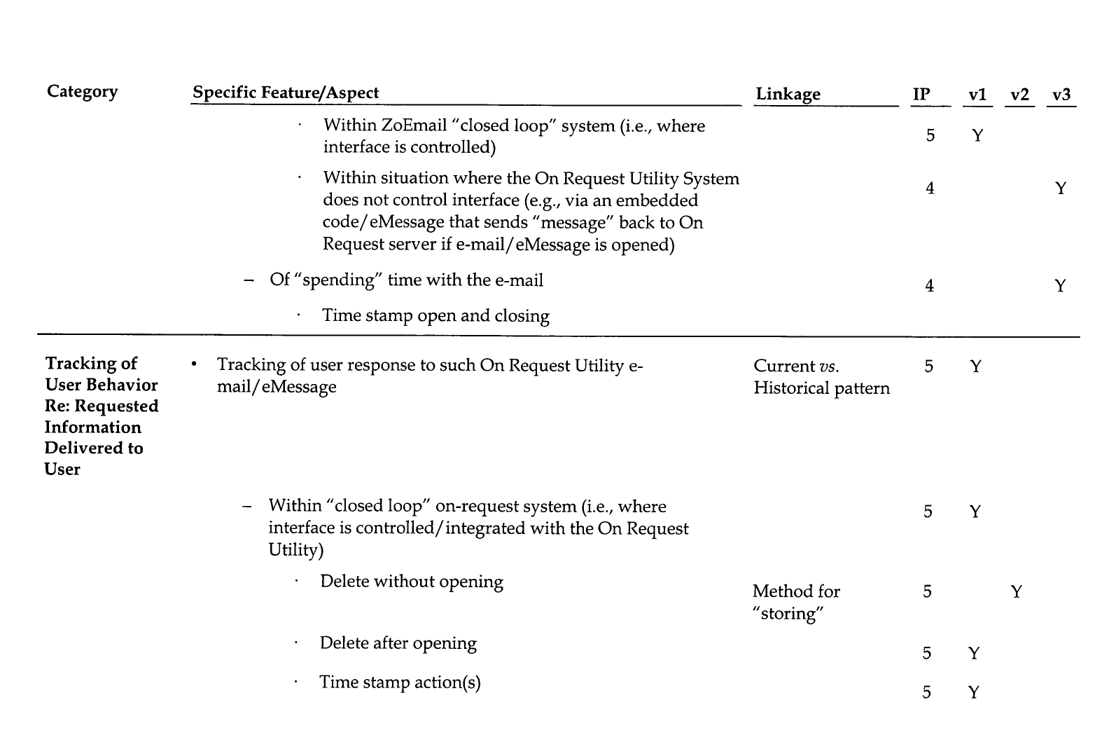

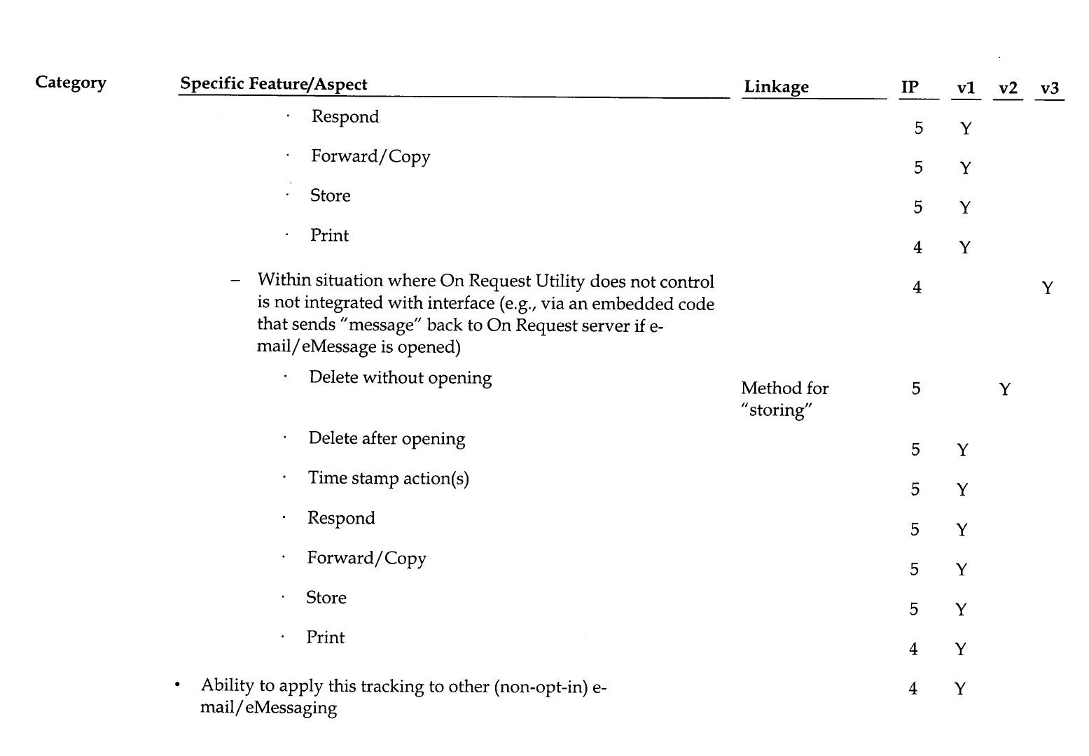

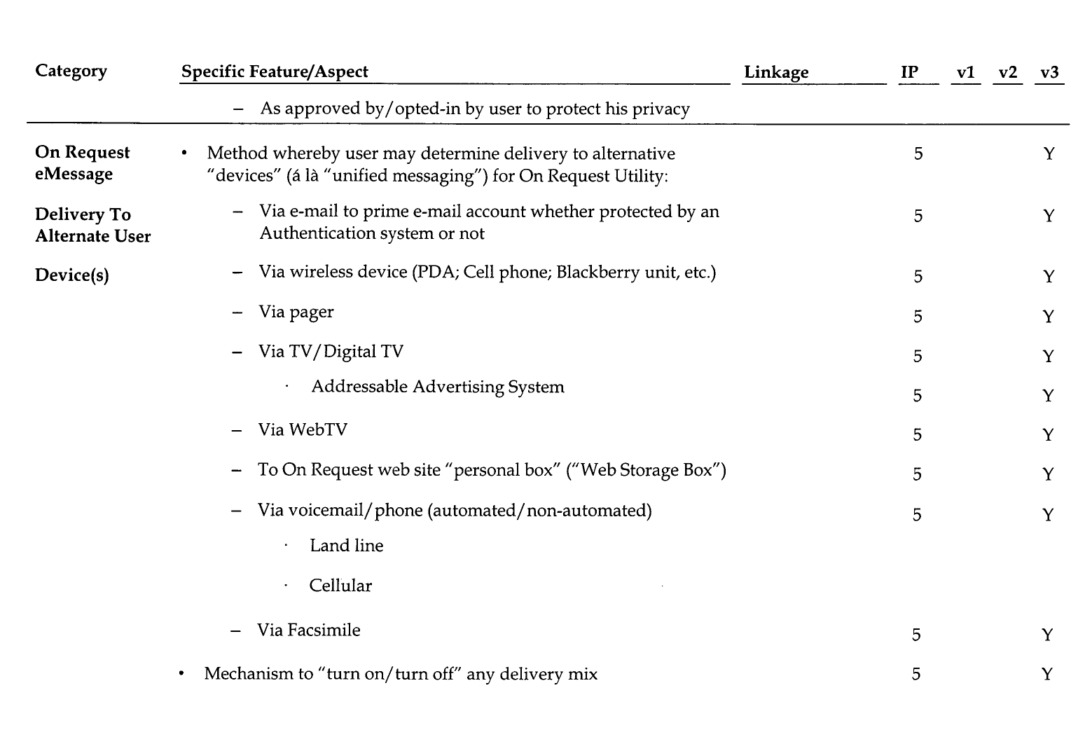

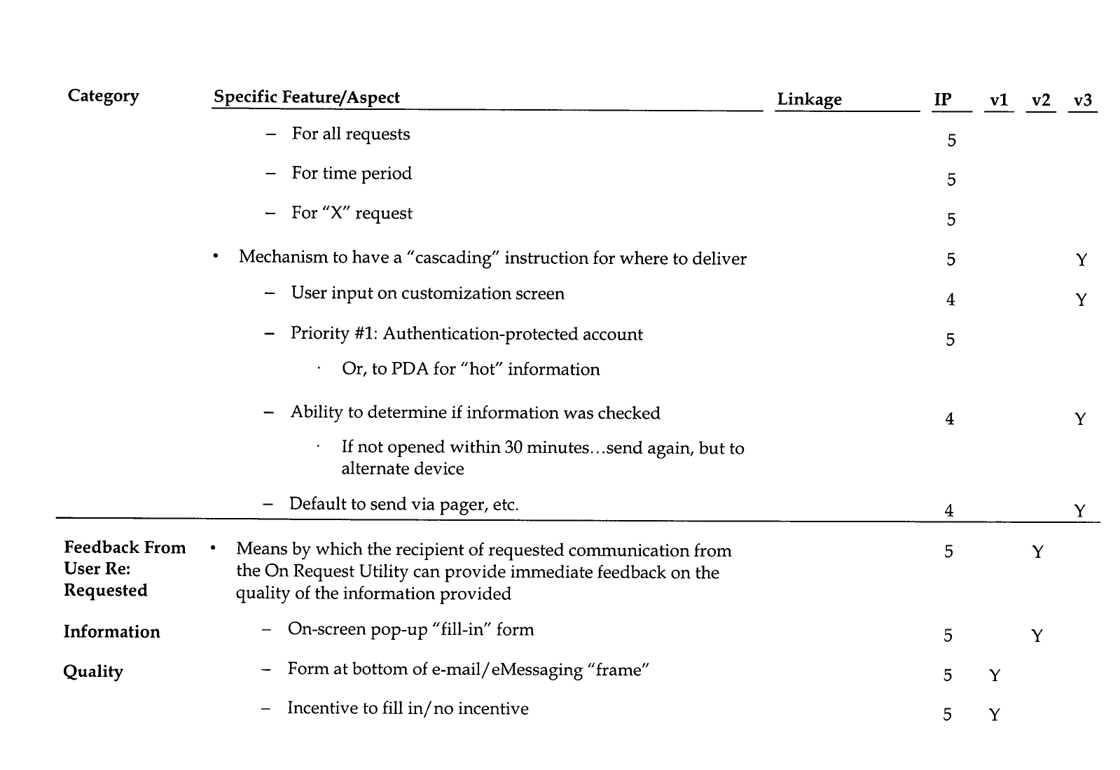

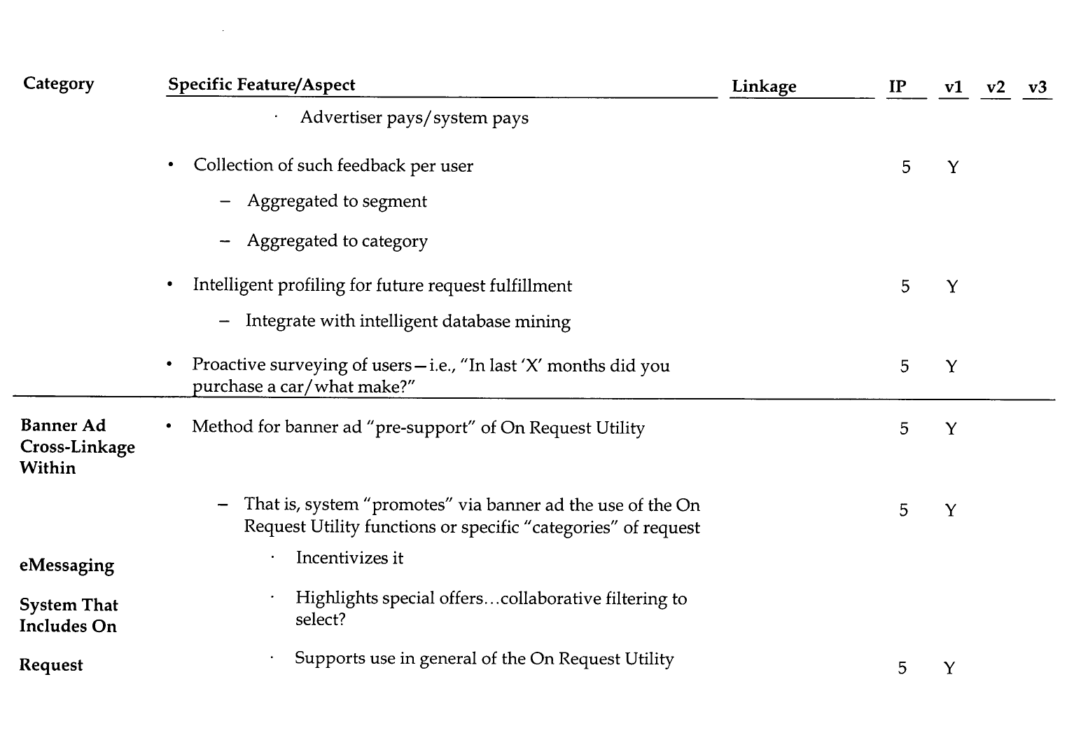

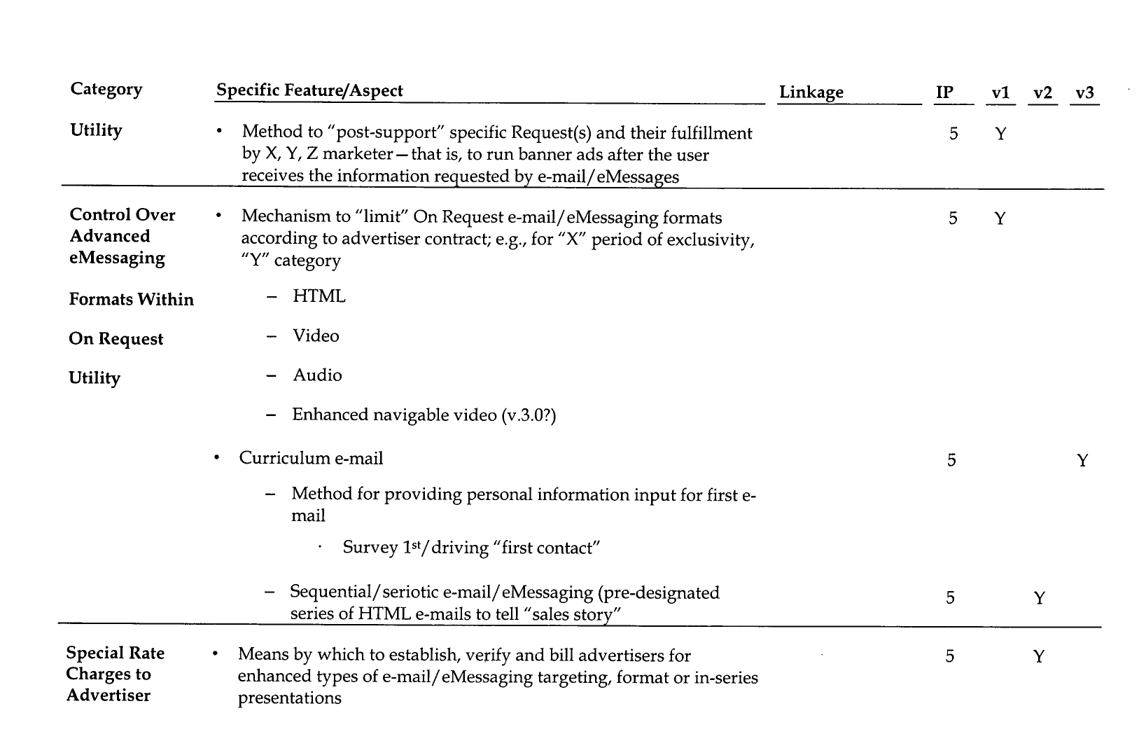

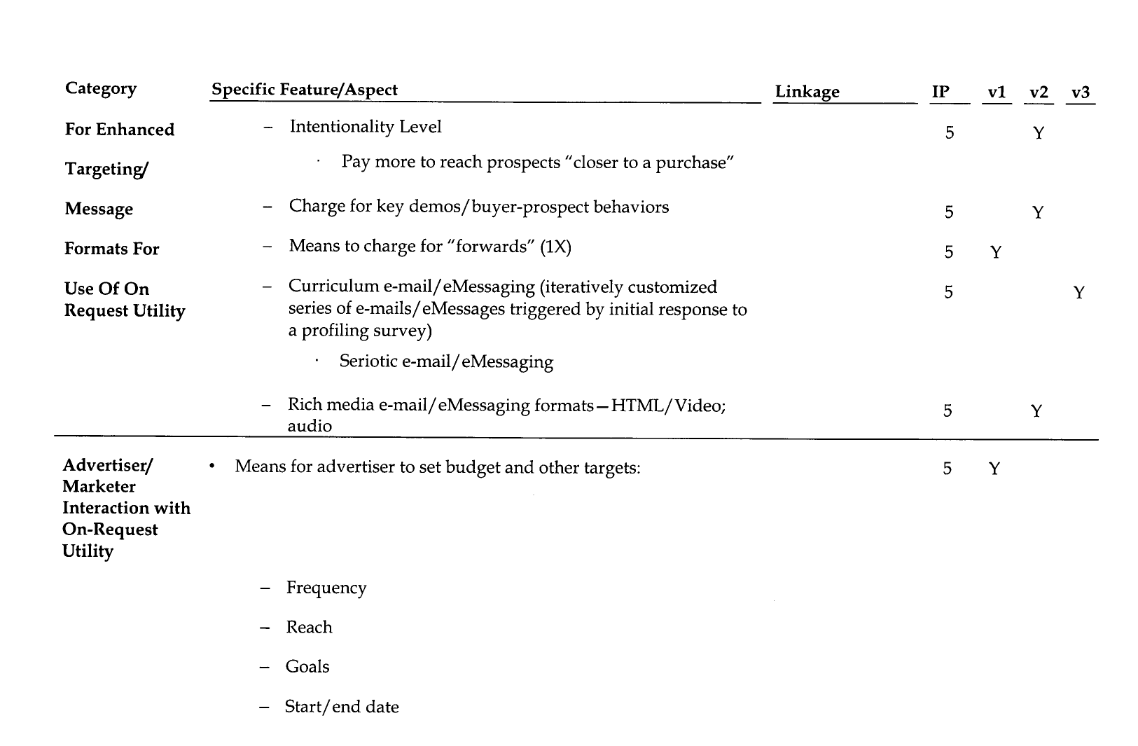

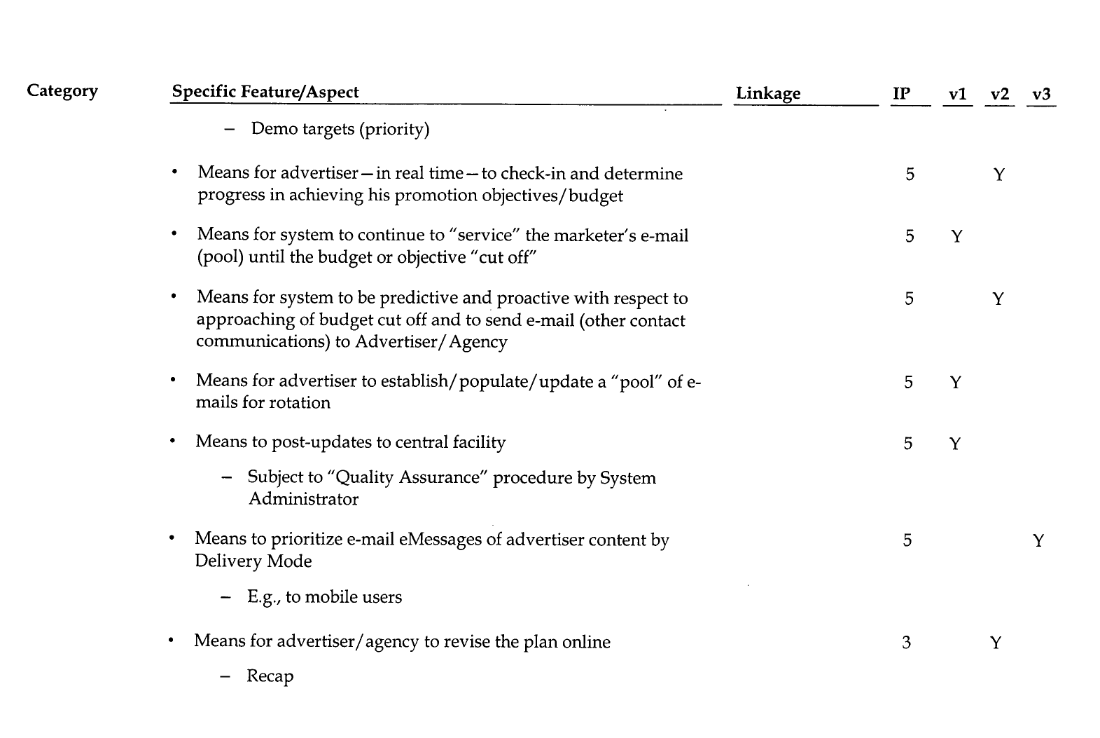

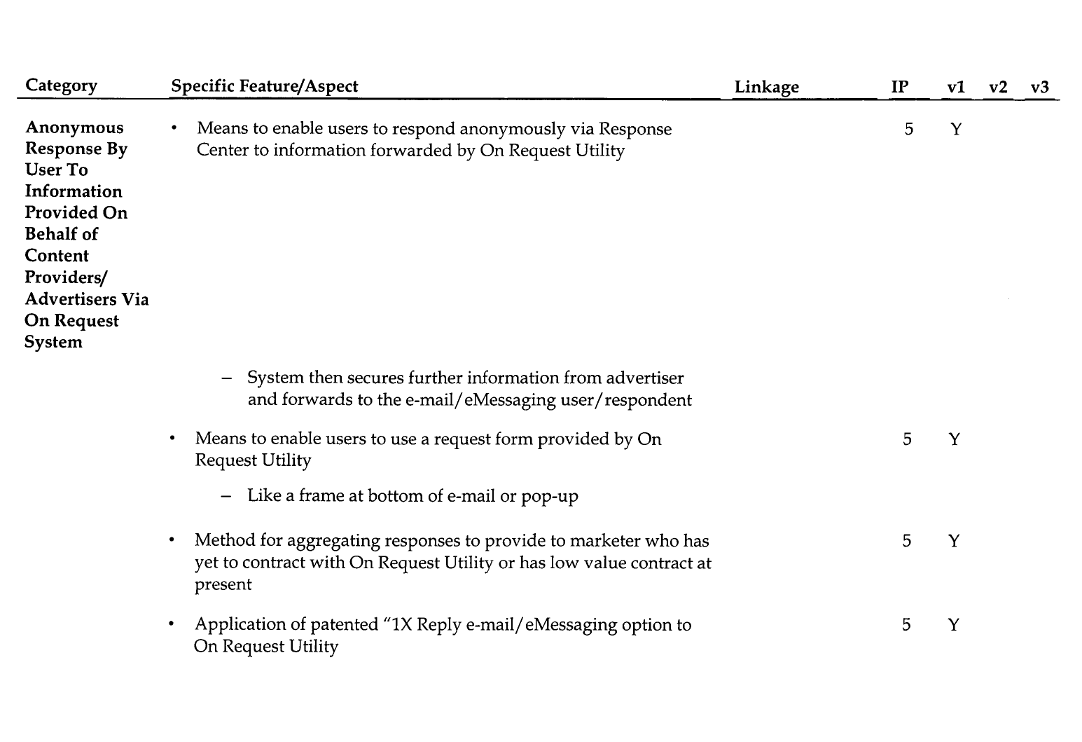

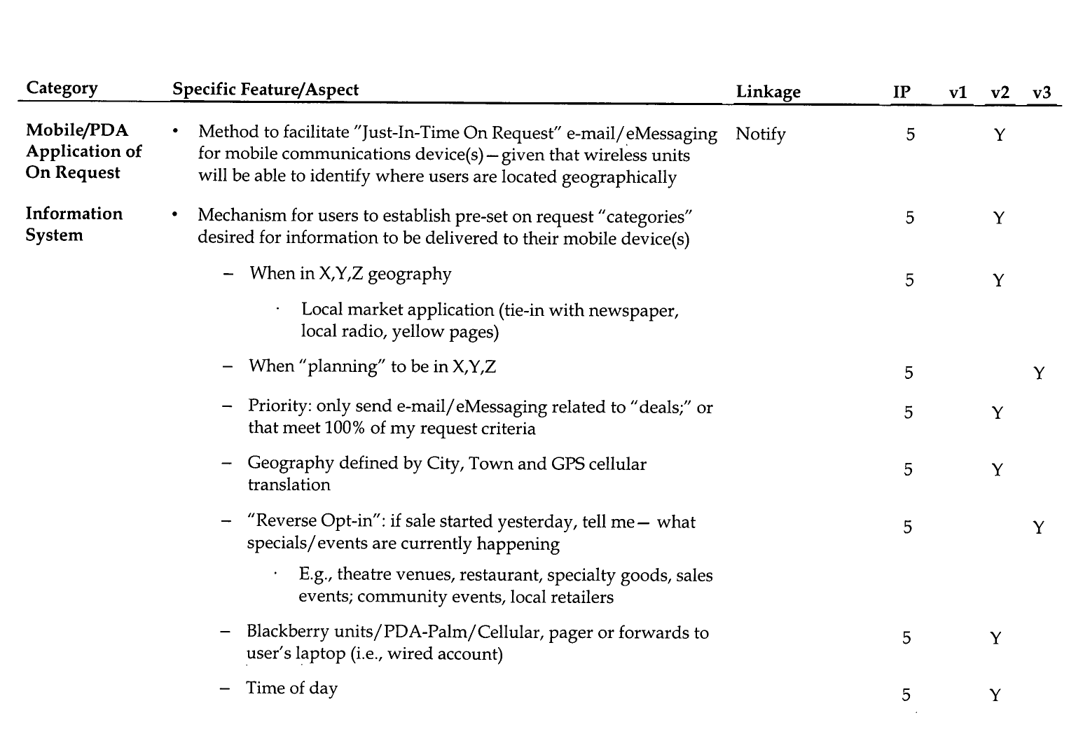

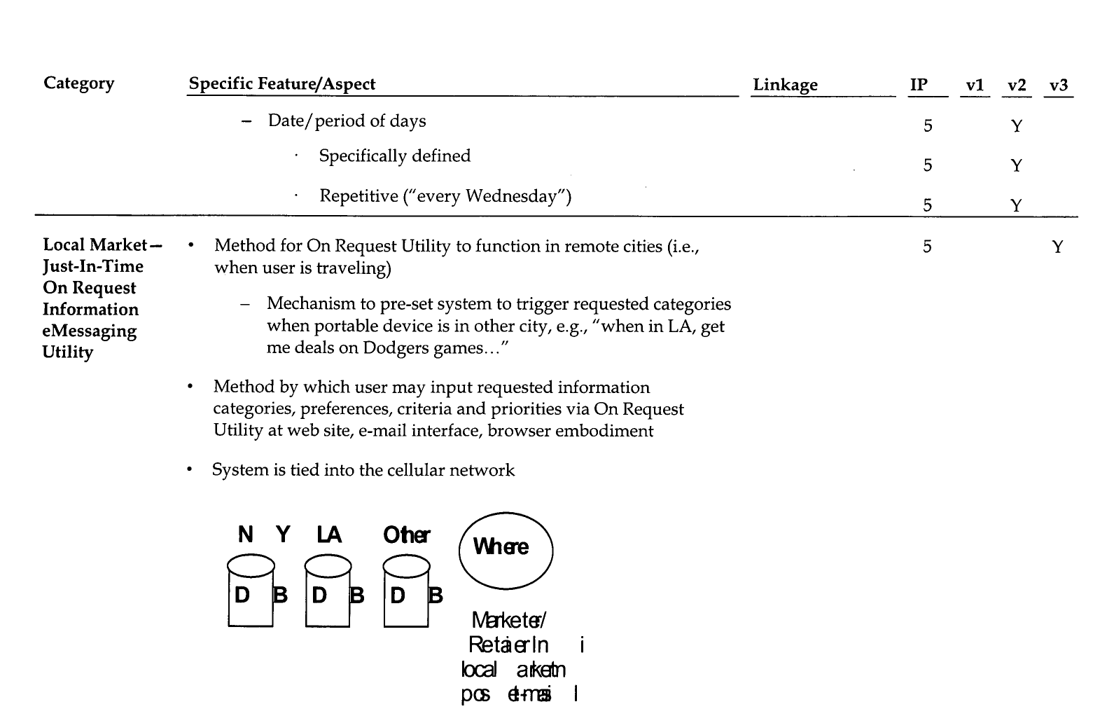

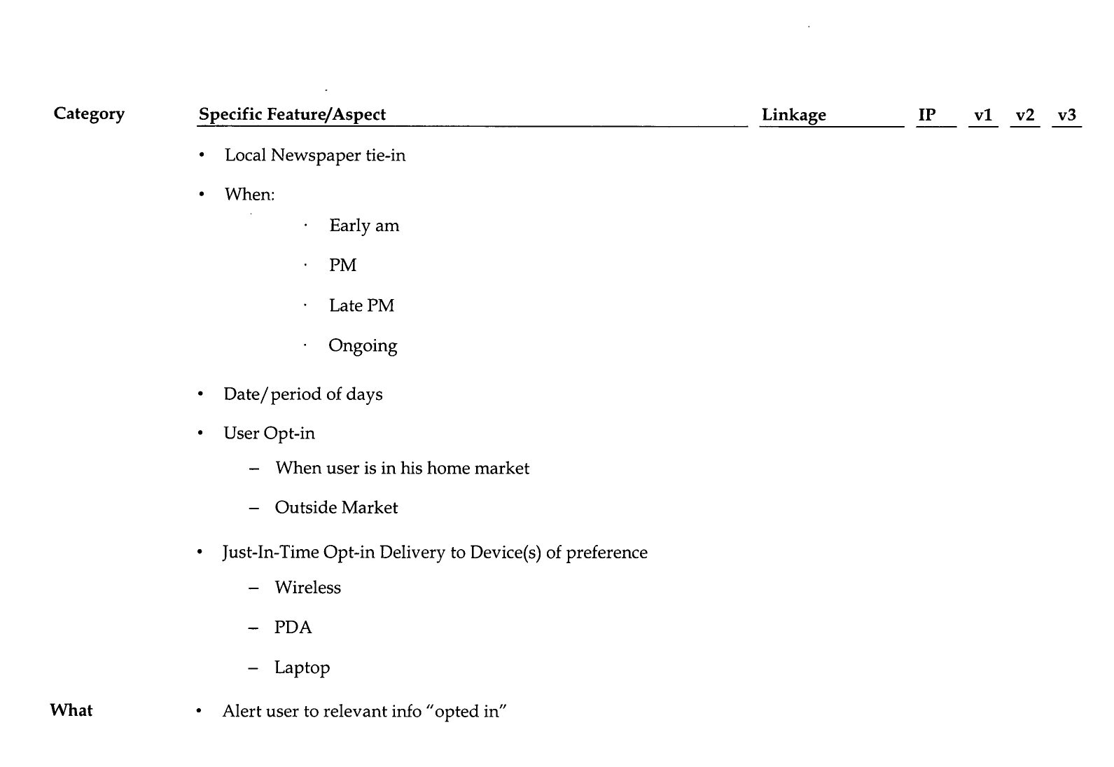

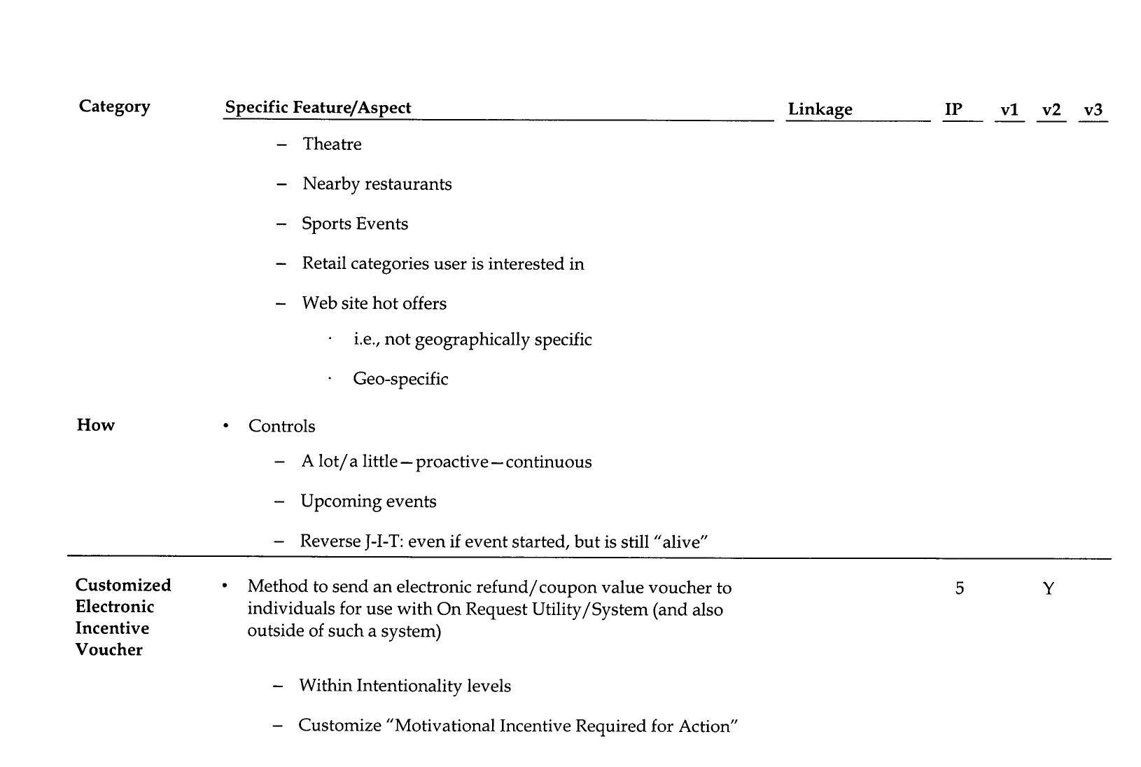

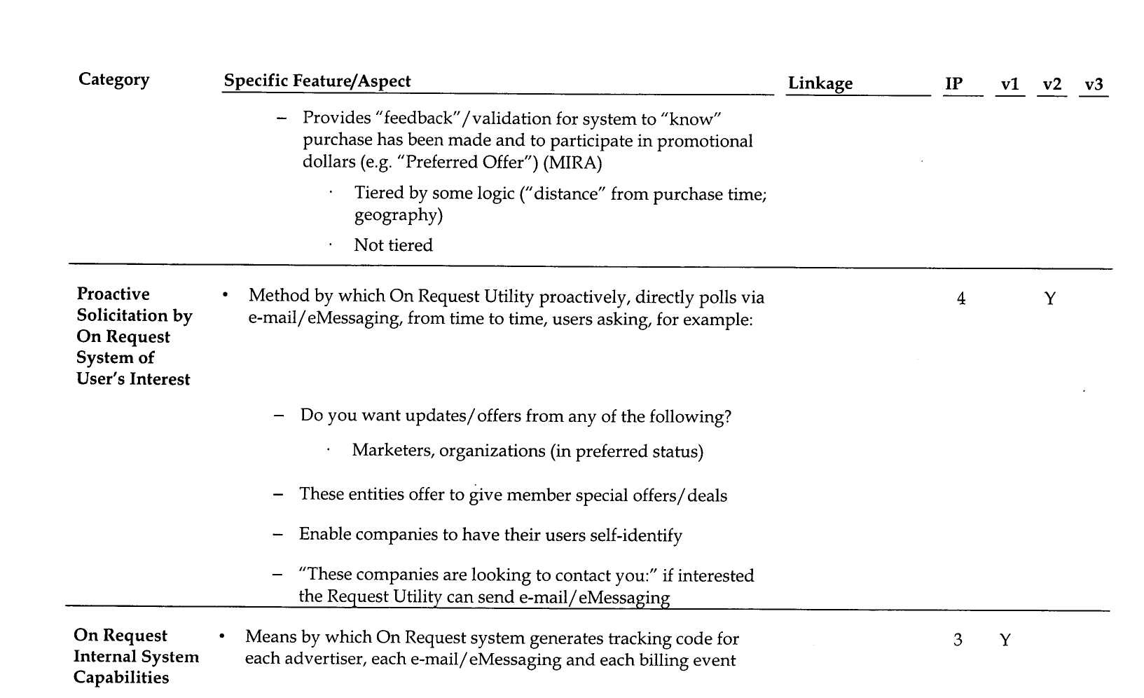

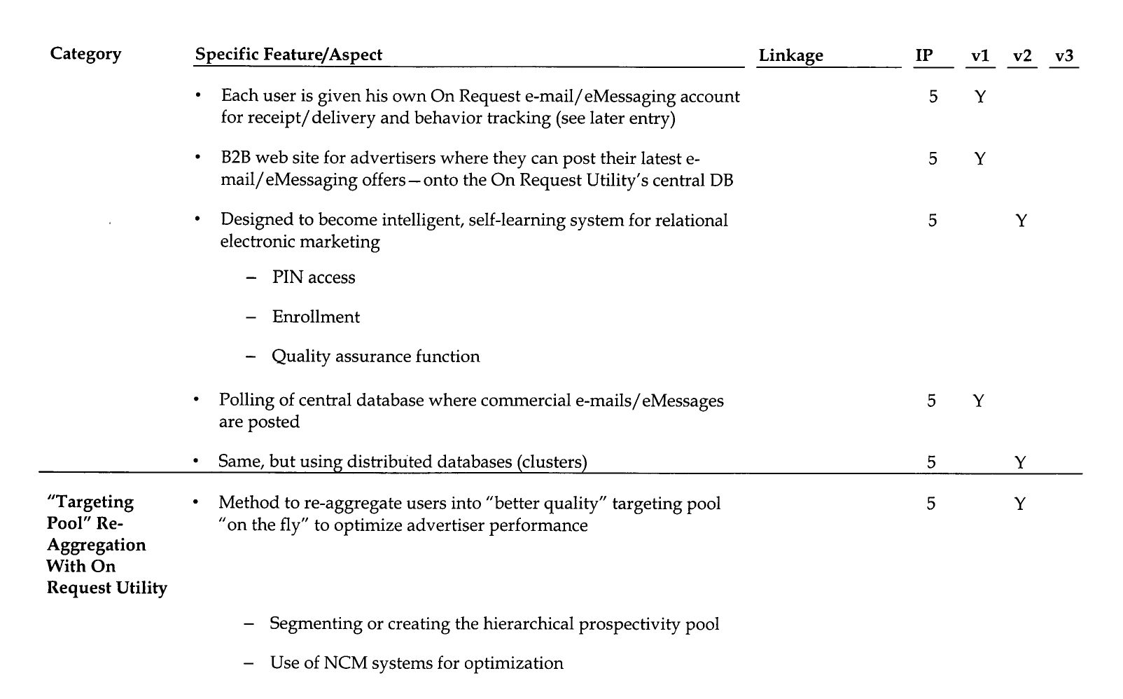

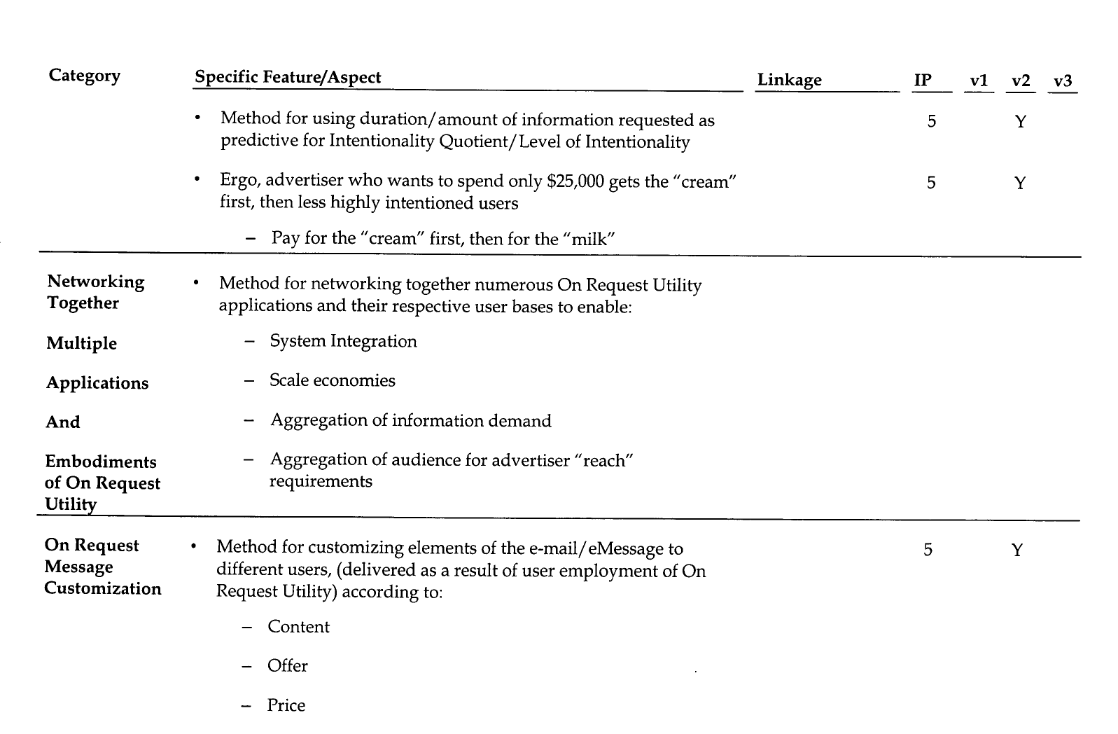

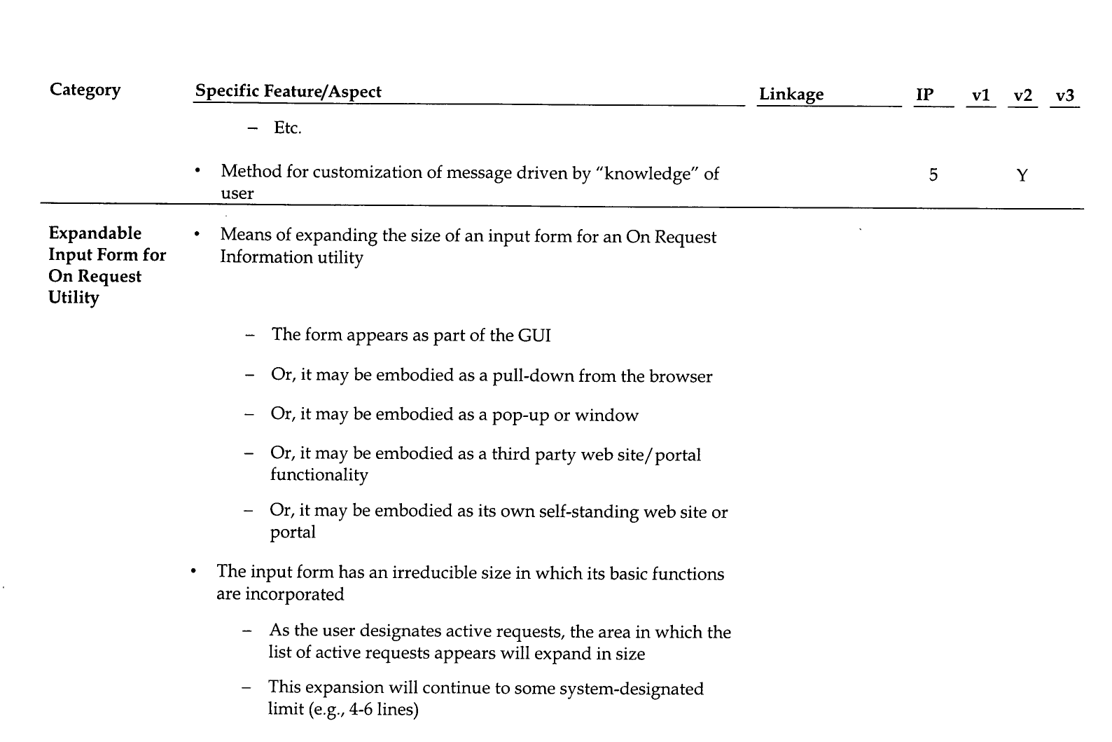

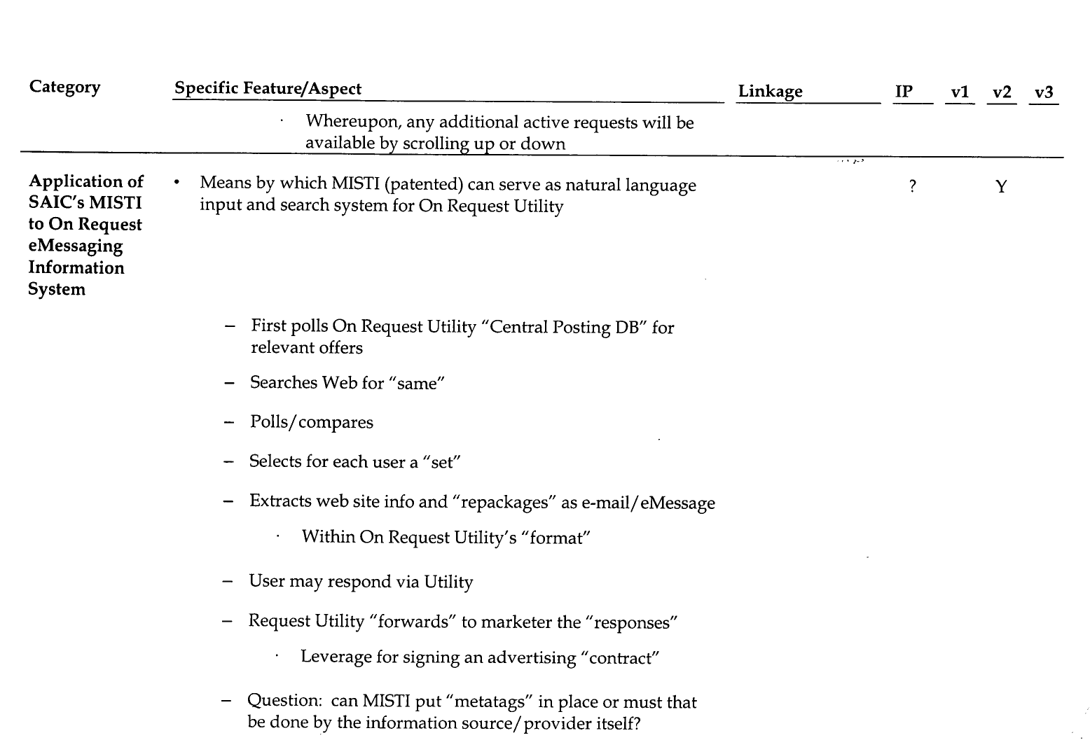

What has been illustrated above is the hardware and software framework for the present invention to be practiced. As readily understood by a person of ordinary skill in the art, the framework can be used to include many more features. To present the features in a more systematic manner, tables G and H are enclosed in FIGS. 15 and 16.

From the foregoing detailed description, it will be evident that there are a number of changes, adaptations and modifications of the present invention which come within the province of those persons having ordinary skill in the art to which the aforementioned invention pertains. However, it is intended that all such variations not departing from the spirit of the invention be considered as within the scope thereof as limited solely by the appended claims.

1. A method of requesting and collecting information from a network via an information account of a system, comprising a plurality of steps of:
making a request by indicating a type of information to be collected;
entering a duration in which the request is active.

2. The method of claim 1, further comprising a step of:
receiving in the information account a result obtained from the network in response to the request.

3. The method of claim 1, further comprising a step of:
maintaining a record to capture the request and a result obtained from the network in response to the request.

4. The method of claim 3, further comprising a step of:
determining an amount of result in the record.

5. The method of claim 3, wherein a utility analyzes behaviors of a requester making the request in view of the record.

6. The method of claim 1, further comprising a step of:
determining an actual duration the request stayed active.

7. The method of claim 1, further comprising a step of:
taking an action based on the result obtained from the network in response to the request.

8. The method of claim 7, further comprising a step of:
categorizing the action taken after receipt of the results.

9. The method of claim 7, wherein the action is one of made a purchase, not made a purchase, continued to make the request, modified the request, purchased within a time range and abandoned the request.

10. The method of claim 1, further comprising a step of:
inputting one of various levels of readiness to buy and a purchase intentionality index.

11. The method of claim 1, further comprising a step of:
entering one of a usage intentionality index.

12. The method of claim 11, further comprising a step of:
determining whether to issue one of an electronic refund and a coupon voucher based on one of the purchase intentionality status, the purchased intentionality index and the usage intentionality index.

13. The method of claim 1, further comprising a step of:
specifying one of a destination and a plurality of destinations regarding where a result of the request is to be delivered to.

14. The method of claim 1, wherein an origin of where the request is initiated from is insulated from the network.

15. The method of claim 1, wherein the request comprises a plurality of request parameters.

16. The method of claim 1, wherein the duration is preset for one of a future activation date and a future cut-off date.

17. The method of claim 1, further comprising a step of:
specifying a time the request is made known to the network.

18. The method of claim 1, further comprising a step of:
entering a quantity of information desired as expressed in one of a fixed number and a range.

19. The method of claim 1, further comprising a step of:
entering a preferred method of transmission as expressed in a transmission rate.

20. The method of claim 1, further comprising a step of:
entering a preferred method of transmission suitable for a particular type of receiving terminus.

21. The method of claim 1, further comprising a step of:
entering a geographic region where the type of information is to be collected from.

22. The method of claim 1, further comprising a step of:
specifying a certain promotional type which the type of information is to be collected from.

23. The method of claim 1, further comprising a step of:
specifying a source of origin where the type of information is to be collected from.

24. The method of claim 1, further comprising a step of:
specifying the type of information must be collected from a source accepting a certain transaction method.

25. The method of claim 1, further comprising a step of:
entering a delivery priority of the type of information based on a plurality of terminus.

26. The method of claim 15, further comprising a step of:
ranking a plurality of results based on how close each result matches the plurality of request parameters.

27. The method of claim 15, further comprising a step of:
entering a priority of delivery based on how well a plurality of results matches the specified request parameters.

28. The method of claim 1, further comprising a step of:
specifying a time the type of information should be delivered to the information account.

29. The method of claim 1, further comprising a step of:
specifying a repetitive pattern the type of information should be delivered to the information account.

30. The method of claim 1, wherein the account comprises an electronic mail (email) account, an instant messaging account, a wireless short messaging account, a wireless account, a cellular telephone account, a paging account, a facsimile number, a voice mailbox, a bulletin board, an addressable TV terminus address, a posting address and a print out address.

31. The method of claim 1, wherein the type of information is indicated by one of selecting from an index with a mouse, entering from a keyboard and entering orally with a microphone.

32. The method of claim 1, wherein the type of information is searched from one of a public domain resource and a private domain resource.

33. The method of claim 1, wherein the duration is measured in one of seconds, minutes, hours, days, weeks, months, years, and a combination thereof.

34. The method of claim 1, further comprising a step of:
entering an update interval of the request.

35. The method of claim 34, wherein the update interval is measured in one of seconds, minutes, hours, days, weeks, months, years, and a combination thereof.

36. The method of claim 1, further comprising a step of:
specifying a format of a result.

37. The method of claim 36, wherein the format comprises HTML/PIX, Video, Audio, Text, ASCII, TIFF, JPEG and other formats used in the digital transmission of data.

38. The method of claim 1, further comprising a step of:
specifying whether a related subject of the type of information is desired

39. The method of claim 1, further comprising a step of:
specifying whether the search should be conducted in one of a public domain resource, a private domain resource, and a combination thereof.

40. The method of claim 39, further comprising a step of:
taking payment information from a requester via one of a micro-payment system, billing or credit card system.

41. The method of claim 1, further comprising a step of:
receiving a result of the requested type of information in the account in a specified format at a specified update interval within the duration the request is active, in a quantity desired and according to a priority and a preference.

42. The method of claim 1, wherein the method is implemented on one of an instant messaging utility, a wireless messaging utility (WAP or other), an electronic mail utility, a paging utility, a facsimile utility, a voice mail utility, a bulletin board utility, a printer utility, a browser utility, a cable utility, a satellite utility, a digital broadcast utility, a television system utility, a web-TV utility and an Internet utility.

43. The method of claim 1, wherein the request is transmitted via one of a 2-way addressable television system, or a hybrid system where download is via a broadband signal and upload is via telephone, a cable system, an Internet system, an Intranet system, a satellite system, a Web-TV system and a digital broadcast system, a local area network and a wide area network.

44. The method of claim 1, wherein the method is implemented on a computer system in one of an always active mode and a launched upon request mode.

45. The method of claim 1, wherein the method is integrated as a request utility as part of one of a web site and a portal.

46. The method of claim 1, wherein a requester's identity is concealed from an origin providing a result relevant to the request.

47. The method of claim 1, further comprising a step of:
designating automatic forwarding of requested informational/advertising e-mails to one of a single party, a plurality of parties, an existing carbon copy (cc) list, and a newly created distribution list of e-mail recipients.

48. The method of claim 1, further comprising a step of:
paying for a result relevant to the request by one of a micro-payment, billing, and credit card system.

49. The method of claim 1, wherein the system captures a requester behavior with respect to a result delivered to the requester.

50. The method of claim 49, wherein the requester behavior comprises opening the result, saving the result, deleting the result, forwarding the result, responding to the result, making a purchase transaction via email in response to the result, registering for any offer in response to the result and archiving the result.

51. The method of claim 1, wherein should the request fail to specify any preferences or request criteria, default preferences or request criteria are imposed by the system.

52. The method of claim 51, wherein the default preferences or request criteria are based on one of an average preferences or request criteria of the account in the type of information, an average preferences or request criteria of the overall account, an average preferences or request criteria of the system in the type of information, and an average preferences or request criteria of the overall system.

53. The method of claim 1, wherein a result of the request can only reach the account with one of a digital key, a certificate for permitted access and a password recognized by a lookup table.

54. A communication system, comprising:
a subscriber system;
a supplier system;
an information memory system;
an information exchange system;
a clearinghouse system; and
a network;
wherein the subscriber system, the supplier system, the information memory system, the information exchange system; the clearinghouse system are interconnected through the network.

55. The communication system of claim 54, wherein data of the system are intercommunicated among the subscriber system, the supplier system, the information memory system, the information exchange system, the clearinghouse system and the network.

56. The communication system of claim 54, wherein a subscriber account communicatively connected to the subscriber system makes a request of information having a specified characteristic to the subscriber system.

57. The communication system of claim 56, wherein a supplier account communicatively connected to the supplier system provides a supply of information having an indicated characteristic to the supplier system.

58. The communication system of claim 57, wherein the information exchange system, serving as one of a trusted intermediary and a third party, upon finding a match between the specified characteristic and the indicated characteristic, causes the communication system to transfer the supply of information to the subscriber account.

59. The communication system of claim 58, wherein the information exchange system informs the clearinghouse system that the request of information has been fulfilled.

60. The communication system of claim 59, wherein the clearinghouse system registers a charge against the subscriber account.

61. The communication system of claim 54, wherein the network is one of a local area network, a wide area network or an Internet.

62. The communication system of claim 58, wherein the match is one of an exact match and a varying degree of match.

63. The communication system of claim 56, wherein the request of information having the specified characteristic is communicated to a plurality of suppliers correspondingly having a plurality of supplier accounts communicatively connected to the supplier system.

64. A communication system, comprising:
a dynamic request data system is communicatively connected to an Internet;
an information control panel is communicatively connected to the dynamic request data system;
an email account is communicatively connected to the dynamic request data system;
an information supplier system is communicatively connected to the dynamic request data system;
wherein the dynamic request data system upon receiving a request via the information control panel, initiates a search in one of the internet and the information supplier system and delivers information fulfilling the request to the email account.

65. The method of claim 58, wherein a feature of one of the trusted intermediary and third party is achieved by having the information memory system to hold a lookup table.

66. The method of claim 58, wherein a feature of one of the trusted intermediary and third party is achieved by a channelized address.

67. The method of claim 58, wherein a feature of the trusted intermediary and the third party is achieved by a limited used cryptographic system.

68. The method of claim 58, wherein a feature of one of the trusted intermediary and the third party is achieved by a traditional email alias account wherein the aliases are deleted from the account once a predetermined time has expired.

69. The method of claim 58, wherein a feature of one of the trusted intermediary and the third party is achieved by storing a computer table in a relational database.

70. The method of claim 65, wherein the lookup table is held by a bonded party to insulate subscriber system and the supplier system from knowing each other.

71. The method of claim 58, wherein a feature of one of the trusted intermediary and the third party is achieved by insulating a purchasing party and a selling party from knowing each other after consummation of a sales transaction.
